(19) United States
(12) Patent Application Publication
(10) Pub. No.: US 2017/0329922 A1
(43) Pub. Date: Nov. 16, 2017

(54) TELEMEDICINE PLATFORM WITH INTEGRATED E-COMMERCE AND THIRD PARTY INTERFACES

(71) Applicant: Azova, Inc., Alpine, UT (US)

(72) Inventors: Cheryl Lee Eberting, Alpine, UT (US); Paul Raymond Ewing, Highland, UT (US); Richard Dick, Alpine, UT (US)

(21) Appl. No.: 15/597,102

(22) Filed: May 16, 2017

Related U.S. Application Data
(63) Continuation-in-part of application No. PCT/US16/20964, filed on Mar. 4, 2016.
(60) Provisional application No. 62/337,203, filed on May 16, 2016.
(60) Provisional application No. 62/353,865, filed on Jun. 23, 2016.
(60) Provisional application No. 62/378,590, filed on Aug. 23, 2016.
(60) Provisional application No. 62/129,641, filed on Mar. 6, 2015.
(60) Provisional application No. 62/167,058, filed on May 27, 2015.
(60) Provisional application No. 62/247,584, filed on Oct. 28, 2015.
(60) Provisional application No. 62/303,229, filed on Mar. 3, 2016.

(51) Int. Cl. G06F 19/00; G06Q 20/40; G06Q 30/06; G06Q 10/10

(52) U.S. Cl. CPC G06F 19/3418; G06Q 30/0611; G06Q 20/40; G06F 19/322; G06F 19/3437; G06F 19/3406; G06Q 10/109

(57) ABSTRACT

Systems and methods for the integration of leveraged e-commerce offerings are combined with telemedicine consultations. Telemedicine platforms and associated services, including electronic medical record management, physician-customizable online portals, patient services, health-related online marketplaces, secure messaging services, vaccine management, on-demand translations, real-time sales support, and the like are provided in a single, integrated platform or as separate systems and subsystems. The selection of a product for purchase may be linked to the scheduling of a telemedicine consultation related to the selected product. A healthcare practitioner may provide immediate click-to-buy links to various products and services.

### RELATED APPLICATIONS

This application is a continuation-in-part of PCT Application No. PCT/US16/20964, filed Mar. 4, 2016, titled “TELEMEDICINE PLATFORM WITH INTEGRATED E-COMMERCE AND THIRD-PARTY INTERFACES,” which application claims priority to U.S. Provisional Patent Application No. 62/129,641, filed Mar. 6, 2015, titled “TELEMEDICINE PLATFORM AND ASSOCIATED SERVICES;” U.S. Provisional Patent Application No. 62/167,058, filed May 27, 2015, titled “TELEMEDICINE PLATFORM AND ASSOCIATED SERVICES WITH THIRD-PARTY INTERFACES;” U.S. Provisional Patent Application No. 62/247,584, filed Oct. 28, 2015, titled “TELEMEDICINE PLATFORM AND ASSOCIATED SERVICES WITH THIRD-PARTY INTERFACES;” and U.S. Provisional Patent Application No. 62/303,229, filed Mar. 3, 2016, titled “TELEMEDICINE PLATFORM WITH INTEGRATED E-COMMERCE AND THIRD-PARTY INTERFACES,” all of which are hereby incorporated by reference in their entireties. This application also claims priority to U.S. Provisional Patent Application No. 62/337,203, filed May 16, 2016, titled “SYSTEMS AND METHODS FOR ON-DEMAND CONSULATIONS;” U.S. Provisional Patent Application No. 62/353,865, filed Jun. 23, 2016, titled “SYSTEMS AND METHODS FOR VIRTUAL SALES SUPPORT NETWORK;” and U.S. Provisional Patent Application No. 62/378,590, filed Aug. 23, 2016, titled “SYSTEMS AND METHODS FOR VACCINE SCHEDULING AND MONITORING”, all of which are hereby incorporated by reference in their entireties.

### TECHNICAL FIELD

This disclosure relates to telemedicine platforms and associated services, including electronic medical record management, physician-customizable online portals, patient services, health-related online marketplaces, and secure messaging services.

### BRIEF DESCRIPTION OF THE DRAWINGS

Non-limiting and non-exhaustive embodiments of the disclosure are described herein, including various embodiments of the disclosure illustrated in the figures listed below.

FIG. 1 illustrates one possible embodiment of a screen shot of a user interface (UI) allowing a healthcare practitioner to choose from a preselected list of services and telemedicine features to create a practitioner-specific telemedicine portal.

FIG. 2 illustrates one possible embodiment of a screenshot of a UI allowing a user to initiate the integration of electronic medical records (EMRs) into the AZOVA™ system by selecting a third-party EMR provider from a drop-down list.

FIG. 3 illustrates one possible embodiment of a screen shot of a UI allowing a user to manage the sharing of personal medical records with one or more healthcare practitioners and/or healthcare facilities and/or other individuals.

FIG. 4 illustrates one possible embodiment of a screen shot of a UI allowing a user to manage the sharing of personal radiology studies with one or more healthcare practitioners and/or healthcare facilities.

FIG. 5 illustrates one possible embodiment of a screen shot of a UI allowing a healthcare practitioner to choose from a global list of categorized products for inclusion on a physician-specific marketplace that mimics or does not mimic the original global list of categorized products.

FIG. 6 illustrates a screen shot of a UI of a healthcare organization.

FIG. 7 illustrates another screen shot of a UI of a healthcare organization advertising an online open house.

FIG. 8 illustrates an example UI of a product available via a combination or integrated e-commerce and telemedicine platform, such as the AZOVA™ platform.

FIG. 9 illustrates an online clinic supported by the AZOVA™ platform integrated into a healthcare organization's website.

FIG. 10 illustrates a UI for a patient to select the type of telemedicine visit in which the patient is interested.

FIG. 11 illustrates a UI for a patient to shop online for various classifications, categories, types, or classes of telemedicine visitations.

FIG. 12 illustrates a UI for a patient to shop for and/or schedule an in-office visit.

FIG. 13 illustrates a UI for a healthcare practitioner to offer consultation and/or product packages at reduced or bulk pricing.

FIG. 14 illustrates the AZOVA™ platform used to combine e-commerce with a variety of professional service industries.

FIG. 15 illustrates various consultations offered by a healthcare practitioner via the AZOVA™ platform.

FIG. 16 illustrates the integration of telemedicine and/or other consultation services as part of a concierge offering of an existing website of a business using the AZOVA™ platform for backend support.

FIG. 17 Illustrates various consultation offerings supported via the AZOVA™ platform integrated into an online concierge offering.

FIG. 18 illustrates a UI of a mental healthcare practitioner offering various telemedicine consultations.

FIG. 19 illustrates a UI of an obstetrics and gynecology healthcare organization offering various telemedicine consultations via the AZOVA™ platform.

FIG. 20 illustrates a UI of an esthetic healthcare organization offering various in-office consultations via the AZOVA™ platform.

FIG. 21 illustrates a UI of a login and signup portal for patients, providers, and pharmacists, according to various embodiments.

FIG. 22 illustrates a UI for a patient or prospective patient to select any provider, including providers unaffiliated with the telemedicine platform.

FIG. 23 illustrates a UI for an esthetic healthcare organization that allows a patient or prospective patient to select a treatment and visitation type.

FIG. 24 illustrates a UI for a healthcare practitioner to customize the telemedicine offerings.

FIG. 25 illustrates a UI for a user to see, review, and/or schedule a visitation with any healthcare practitioner on behalf of the user or another.

FIG. 26 illustrates a UI of an online intake form for a patient or potential patient.

FIG. 27 illustrates a UI for showing historical consultations and visits, according to various embodiments.

FIG. 28 illustrates an automatic appointment reminder generated via the AZOVA™ platform that can be customized.

FIG. 29 illustrates a videoconference picture-in-picture that can be used as part of a telemedicine consultation.

FIG. 30 illustrates another videoconference picture-in-picture that can be used as part of a telemedicine consultation.

FIG. 31 illustrates a UI for providing a consultation or appointment status and notes, according to various embodiments.

FIG. 32 illustrates a UI for a provider of any of a wide variety of professional service types to a register for the AZOVA™ platform.

FIG. 33 illustrates another embodiment of a UI for a provider of any of a wide variety of professional service types to a register for the AZOVA™ platform.

FIG. 34 illustrates a UI for assigning individuals various roles with the AZOVA™ platform, according to various embodiments.

FIG. 35 illustrates a UI for customizing and configuring appointment types, according to various embodiments.

FIG. 36 illustrates a UI for customizing and configuring appointment types, according to another embodiment.

FIG. 37 illustrates another UI for customizing and configuring appointment types, according to another embodiment.

FIG. 38 illustrates still another UI for customizing and configuring appointment types, according to another embodiment.

FIG. 39 illustrates another UI for customizing and configuring appointment types, according to another embodiment.

FIG. 40 illustrates a UI for scheduling appointments types by type, according to another embodiment.

FIG. 41 illustrates a UI for group management to create groups of staff and/or healthcare practitioners within an organization and between organizations.

FIG. 42 illustrates a UI for creating coupons for various products and services, according to various embodiments.

FIG. 43 illustrates a UI for adding and/or customizing product and/or service offerings, according to various embodiments.

FIG. 44 illustrates a UI for ordering or requesting various imaging, studies, prescriptions, products, and/or services, according to various embodiments.

FIG. 45 illustrates a UI for creating and/or viewing an assessment, plan, and/or internal notes associated with an appointment, including a status identifier.

FIG. 46 illustrates a UI for a healthcare practitioner to provide an assessment and plan to a patient that includes a click-to-order link for imaging, studies, prescriptions, products, and/or services.

FIG. 47 illustrates a UI of one embodiment of an e-commerce integrated offering of the AZOVA™ platform, according to various embodiments.

FIG. 48 illustrates a graphical user interface of a consultation sourcing system for selecting a language, according to various embodiments.

FIG. 49 illustrates another graphical user interface of a consultation sourcing system for selecting a consultation language and time, according to various embodiments.

FIG. 50 illustrates additional options via graphical user interface of a consultation sourcing system for selecting a consultation language and time, according to various embodiments.

FIG. 51 illustrates another graphical user interface of a consultation sourcing system for menu navigation of categories of health services available for interpretations, according to various embodiments.

FIG. 52 illustrates an appointment scheduler for a consultation sourcing system, according to various embodiments.

FIG. 53 illustrates a secure payment system for a consultation sourcing system, according to various embodiments.

FIG. 54 illustrates a user calendar for a consultation sourcing system, according to various embodiments.

FIG. 55 illustrates a live translation service using a consultation sourcing system.

FIG. 56 illustrates a staff member schedule for a consultation sourcing system, according to various embodiments.

FIG. 57 illustrates a staff member view for a consultation sourcing system, according to various embodiments.

FIG. 58 illustrates an interface for a staff member profile generator, according to various embodiments.

FIG. 59 illustrates additional features of a staff member profile generator, according to various embodiments.

FIG. 60 illustrates additional features of a staff member profile generator, according to various embodiments.

FIG. 61 illustrates additional features of a staff member profile generator, according to various embodiments.

FIG. 62 illustrates additional features of a staff member profile generator, according to various embodiments.

FIG. 63 illustrates an interface for creating an appointment, according to various embodiments.

FIG. 64 illustrate a first portion of an interface for an appointment-type editor, according to various embodiments.

FIG. 65 illustrate another portion of an interface for an appointment-type editor, according to various embodiments.

FIG. 66 illustrate another portion of an interface for an appointment-type editor, according to various embodiments.

FIG. 67 illustrates a consultation sourcing system using a membership.

FIG. 68 illustrates menu navigation for a consultation sourcing system.

FIG. 69 illustrates a mobile log in for a consultation sourcing system.

FIG. 70 illustrates a first portion of a widget creator for a consultation sourcing system

FIG. 71 illustrates another portion of a widget creator for a consultation sourcing system.

FIG. 72 illustrates a consultation sourcing widget incorporated into a website.

FIG. 73 illustrates an appointment status interface for a consultation sourcing system.

FIG. 74 illustrates a staff information interface for a consultation sourcing system.

FIG. 75 illustrates a staff-type interface for a consultation sourcing system.

FIG. 76 illustrates a virtual sales support system installed in a store, such as a pharmacy or convenience store, according to various embodiments.

FIG. 77 illustrates a block diagram of a virtual sales support device, according to various embodiments.

FIG. 78 illustrates a flow diagram of a method for providing virtual customer support, according to various embodiments.

FIG. 79 illustrates a treatment type request page allowing a patient to select between various treatment types specifically relating to vaccines, according to various embodiments.

FIG. 80 illustrates a page for selecting the types of vaccines a patient would like to receive, according to various embodiments.

FIG. 81 illustrates a view of medical records, including vaccination records, accessible via an online healthcare portal that includes an integrated or connected vaccine management system, according to various embodiments.

FIG. 82 illustrates a provider list that allows a patient to select a provider to administer or provide consultation with respect to vaccines, according to various embodiments.

FIG. 83 illustrates a list of vaccines for a patient, dosages, recommendations, other information, and a validation status, according to various embodiments.

FIG. 84 illustrates a page for a healthcare profession to add vaccination detail, according to various embodiments.

FIG. 85 illustrates a summary page of information associated with a particular vaccine, according to various embodiments.

FIG. 86 illustrates a page allowing for automated or semi-automated adverse event reporting for vaccinations, according to various embodiments.

FIG. 87 illustrates a page allowing for the uploading or submission of documentation relating to vaccinations, according to various embodiments.

FIG. 88 illustrates an appointment scheduling tool to schedule appoints for one or both the patient and the healthcare professional, according to various embodiments.

FIG. 89 illustrates an appointment chart with quick access to records that have been shared with the healthcare professional, according to various embodiments.

FIG. 90 illustrates a view of the patient's history as shared by the patient with the healthcare professional, according to various embodiments.

FIG. 91 illustrates a sharing module that allows the healthcare professional to share the patient's record with others within a common organization and/or with others as authorized by the patient explicitly or implicitly, according to various embodiments.

FIG. 92 illustrates a provider interface for sharing patient information within a common organization, according to various embodiments.

FIG. 93 illustrates an assessment and plan module to allow for vaccines to be added and removed from a plan, according to various embodiments.

FIG. 94 illustrates a products and services module that allows a patient to select products and/or services for purchase during an appointment, according to various embodiments.

FIG. 95 illustrates a precision vaccination workflow, according to various embodiments.

FIG. 96 illustrates a block diagram of a vaccine management system, according to various embodiments.

### DETAILED DESCRIPTION

A telemedicine platform may include any number of features and options that may be commonly used by all healthcare practitioners and/or patients and other features and options that are not used by certain subsets of healthcare practitioners and/or patients, whether due to personal preference, usability, cost, or inapplicability. Accordingly, the present systems and methods provide various aspects, features, services, and functions relating to telemedicine healthcare platforms and auxiliary services and products. It is appreciated that any of the various embodiments described herein may be combined in any number of ways and that all permutations and combinations of the described features, advantages, embodiments, and options are part of this disclosure even if such permutations and combinations are not explicitly described in a single embodiment.

In various embodiments of the presently described systems and methods, a physician or other healthcare practitioner may create a customized telemedicine platform by selecting one or more telemedicine platform features from a preprogrammed set of available telemedicine features (i.e., a global feature set or global content library). Accordingly, rather than each healthcare practitioner being forced to use a generic telemedicine platform or developing a fully customized telemedicine platform from scratch, a healthcare practitioner may select from a list of available telemedicine features to create a customized telemedicine platform using preprogrammed features, functions, and/or interfaces.

In one specific example, a physician may begin the telemedicine platform creation process by selecting from a variety of webpage templates. Each template may offer varying services and different combinations of templates may be available for different layers/levels/areas of the final physician-specific telemedicine platform. A template may include various tiles, ribbons, windows, or the like that can be populated with any of a wide variety of services, features, menus, links, images, content entry forms, text boxes, radio icons, and/or other online content items. The physician may select from a global library of content items to create a physician-specific telemedicine platform.

According to various embodiments, the creation of a physician-specific telemedicine platform is more than just a customized webpage. For example, physicians may elect to include a wide variety of healthcare services, features, functions, databases, subsystems, etc. in their physician-specific telemedicine platforms, without necessarily needing to create or customize the underlying infrastructure required. For instance, a healthcare practitioner may decide to support face-to-face live videoconferencing between physicians and patients (and/or other healthcare practitioners). In various embodiments, healthcare practitioners may be able to customize and select top-level domains and/or customized subdomains to make it appear as if the platform is their own, even if the underlying infrastructure is provided by AZOVA™ or another service provider.

As used herein, the AZOVA™ system is a potential name or brand of a system embodying any one or more of the subsystems or embodiments described herein. However, any other name may be used without necessarily changing any functionality. As an example, the name “AZOVA” may be replaced or substituted by the name AZIVA™ or AVAMR™, and a related online store may be referred to as AZOVAShop, AZIVAShop, or AVAMRShop. Any other name or even a generic description might be used instead.

While the underlying infrastructure to support secure videoconferences may be complex, the presently described systems and methods allow the healthcare practitioner to simply select a “practitioner-to-physician videoconferences” content item from a library of content items. The underlying infrastructure is provided by the service provider and abstracted from the physician or another healthcare practitioner. That is, the physicians or other healthcare practitioners may be aware of the underlying infrastructure and associated complexity, but are not required to understand, manage, or otherwise concern themselves with the implementation thereof.

From the healthcare practitioner's perspective, a selection of a content item may be in the form of dragging and dropping a content item onto a webpage template, the selection of a radio button, moving an icon or text-phrase image to an “include” list, the selection of the item from a drop-down menu, and/or other selection action. As used herein, a content library is not merely a collection of text, images, and/or sounds, but instead includes a library of relatively complex telemedicine services and features that, in many instances, are associated and/or supported by a software and/or hardware infrastructure.

For example, from a physician's perspective, selecting a videoconferencing service from the content library that allows for practitioner-to-patient or practitioner-to-practitioner videoconferencing may appear as a simple videoconference icon or window on the practitioner-specific telemedicine platform. In fact, (possibly unknown to the physician), the videoconferencing library content item may be associated with a robust teleconferencing software solution running on remote servers that are administered, maintained, and/or paid for by the service provider.

In various embodiments, the videoconference functionalities may comply with any of a wide variety of data security and/or privacy regulations, such as HIPPA. In various embodiments, the secure videoconference functionalities may also allow for secure messaging (text, image, audio, document, etc.) during a videoconference with one or more entities. In some embodiments, screen sharing, document sharing, image sharing, videoconferences, and/or other visual communication functionalities may allow a healthcare practitioner, a patient, and/or an associated entity to draw graphics on screen (e.g., via a finger, mouse, stylus, or other input device), manipulate images, and/or otherwise provide live-time comments for viewing by both parties.

In some embodiments, face-to-face video consultations are enhanced by the ability to watch videos together (e.g., secondary videos, picture-in-picture, etc.), share documents, or otherwise collaborate. As previously discussed, the videoconference services may allow for live-time commentary or markup of the videos or other shared content.

In some embodiments, advertisements may be presented to a patient while the patient is on hold waiting for a face-to-face videoconference. In various embodiments, a healthcare practitioner and/or facility may select the advertisements that will be displayed. In some embodiments, the advertisements may be preceded or captioned by a notice that “Practitioner Name/Facility Name has selected the following informational videos for you to watch while you are waiting.” Accordingly, a doctor can approve or even endorse the videos or advertisements displayed to the patient. The videos may be tailored to the specific circumstances (diagnosis, medical history, etc.) and/or demographic information of the patient, such as gender, age, and the like. In some embodiments, the video selection may be based on a known insurance provider of the patient or a preferred vendor associated with the healthcare practitioner.

Numerous telemedicine features and services are contemplated as being selectable content items within the library of content items. For instance, a healthcare practitioner may elect to include a store-and-forward service in their practitioner-specific telemedicine platform. The store-and-forward service may allow a patient to upload photos, short videos, documents, and/or other information for a physician or another healthcare practitioner to review later.

Part of the ease of the presently described systems and methods is that the healthcare practitioner may not need to worry about local data storage, backups, servers to support the software, or the like. The supporting hardware and software for the telemedicine services elected by the healthcare practitioner may be created, managed, maintained, updated, and/or otherwise cared for without the electing healthcare practitioner's knowledge.

As another example, a combination of live videoconferences and store-and-forward services may be elected by a healthcare practitioner. In other embodiments, a healthcare practitioner may elect to include a “telephone call visit” as a telemedicine service on the practitioner-specific telemedicine platform. The telephone call visit may facilitate telephone calls between a healthcare practitioner and a patient, and may create, auto-generate, and/or semi-automatically generate a medical record of the telephone call and automatically place it into long-term storage as part of the patient's personal health record.

The global content library may include additional content items that may be optionally selected by a healthcare practitioner for inclusion on a practitioner-specific telemedicine platform. Such content items include, but are not limited to: urgent messages; urgent telephone call visits; insurance authorization requests; insurance notification features; after-hours patient request management and forwarding; doctor's note management, generation, forwarding, request, etc.; secure instant messaging; secure text messaging; secure mms messaging; secure sms messaging; secure email; secure out-of-band messaging; secure messaging through a third-party or other secure healthcare-specific messaging application; and/or any other service or product provided by a healthcare practitioner, practitioner's assistant, billing administrator, insurance administrator, and/or other involved party whose service or product can be provided or at least partially provided in an online format via a telemedicine platform.

Any one of the content items may be fully or partially customized by the healthcare practitioner for their particular practice. In some embodiments, each content item may include a set of customizable features that are readily customizable by the healthcare practitioner. In other embodiments, a healthcare practitioner may customize a particular content item by requesting a programmer from the service provider and/or a third-party programmer delete, add to, supplement, and/or otherwise modify features, advantages, or aspects of any given content item.

For example, a healthcare practitioner may select content items that allow for telephone call visits, doctor's note management, videoconferencing with patients, and cosmeceutical visits. The healthcare practitioner may also select a portal for a mini-store that allows for the purchase of various products or services. The service provider and/or the content items themselves may allow for semi-, partial-, and/or full-customization of any number of the selected content times. Such customization may come in the simple form of logos and the inclusion of personal information. Alternatively, the basic functionality, features, options, and other primary characteristics of a content item may be modified as desired by the healthcare practitioner.

In some embodiments, a Click-to-Talk or Talk to Us Now feature may allow a patient or potential patient to immediately contact a receptionist, healthcare practitioner, or other related entity via a messaging system, a videoconferences system, an audio discussion, and/or a store-and-forward messaging (video or audio) system. Staff members of a healthcare facility may be added using a drop-down menu for specific availability scheduling for the Click-to-Talk or Talk to Us Now feature.

In some embodiments, patients may be able to share their screen with a receptionist or other staff member who can help the patient fill out paperwork (e-paper work). In some embodiments, if the staff or receptionist is not available, then a message might be received by the patient noting that the [staff type] is not currently available. The system may then allow the patient or potential patient to sign in or sign up for a secure account to leave a HIPPA-compliant message for the healthcare facility.

In some embodiments, an intake form may be customized for particular visit types. For instance, the system may include four different e-visit intake form types, three different in-office form types, and two different in-home visit form types. Each visit type may need a different intake form attached to it and/or require different information based on the state regulations and/or insurance expectations. A form-building tool may allow a healthcare facility and/or practitioner to customize intake and/or follow-up visit forms for particular visit types, specialties, and/or other circumstances. Providers may provide their own intake forms that can be converted to digital forms and potentially added to the library of forms available to other customers.

The system may display all of the staff members of a facility and allow the patient or prospective patient to select a desired staff member and send a secure message, schedule an e-visit, schedule an in-person visit, manage bills, view lab results, etc. Various embodiments allow patients to make appointment changes, cancel orders, etc. Automatic refunds and/or partial refunds based on the number of hours prior to the scheduled visit a patient cancels may be available.

In various embodiments, other content items that may be added to the practitioner-specific telemedicine platform may relate to wearable health monitoring devices, remote monitoring systems, wellness coaching programs, and the like. For example, wearable and monitoring devices may have application programming interfaces (APIs) that are accessible and allow for data to be aggregated, stored, shared, displayed, and/or otherwise used with in the AZOVA™ system. Similarly, if a coaching program, wearable device, monitoring device, or other device or service has a portal or allows other online access, the portal or online access may be integrated as a content item into a practitioner-specific telemedicine platform.

In various embodiments, the AZOVA™ system allows healthcare practitioners and/or other providers to customize a telemedicine platform for their specific practice. For example, a general practice physician may desire to present their “own” telemedicine platform with a unique interface and a variety of available features and services that is vastly different from the telemedicine platforms offered by a pharmacist, a therapist, a radiologist, a dietician, a physical therapist, etc.

In some embodiments, the AZOVA™ system allows for modular applications to be selected by the healthcare practitioner for inclusion in the healthcare practitioner's customized telemedicine platform. Each of the modular applications may be purchased and/or subscribed to the healthcare practitioner on an individual basis or as part of packages of product and services for specific industries.

The discrete modular applications may AZOVA™ specific applications designed, owned, provided, and/or serviced by AZOVA™. In other embodiments, the discrete modular applications may include third party applications, interfaces, services, products, and the like that are integrated into the backend of the AZOVA™ system. In some embodiments, the AZOVA™ system may act as an integration hub to provide a common or standardized connection between all of the discrete third party applications, interfaces, products, and services.

Examples of third party applications that can be integrated into the AZOVA™ system and/or selected for inclusion in a customized telemedicine platform by a healthcare practitioner include, but are not limited to: interfaces and monitoring software associated with biometric monitoring and/or tracking devices; patient engagement solutions, interfaces, programs, etc.; electronic health record interfaces and portals; cardiology recovery and monitoring applications; laboratory interfaces; cholesterol management services, portals, interfaces, and the like; lipid management and monitoring software solutions; asthma monitoring and management systems; blood pressure monitoring and management services and interfaces; weight loss management, support, monitoring, and advisory systems; and/or other third party provider-patient interface, monitoring and/or tracking solutions.

As a specific example, a healthcare practitioner may select (e.g., via an a La Carte or package subscription or one-time purchase) an application for integration or inclusion in the healthcare practitioner's telemedicine platform that provides a specific patient engagement platform. Based on the healthcare practitioner's specific needs, the integration and/or inclusion of specific products and services into the customized telemedicine platform may provide significant advantages to the medical providers, managers, and/or patients. For instance, a customized patient engagement application may be integrated into the AZOVA™ system to facilitate, control and/or manage how information is disseminated (e.g., via patient portals, hard copies, electronic communication, etc.), interactions between providers and patients (video, voice, messaging, store and forward, in-person, etc.), how data is collected or reported via testing and/or monitoring devices, and/or effect other patient engagement details.

As another example, a family physician may create a customized telemedicine platform and select a package of applications (e.g., a free package, via a one-time purchase, or as part of a subscription plan) that includes various patient interfaces and/or monitoring services associated with diet plans, cholesterol management, physical therapy, medication management solutions, and/or the like. In such embodiments, the family physician may utilize the AZOVA™ system to provide an online telemedicine platform that is more robust and offers services and products that the family physician might not otherwise be able to offer.

In various embodiments, third party developers may develop applications for inclusion and/or incorporation into the AZOVA™ system. Third party applications may pay to be listed on the AZOVA™ system and/or the AZOVA™ system may collect a percentage or other fee based on the usage and/or inclusion of each third-party application on a provider's customized telemedicine platform.

The practitioner-specific telemedicine platform may be referred to and/or include a “dashboard” of features and/or services that are available to the healthcare practitioner, patients of an associated healthcare practitioner, family of patients of an associated healthcare practitioner, friends of patients of an associated healthcare practitioner, other associated or relevant healthcare practitioners from other healthcare facilities, and/or other entities. The dashboard of features and/or services available to each of these entities may be regulated and/or restricted based on the entity accessing the telemedicine platform, permission settings, and/or based on the assigned feature sets to each specific entity.

Any of a wide variety of health and wellness platforms may be integrated as content items (potentially customizable) available for inclusion in a practitioner-specific telemedicine platform. Such platforms include, but are not limited to: stress-reduction programs, weight loss counseling, group therapy sessions, and the like that might be implemented (in person, via teleconference, via videoconference, etc.) within or through integration with the AZOVA™ system.

As a specific example, a healthcare facility may create a customized facility-specific telemedicine platform that includes integration with a yoga instruction class that is taught online by a world-renowned specialist. Similarly, a practitioner-specific telemedicine platform may provide a mechanism through which classes are taught or training is provided to groups of any size (patients or other physicians) regarding any of a wide variety of topics. Thus, providers may use the AZOVA™ system to create a customized conglomerate of existing services and platforms and couple them with any of the other content items described herein. Some of the integrated services, platforms, content items, and the like may be managed and provided by the service provider, while others may simply be integrated via screen-scrapes, links, APIs, and/or the like.

According to various embodiments, any of a wide variety of financial models may be used to charge for the use or inclusion of the services and features described anywhere herein. Fees may be paid by a healthcare practitioner to the service provider (i.e., the creator/supplier of the global content library, e.g., AZOVA™), by a patient to the service provider, by the patient to the healthcare practitioner, and/or by the healthcare provider to the patient. The fees paid may be based on a subscription model, pay-per-use model, or based on a one-time fee. Any of a wide variety of tiered, discounted, incentive-based, and other financial models may be used. For example, in some embodiments, a variation of a concierge subscription model may be used where the patient pays the healthcare provider on a monthly or yearly basis for predetermined telemedicine and/or in-person services.

As an additional example, a service provider may charge a periodic (weekly, monthly, yearly, multi-year) fee to a healthcare practitioner based on the number and types of content items selected for inclusion on the practitioner-specific telemedicine platform. For instance, pricing models may be created for each content item and/or for packages of content items. In some embodiments, a flat pricing model may be implemented in which a healthcare practitioner pays the service provider a flat rate (one-time or subscription-based) to create a practitioner-specific telemedicine platform with any number or type of content items from the library of content items. In other embodiments, the pricing may be a la carte based on the specific content items selected. In yet other embodiments, the pricing may be based on the actual usage of each of the elected content items included in the practitioner-specific telemedicine platform.

In some embodiments, the healthcare practitioner may decide to charge patients directly for usage of the practitioner-specific telemedicine platform. In such an embodiment, a physician may generate a profit on the practitioner-specific telemedicine platform if the income received from the patients exceeds the fees charged by the service provider. As above, the physician may charge patients based on actual usage, the features/services used, under a subscription model, as a percentage of other healthcare costs, etc. Using any of the models described above, a healthcare practitioner may charge or bill an insurance company for the insurer's usage and/or the patient's usage of the practitioner-specific telemedicine platform. The ability to bill or the automatic billing of an insurance provider may be turned on or off on a visit-by-visit basis. In some embodiments, a healthcare practitioner may indicate that a visit is a follow-up telemedicine visit to an in-person visit. This may be important because some insurers and/or regulatory entities (e.g., a state) may require that first visits or periodic visits be conducted in person. The system may dynamically adapt itself based on the zip code or other residency-identifying information and/or insurance information of the healthcare practitioner and/or patient to maintain compliance with all applicable laws and/or insurance rules.

In some embodiments, patients may create accounts with the service provider independent of the healthcare practitioners and/or insurance companies. Pricing models may vary based on the parties' interactions and/or affiliations with the service provider. For example, the fees charged to a healthcare practitioner and/or a patient may vary based on the pricing agreement of one or both parties with the service provider. For example, if the healthcare provider is a subscription-based customer of the service provider, any interaction by the patient with the healthcare practitioner may be free of charge. Whereas, if the healthcare provider is using a free, one-time payment, trial, discounted, split-fee arrangement, or other pricing model, an interaction by the patient with the healthcare practitioner may be billed or charged to the patient by the healthcare practitioner and/or directly by the service provider.

In addition to the content items described above and regardless of the pricing model used, the content library may include any number of telemedicine features, functions, products, services, and/or the like that are known in the art of telemedicine platforms. These previously known telemedicine services, features, and functions may be recast as optionally selectable content items that can be included in a content library and made available for selection by a healthcare practitioner for inclusion in a practitioner-specific telemedicine platform.

The telemedicine platform provides advantages to and can be used by any of a wide variety of people associated with healthcare, including, but not limited to: pharmacists, physicians (MDs), osteopathic physicians (DOs), nurse practitioners, physician's assistants, mental health professions, psychologists, social workers, mental health therapists, health and wellness professionals, dieticians, nutritionists, associated insurers, agents, billing specialists, patients, and/or other persons or entities associated with mental, beauty, physical, and other healthcare areas.

Many of the embodiments described herein use a “healthcare practitioner” as an example of the entity that is creating, customizing, selecting, and/or otherwise utilizing the AZOVA™ system. However, it is appreciated that the entity actually managing, setting up, initializing, or otherwise involved with the AZOVA™ system may be a healthcare administrator, information technology (IT) specialist, or other entity that does not necessarily treat, test, diagnose, or otherwise interface with patients. Such entities may be referred to as “providers” inasmuch as they provide services to patients.

In various embodiments, the system may include and/or support custom, semi-custom, or standardized integration with one or more laboratories, imaging centers, and/or other healthcare-related facilities or service centers. The AZOVA™ system may include, or allow a healthcare practitioner to enable, integration with any number of laboratories, such as blood or pathology laboratories, or imagining centers, such as radiology imaging centers and/or hospital imaging centers. For example, in some embodiments a healthcare practitioner may customize a “provider dashboard” to include or otherwise indicate which of a plurality of laboratories and/or imaging centers are supported.

Thus, a healthcare practitioner may customize a telemedicine platform to include a list of laboratories and/or imaging centers from which a patient may import electronically (e.g., via formal or simplified order requisition of medical records) medical information (e.g., pathology test results, images from a medical imaging consultation, etc.). In some embodiments, the laboratories and/or imaging facilities selected by a healthcare practitioner may appear on the healthcare practitioner's dashboard during a patient consultation. The healthcare practitioner may schedule consultations, tests, imaging, etc. with any of the listed laboratories and/or listed imaging facilities.

In various embodiments, a dashboard may allow a healthcare practitioner, an assistant, a patient, and/or a patient's representative to schedule an e-visit, an in-office appointment, a house call, and/or other consultation. In one possible embodiment, scheduled visits (whether e-visit, in-office, house call, or other) may be color coded on a calendar.

A physician, healthcare provider, or facility may offer one or more types of visits and online scheduling of the same. In some embodiments, patients and/or healthcare practitioners may use the system to schedule in-person or e-visits on a case-by-case basis.

A Find an Appointment or Find a Provider page may allow a patient to select type of visit, specialist needed, an address, identifying information, medical history, medically relevant facts, maps, contact information, etc. that can be used to schedule a first or follow-up visit. A specific provider may be presented to the patient for selection along with available appointment times and scheduling abilities.

In some embodiments, patients and/or healthcare practitioners may be presented with or search for specials, membership opportunities, package deals, and/or concierge service.

For example, a patient may visit Laboratory A for a blood test and then visit Laboratory B for a pathology test. The patient may then return to the healthcare practitioner for a follow-up consultation. The healthcare practitioner may access a dashboard during the follow-up consultation and open an order requisition to select and/or request the desired tests or studies from Laboratory A and Laboratory B.

As described herein, the system may facilitate scheduling patients for e-visits, in-office visits, in-home visits, etc. Additionally, the system may allow for integration with population health management programs. Population Health Management (PHM) may be understood as an aggregation of patient data across multiple health information technology resources. PHM may also include the analysis of the aggregated data into a single, universally available patient record. PHM may also include the actions through which healthcare providers can improve both clinical and financial outcomes. A goal of PHMs is often to improve both care and financial efficiency.

In various embodiments, the system provides integrated access to providers and other entities associated with a capitated plan model or an accountable care organization (ACO). Such entities may need to monitor large numbers of patients with, for example, certain chronic diseases such as asthma, diabetes, hypertension, congestive heart failure, and/or chronic obstructive pulmonary disease (COPD). The system may provide (1) remote monitoring capabilities, (2) the ability to schedule any number of patients with any number of common problems, and all in conjunction with (3) scheduling of any number of other visit types using the same platform and tools.

In some embodiments, the order requisition may be pre-populated with personal information about the patient (e.g., name, age, identification information, social security information, medical record identification numbers, and/or other patient demographic information), information regarding the healthcare practitioner (e.g., personal, entity, and/or other identification information), insurance information, proof of authorization to access medical records, and/or other information for accessing, requesting, and/or transferring medical records.

Because the AZOVA™ system in many embodiments is not restricted to any particular electronic medical type or format, healthcare practitioners can configure their personalized telemedicine platform to interface (e.g., via a dashboard interface) with any of a wide array (potentially all) laboratories, imaging centers, and other healthcare-related facilities. In some embodiments, the order requisitions may be electronically sent and received or may be sent and received manually (e.g., hardcopy), depending on the capabilities of the selected laboratory, imaging center, and/or other healthcare-related facility.

In some embodiments, custom HL7 interfaces for each EMR may be avoided or eliminated by integrating each facility with the AZOVA™ system, regardless of the specific EMR format utilized. Based on participation and integration, the AZOVA™ system may allow for any healthcare practitioner or facility to access data from any laboratory, imaging center, and/or healthcare-related facility in the world.

Underlying interfaces of the AZOVA™ system with order requisitions can be done in some embodiments via a digital version of a requisition hosted on the AZOVA™ platform. In other embodiments, the underlying interface of the AZOVA™ system for order requisitions may include an interface with a requisition process on a website or other portal of the laboratory, imaging center, or other healthcare facility.

When interfacing with the electronic requisition portal of an external laboratory, imaging center, or other healthcare facility, the AZOVA™ system may provide the necessary information to complete the requisition. Such information may vary based on the specific electronic requisition portal and may include patient name, date of birth, address, insurance information, billing address, shipping address, electronic contact information, other demographic information, personal identification numbers, and/or the like.

In various embodiments, patients, healthcare practitioners, laboratories, imaging centers, and/or other healthcare entities/facilities may have unique AZOVA™ handles that allow for secure messaging and interfacing without potentially revealing personal information between entities. That is the AZOVA™ system may keep, hide, or selectively reveal private, personal, HIPPA protected, and/or other information between interacting entities. For example, patients and providers (e.g., healthcare practitioners) may communicate using secure messaging within the AZOVA™ system using AZOVA™ specific handles.

In some embodiments, a laboratory may have access to a HIPPA secure dashboard within the AZOVA™ system where they can manage orders made via the AZOVA™ system. Alternatively, orders made via the AZOVA™ system may be transmitted to the relevant laboratory via email, e-fax, or physical mail. In various embodiments, the AZOVA™ system may provide the laboratory an interface whereby they can send invoices directly to the requesting healthcare practitioner and/or patient using the AZOVA™ handle of the healthcare practitioner, an associated insurance, and/or a patient. The invoice may be send to an address (electronic or physical) associated with the AZOVA™ handle.

In some cases, a custom requisition may be built for each laboratory that, when selected from the healthcare practitioner's dashboard, may deploy the requisition with the patient and the healthcare practitioner's demographics and insurance information as required by the laboratory. Each item that is offered by the laboratory may be listed with a respective price and description as well as any requisite test kits that may be needed to collect that specimen that is ordered by the healthcare practitioner.

The listing may be integrated with an online shop or marketplace of the AZOVA™ system (e.g., AZOVAshop.com) where the respective laboratory will have a backend account to upload all products, their descriptions, and any required testing kits or supplies that will be needed for that particular test. The cash price, discount price based on membership, insurance price, wholesale price, or other price for the test and/or supplies may also be listed. When a healthcare practitioner selects a particular test while an appointment page is open in their dashboard, the test may be sent to the patient's chart as a “healthcare practitioner's order” along with a link to purchase the test. The patient may also indicate via a button, menu selection, or added note that the laboratory should bill an insurer.

Laboratory interfaces on the AZOVA™ system may provide an indication of specimen collection types to the healthcare practitioner and/or the patient. Collection types might include:
(1) Remote phlebotomy services, in which case the patient may be presented with a link to purchase a remote phlebotomy service;
(2) In-home saliva, dried urine, finger stick, tissue collection, and blood spot tests, in which case the patient may be presented with a link to purchase the blood work. Once payment has been received by the AZOVA™ system or an associated payment system, the AZOVA™ system may route the order to the respective laboratory. The laboratory may then ship the appropriate test kit(s) to the patient. Once the results are available, the laboratory may upload and transmit the results to the patient and/or the doctor via the AZOVA™ system (e.g., via an entity-specific dashboard) by using the AZOVA handle of the healthcare practitioner and/or patient.
(3) Require the patient to go to a blood draw station or other specimen collection site, in which case the actual requisition is sent to the patient as a document. The patient can print it out and take it to the blood draw station or another specimen collection site.

As indicated above, laboratories, imaging centers, and/or other healthcare-related facilities may sell, advertise, and/or otherwise offer products and/or services via the AZOVA™ system, such as within an AZOVAshop.com website. When a healthcare practitioner creates a customized or semi-customized telemedicine platform, the healthcare practitioner may select (or it may be automatically included) to create an associated e-commerce interface (e.g., a personalized or semi-custom AZOVAshop.com).

For each laboratory, imagining center, and/or other healthcare-related facility included by the healthcare practitioner on the customized telemedicine platform, the services and/or products may be included automatically within the personalized e-commerce interface. Products and/or services for each laboratory, imagining center, and/or other healthcare-related facility may be associated with a SKU allowing for easier inclusion and unique identification on each unique e-commerce interface of a plurality of healthcare practitioners' customized telemedicine platforms.

Laboratories may upload a list of products and services, along with associated costs and details of administration via an e-commerce interface (e.g., AZOVAshop.com). The laboratories may indicate the name of the laboratory, payment types accepted, insurances accepted, collection method for the test, test type, etc. For each product or service offered, the MSRP or standard pricing of the lab test may be indicated. In some embodiments, the listed MSRP price may be require to be less than, equal to, or greater than (but capped at, for example, 10% greater than or 20% greater than) other online prices offered by the laboratory. A sale price for AZOVA™ system users may be listed as well (e.g., 20% below MSRP or standard pricing).

Examples of collection methods may include blood draw stations, mobile phlebotomy, dried urine, cheek swab, saliva, culture swab, finger stick, tissue specimen, and the like. Examples of test types include blood, urine, tissue, genetic, and the like.

In various embodiments, when a healthcare practitioner (e.g., a primary care physician) selects a laboratory, imaging facility, or other external healthcare facility from the AZOVA™ system, a requisition form may be populated with all or a subset of the tests that can be ordered from the selected laboratory, imaging facility, and/or other external healthcare facility. For example, all of the available tests may be populated on the requisition form in alphabetical order and/or in another order based on customized preferences of any involved entity.

Multiple possible scenarios are possible when a healthcare practitioner orders particular lab work from a laboratory (similar scenarios are possible for imaging centers and/or other entities). Examples of a few are provided below in which the healthcare practitioner is referred to as a “provider”:

Scenario 1: The test is cash only at a standard blood draw station. The test may be sent to the patient in their Plan section (of their chart) with a button (or other icon or option) to purchase. When the patient pays, the patient will receive the order form as a receipt. The order form may comprise relevant patient demographics and/or other personal information, ordering/requisitioning provider demographics and/or personal information, the test(s) ordered, an indication of where the results should be sent (e.g., to the patient and/or the requisitioning provider), the doctor's electronic signature, and/or the patient's and provider's (e.g., the doctor's) AZOVA™ handles. In various embodiments, the order form may look like a standard order form. In some embodiments, the order form may include a UPC code or other electronically readable identification information that will allow electronic tracking and/or order history information.

Scenario 2: The test is cash only and is dried urine, cheek swab, blood spot, finger stick, or the like. The provider may select one or more of these tests, the respective tests may then appear in the plan section of the patient's chart along with a button to purchase the products. The order form may include of patient demographics/information, ordering provider's demographics/information, the test(s) ordered, an indication if the results should go to the patient and/or the provider, the doctor's electronic signature and the patient and provider's respective AZOVA handles. When the patient purchases the products (tests), the order requisition may be sent to an appropriate laboratory's AZOVA™ dashboard and display as “pending orders.” The laboratory may then ship the test kit to the patient or have the test kit ready for pickup by the patient. The patient may then collect the specimen and send it back to the lab. When the results are ready, the lab may upload them to AZOVA's messaging platform and send them to the patient and/or the provider using their respective AZOVA handles.

Scenario 3: The lab test is cash only and is mobile phlebotomy. The mobile phlebotomy may be sent as a separate line item to the patient for purchase. The provider may then order the mobile phlebotomy.

Scenario 4: The test is insurance eligible and is mobile phlebotomy. The patient may receive the order form as will an appropriate laboratory. The laboratory may then contact the patient to arrange for phlebotomy and insurance billing.

Scenario 5: The test is insurance eligible and is standard blood draw station. The patient may not need to pay to get the order form. The order form may be embedded/attached to the visit note from the provider. The patient can print it or take it to the appropriate laboratory for blood work.

Scenario 6: The test is dried urine, cheek swab, blood spot, saliva, finger stick, and/or tissue collection and is insurance eligible. The order form may be sent to the patient and the laboratory. The laboratory may then send the collection kit to the patient and manage the insurance billing information.

Scenario 7: The test is tissue collection and cash only. The item may be sent to the patient's plan section of their note from the provider for purchase. The patient may pay for the test and the order may then be transmitted to the lab. The lab may then send the ordering provider the test kit (or the patient can go to the provider's office where the provider may already have some of the test kits) and the tissue specimen will be taken and sent to the lab. An example of this scenario may be when a tissue pathology laboratory is used to process specimens that are taken in a provider's office, but that were ordered by the provider as the result of a telemedicine visit.

In various embodiments, under each lab product entered the site, there may be a box for “Provider's Comments to the Laboratory.” This may appear along with the product and/or service that will be in the plan section of the patient's note once the provider has selected the item. Accordingly, a provider can specify/clarify details of the test/service for the laboratory.

In some embodiments, when a healthcare practitioner configures the laboratories from which lab work will be ordered, the healthcare practitioner may simply select (e.g., via a click) those laboratories from a list of available laboratories that the healthcare practitioner wishes to utilize. The selected laboratories may be used to populate the healthcare practitioner's dashboard under “Laboratories.”

Radiology may be very similar or the same as the examples and scenarios described herein with regard to laboratories. For example, orders may be cash or insurance eligible and the order may be sent to the patient and/or the imaging center. The AZOVA™ system may include all requisitions, a place for patients to consent to have their results released to themselves and/or to the requisitioning healthcare practitioner.

Another feature of the AZOVA™ system may, in at least some embodiments, include a remote answering service (e.g., OnCallButton.com). The remote answering service can be used during or after hours to field patient calls and to contact the healthcare practitioner in the case of an emergency.

As a specific example, a healthcare practitioner's office may record a message on its after-hours phone that states: “For after-hours consults, please go to our web site at www.example.com and click on our ON CALL BUTTON. Here you can reach the On-Call doctor (or other provider) via an on-line after hours visit.” The message can be adapted for a particular practice and/or specific details for contacting. The message may also provide a telephone number as an alternative.

In various embodiments, a patient may call the number at which point they may be prompted to record a message for the on-call provider regarding why they need after hours help. This message could also be recorded at the point of the initial phone call above, i.e. when the patient calls the clinic after hours in the first place. In some embodiments, the message may prompt the patient to record a message about why they need to contact the on-call after-hours provider. Once the message is recorded, or if the patient just calls the on-call number, the AZOVA™ system may use an IP-based telephony solution to call the on-call provider.

When the patient visits the after-hours section of the website as a result of the initial phone call (as opposed to recording a message that is routed to the on-call provider) an OnCallButton icon (or other icon that could be configured for many other uses) on the website may take the patient to a very simple telemedicine visit called an After Hours On-Line Visit (or another name as selected by the provider). The provider can opt to charge for this visit or not to charge for this visit type. The visit could also be configured to load the doctor/provider's full telemedicine clinic offerings if the provider has subscribed to the full The AZOVA™ system platform.

In various embodiments, the patient may pay for the after-hours consultation/visit and then enter health information as prompted. For example, the patient may be asked why they need to reach the on-call provider, request medical information. Some information may be pre-populated if the patient already had an account with the AZOVA™ system. The patient may also be prompted to upload photos of any problem they may have. Once the patient has filled out all the required information, the patient may securely transmit and the information via the AZOVA™ system to the provider's email and cell phone (or other secure messaging system) where a message will appear that indicates that “an after-hours consultation is waiting.”

The consultation may appear inside the provider's Dashboard under “Consultations” or “appointments.” The doctor may read the information and respond electronically through the platform or can call the patient as needed.

On the provider's back end, a single phone number may be used for the clinic's on-call service. This is the phone number that will be recorded on the office voice mail that the patient is supposed to call if they do not have internet access. The provider's phone numbers may never be displayed. On the clinic admin dashboard, the clinic may log in to the back end to change the phone number, email and AZOVA handle to those of whomever is on call. The calls, texts and emails can be directly routed to that person after hours. The system may have an auto-updating schedule of afterhours providers.

In some embodiments, the system may include or be optionally configured to include an integrated emergency medical services (EMS) application. The EMS application may have an on button push or instant connect option that allows a healthcare practitioner, patient, and/or other user/operator to call EMS or other assigned entity or person.

In various embodiments, the system may instantly open a streaming video interface allowing EMS to see and communicate with the person who is in the emergency situation (e.g., the patient, other person on hand such as a bystander, and/or a healthcare practitioner who was contacted first and may still be on the line).

In some embodiments, the system may automatically and/or instantly stream video. Because the system being used for the EMS contact is the same system that has access to the patient's EMR, the system may provide the EMS or other emergency responder access to the patient's EMR upon request or at the same time as alerting EMS.

Similarly, the system may provide access to emergency responders and other healthcare practitioners in an emergency room (ER). A healthcare practitioner in the ER (or other healthcare facility) may log in to their account. A patient may log in to their account and authorize (permanently or temporarily) one or more portions of their EMR. Effectively, a patient may instantly share their entire personal health record (or a portion thereof) with any hospital or healthcare professional.

As described herein with regard to other EMR sharing, the patient may share information from their personal dashboard and sending it to an interfaced EMR. The system may create an instant message that would go to an email address where the recipient (the one who owns the email address at the ER) would receive a secure message and be instructed to log in or sign up and see the information that was transmitted by the system at the instruction of the patient. Once signed up/in, the recipient will have instant access to the patient's entire medical record or the shared portion thereof.

In various embodiments, the AZOVA™ system may include online open houses and/or monthly specials. For example, since the AZOVA™ system is used by providers and any other business, it may be beneficial to allow such entities to conduct online open houses and/or to promote and sell any specials

For example, an open house may allow a provider (or other customer of the AZOVA™ system) to offer remote consultations over the internet and to make a recommendation for appropriate services and specials to the prospective client online. The specials will be available to purchase in association with a consultation during the online open house promotion. When a provider configures an online open house, the provider may select and configure (choose the descriptions and price) of any visit type that is offered via the AZOVA™ system to be offered as part of the open house. The provider can also choose to charge a fee or to offer the consultation for free.

The specials that are offered as part of the open house may be completely customizable by the provider. As a specific example, the provider may have a tool on their dashboard that says “Promotions.” Under this button will be a drop-down menu that has “Customize Your On-Line Open House” and “Monthly Specials” where the provider can create specials that may include “buy one chemical peel and get one free” or a particular product can be displayed at a particular discount. Any services of any professional could be configured to be on sale or promotional in this way. This platform may also allow the provider to sell their own in-stock inventory from their “specials” website if desired.

Once the provider has configured their Online Open House and their monthly specials, the system may generate a widget (which will also be customized by the customer to match their website) that says “Our Monthly Specials” and “On-Line Open House Going on Right Now.” When a prospective client/patient clicks on the widget(s), a webpage may open displaying the monthly specials and the Online Open House products along with the interface to the telemedicine clinic. The top of the page for the open house and monthly specials may have “Get an Online Consultation. Find Out What Is Right for You!”

There may be a small image of an online consultation taking place on the right with a drop-down menu of the providers in the practice from which the patient can select the on-line consultation. The providers may be able to configure their consultation fees and the special prices of their consultation fees on their backend. The widget for the Online Open House can be placed anywhere on the provider's website including the home page and/or on a telemedicine clinic button.

The AZOVA™ system may include “Specials” and/or “Open House Discounts” pages or websites that conglomerate all of a particular healthcare practitioner's telemedicine platform subscriber's ongoing specials into a single location. This may allow customers/patients to shop for discount products and services. In various embodiments, the AZOVA™ system may charge a referral fee for any leads/sales that are generated using this feature.

In various embodiments, a healthcare practitioner or organization may incorporate or link any of the various embodiments, functionalities, services, or the like via a button, link, or other graphical user interface (GUI) element on an existing website, application, program, or other user-accessible electronic content.

Various embodiments of the system and methods described herein allow prospective and existing customers or patients to browse products and services, some of which may be associated with an office consultation (in person or via telemedicine). Thus, in contrast to an independent e-commerce platform and a separate telemedicine consultation platform, the present systems and methods effectively provide or generate a composite website or platform that incorporates elements from a product/services sale page and telemedicine consultation offerings.

E-visits or telemedicine consultations associated with products may utilize various technology interfaces, including: face-to-face video, store and forward video/text/images, secure messaging, telephone, house calls, office visits, hospital visits, and/or in person. In some embodiments, free consultations may be offered to entice new customers or retain existing customers. In some instances, consultations that would normally cost money may be offered for free or at a discounted price if selected in the context of purchasing a product. For example, the purchase of a particular face cream or subscription to a medication may include a free telepresence consultation. Such a consultation may also be required for the purchase. For instance, a prescription medication available for purchase may be coupled to a telepresence consultation during which the healthcare practitioner can provide the requisite prescription for the medication.

In various embodiments, visits of any type can also be customized based on a referral from another provider. In some embodiments, in-office appointments and procedures can be offered and scheduled by a patient without generating a phone call.

Offerings may include products and services, some of which may be coupled with consultations. Memberships and packages may also be offered. Thus, a provider can offer a combination of products and services and package them together. Such combinations may be offered at discounts and may include one-time purchases, monthly subscriptions, and/or other periodic recurrence.

Again, while many of the embodiments and examples provided herein focus on healthcare and related fields, the platform can be adapted for use with any of a wide variety of service- and product-providing industries, including medical, mental health, health and wellness, pharmacists, laboratories, imaging centers, dentists, veterinarians, lawyers, etc.

In some embodiments, the platform is used to configure a concierge offering for existing businesses. For example, the platform can be customized in a matter of minutes for integration with an existing website to provide a concierge package of products and services that can be customized for the particular business.

In some embodiments, adoption of the platform is encouraged by allowing patients and prospective patients to select, contact, and/or be connected with any service provider, even those service providers that are not affiliated with the platform. In such embodiments, the unaffiliated service provider may be encouraged to become an affiliate.

In some embodiments, an intake form or patient submission form may allow a patient, prospective patient, and/or agent of a patient to describe the reason for the visit (e-visit or otherwise). The intake process may allow the user to provide images, videos, or documents. In some embodiments, a model of a human may be shown that allows the patient to indicate where exactly the problem or issue is on the body.

Various embodiments include historical data accessible to patients and/or healthcare practitioners to view past appointments. The historical information may include only the history relevant to the particular healthcare facility or organization, or may include all history from all health professionals, pharmacists, laboratories, or imaging centers. In such embodiments, a patient may be able to selectively hide some of the information from other practitioners.

Images and documents shared during video consultations may be edited, marked-up, and/or otherwise manipulated. In some embodiments, storage of images, documents, video, and other data may be paid for by the patient and/or the relevant healthcare organization. In some embodiments, other affiliated healthcare organizations and practitioners may be charged for accessing stored data belonging to patients and/or other organizations and/or practitioners.

In some embodiments, during an e-visit, such as a video telemedicine consultation, a patient is asked “would you like to record this video (or phone) consultation for future reference?” If the patient consents, a fee may apply. The fee may be charged to the patient, insurer, healthcare provider, or another person. In some embodiments, the fee may be subsidized by a third-party organization upon consent of the patient and/or healthcare practitioner to share data associated with the consultation.

The platform may be configured to notify a patient and/or healthcare provider that a particular entity is doing a study related to the type of medication, disease, product, or other aspect of a consultation and request anonymized or un-anonymized information. Incentives may be provided for those providing the desired information.

A status of a consultation or visit may be accessible to patients and/or healthcare practitioners to allow for easy tracking of next-steps or outstanding tasks. In some embodiments, a change in status of a consultation may trigger a notification to relevant parties. For instance, each update may be sent to a patient so the patient knows what is being done for them (e.g., “Your order has been sent to the lab” or “Prescription sent to the pharmacy”).

In various embodiments, the platform may allow for the creation and management of groups. Groups may be created that include various staff members and healthcare professionals. A unique clinic URL can be created for each provider or combination of providers and staff members. As an example, a primary care physician or a mental health or wellness provider may be included in any number of other specialty clinics. These groups may include various specialists and general practitioners that are not physically near each other. Specialists may be included in multiple groups to effectively share their specialized skills between various groups, potentially minimizing the costs of care with specialists and providing an introduction of specialists into unique circles of general practitioners.

Products can be configured and sold through a custom online store that is integrated with the online clinic and/or telemedicine consultations. Coupons can be created for any visit, any provider, or an entire group. The traditional process may include a healthcare provider recommending a treatment or product. The patient then leaves and goes to another, unrelated entity (e.g., a pharmacy) to purchase some variation of the product or treatment with potential for some deviation from the original recommendation. The presently described combination may allow for increased profits to the original healthcare practitioner and may also be instrumental in improving patient outcomes by improving compliance.

Laboratory ordering, imaging, and prescriptions may all be integrated and connected. Lab tests, prescription drugs, and imaging studies can be offered for sale on the health professional's online store or can be ordered by the health professional as the result of a consultation purchased through the online clinic. The patient can pay cash or use insurance if that option is offered by the health professional. In various embodiments, patients can select products and add them to their online shopping cart and just as easily add studies, imaging, reports, prescriptions, subscriptions, lab tests, pharmaceutical products, or other items to an online cart for checkout. Some of these items may already be internally associated with prescriptions based on prior consultations, and others may be automatically configured to generate a consultation request to obtain the necessary prescription.

As an example, a consultation may result in a prescription for a face cream with any of three active ingredients, each determined to be adequate alternatives by a healthcare practitioner. The prescription may be unfinished while the patient shops the various available face creams in an online store after the consultation is over. Upon selection of a face cream with one of the three active ingredients by the patient, the unfinished prescription is automatically finished, allowing the patient to purchase the product. The purchase of the product forecloses future purchases of more of the same product or the other products absent an additional prescription and/or consultation.

In various embodiments, the addition of products and/or services can include lab tests, pharmaceutical products, or imaging studies and may result in a request for the necessary prescription or consultation from the appropriate practitioner. The practitioner may have the ability to approve, cancel, or change the order for the patient and send any recommendations to the patient.

Thus, the platform allows for the integration of physician-recommended-only products, lab studies, and pharmaceutical drugs that are offered for “sale” to the patient on the doctor's website and which are then integrated into a mandatory online consultation.

When a provider recommends or approves a request to buy a pharmaceutical drug, imaging study, or lab test, the provider may select the pharmaceutical, lab test, or imaging study and then send a click-to-buy button or link to the patient for purchase.

In various embodiments, vendors can set themselves up on the back end and abstract the AZOVA™ platform from the end users. Vendors can offer direct to consumer sales and direct to provider (wholesale) ordering and/or can offer their products only to affiliated groups. Vendors may select whether they want their products and services on the open network. Vendor products and services may be listed at various pricing and availability depending on affiliation status of patients and/or providers. Vendors might sell directly to patients, healthcare practitioners, healthcare organizations, insurers, and/or other service providers. Products and services may include, but are not limited to: nutritional supplements, personal care, food, office supplies, medical supplies or equipment, maintenance offerings, dental equipment, veterinary supplies or equipment, software, laboratory studies, imaging studies, and the like.

The same or different products may be sold direct to consumers by a vendor. Products and services may be categorized, filterable, and/or searchable. Such offerings may include items in personal care, over-the-counter items, and direct sale products (multi-level-marketing).

The systems and methods herein may be used internationally and by customers of various languages and cultures. In some embodiments, the systems and/or methods described herein may allow for sourcing a consultation request. For example, a consultation sourcing system may receive a request for an appointment from a user. The consultation sourcing system may determine which staff members can assist the user and notify those staff members of the request. The request may then be placed in a queue until some action is taken by a staff member. Thus, the system described herein may facilitate or even establish connections and interactions between healthcare providers and patients, optionally through one or more translators, representatives, caregivers, and/or other intermediaries.

A consultation sourcing system can provide support for customers of a range of businesses. For example, the system can be used for customer support, language interpretation, tutoring, sales presentations and promotions, legal services, banking services, medical services, training, proselyting, etc. The system may be modified to support the various businesses. For example, a tutoring system may allow a user to communicate with video, whereas, a banking system may use secure messaging.

In one embodiment, the consultation sourcing system may be a unique system for each business. For example, a law firm may use a system that is uniquely configured for its clients and staff. This type of consultation sourcing system may be considered a closed system. Such a system may only source requests from the clients of a business to its own staff members. This may be advantageous for containment of sensitive information. And, because all the personnel are provided by the business, this may also help with quality control of staff members.

In another embodiment, the consultation sourcing system may be a common system for several businesses. The businesses may be grouped according to their field, needs, or location. In other embodiments, the businesses may self-organize and request a combined system. The combined systems may have shared consultants trained by the businesses. Alternatively, the consultants may be provided by a third party that is maintaining the system. By combining systems, the business may receive a discounted rate for the system or the staff members.

The staff members may come from a variety of locations. In one embodiment, the staff members may be employees of the business. In another embodiment, the staff members may be employees of a third party maintaining the system. In yet another embodiment, the staff members may be crowd sourced. For example, independent contractors may sign up to be a “staff member.” The contractors may be paid based on the appointments that they have completed. The staff members may also comprise some combination of employees and independent contractors. For instance, the system may prioritize the use of staff members that are employees for appointments. And, if all of the employee staff members are busy, the system may source the appointments to independent contractor staff members.

Staff members may have a consultant profile. The consultant profile may be configured with a set of credentials. In one embodiment, a consultant profile may be completed by an employer. In another embodiment, the consultant profile may be completed by the staff members themselves. For instance, when a staff member joins the system he or she may be prompted to insert a skill set and a schedule. The skill set may include languages spoken, specialties, or background information. Based on the skill set, the system may automatically assign the staff members to one or more general categories (staff types). For example, if the staff member indicates he or she speaks English and Spanish, the staff member may be assigned to a Spanish interpreter staff type. Then if any appointment requires a Spanish translation, this staff member and any other in this staff type would be alerted. In one embodiment, the staff type may also indicate if the staff member is an employee or an independent contractor. In another embodiment, the staff type may also indicate the seniority of the staff member. Further, the consultant profile may also be configured with a schedule. The staff member may indicate the hours that he or she is available for an appointment.

In some embodiments, once the staff member is registered to take appointments, the staff member may be assigned at least one system name. The system name may be a screen name, pseudonym, or unique identifier. For example, the system may assign a name that indicates the staff type of the staff member. In situations where the staff member fits into two different staff types, two different system names are associated with the staff member.

In one embodiment, the users of the system may be screened by a screening module when they sign up. The user screening system may rate the user based on online activity. For example, to sign up the user may provide the system with access to his or her name. This may allow the system to search and find any negative statements that the user has made on social media, rating sites, or other online postings. In one embodiment, the user may provide a social media account to log in. In such an embodiment, the user may agree to allow the system to view any private postings. In another embodiment, the user rating may also be based on the user's credit history. In yet another embodiment, the user rating may be based on the user's legal history.

The user rating may be used to show risk associated with a user. This risk may be related to legal, financial, or publicity problems. To make a user rating, the system may include an algorithm to derive a user score. The algorithm may be based on several variables. Each of the variables may be weighted differently depending on the significance in a specific application. For example, the variables may include how many other businesses in the same field the user has gone to in a time period. For instance, if it appears that a user is doctor shopping it would be reflected in the user score. The variables may also include a user's credit score or other credit-related information, such as bill payment history. Bill payment history may be collected from the user's interactions with the current business (when not using the system), from an affiliate, or from a credit collection agency. Further, the variables may also include the legal history of a client. For instance, if the system is being used to provide medical consultations, any suit that the user has brought against a doctor may be flagged and considered in the user score. Finally, the variables may also reflect how the user has publicly commented on other businesses. For instance, the score may reflect whether the user tends to give negative or positive feedback on online review sites.

Each variables' importance in the user score may be weighted. In one embodiment, the variables' weight is determined in part based on the field of the business. For example, a user's negative online reviews of fast food restaurants will be weighted less than the user's positive reviews of tutors when the business is an educational business. The weighting may also be done based on how recent the user's activity is.

The user score may be used to prevent a user from setting an appointment. The threshold score that determines whether a user is screened or not may be set by the owner of a business or by the individual staff members. This may be useful in fields like insurance where high-risk users are not desirable. In one embodiment, the user score may be reviewed by the business or staff member in detail. In another embodiment, the business or staff member may only be presented with the user score. This may help protect businesses from claims over illegal screening.

In one embodiment, the user score may be continuously updated. To do this, the user's activity may be monitored after signing up with the system. The user score may reflect the activity detected after signing up. The algorithm may then also include variables about how the appointments went, what feedback the user left, and online reviews about the system. These activities may be significantly more weighted in the user score than the pre-sign-up variables. If the user score reaches the threshold score, the user may no longer be able to set an appointment. The system may send an explanation of why the user has been screened and allow a response from the user. The response may also be taken into consideration for the user score.

An appointment may be set by a user by sending a request. The request indicates what services the user is looking for and when the user wants the appointment. In some systems, a user may utilize a graphical user interface (also referred to herein as a “GUI”) of the system to select or be assigned an appropriate staff member. In such an embodiment, the user may have almost instant access to the requested service and therefore does not need to schedule an appointment. In some embodiments, there may not be enough staff members to service the request so the user may request a time for the service.

In some embodiments, the user may pay for an appointment in a variety of manners, payments methods, and time periods, including optionally via insurance or a third-party payor. In some embodiments, the consultation sourcing system can be set to charge a flat fee, by the minute, or a membership fee. In one embodiment where the user is charged by the amount of time, the user may set the amount of time to set a limit. In another embodiment, the user can select with which method he or she would like to pay. For example, the user may be offered a flat fee for an appointment or a certain amount per minute. Based on the user's experience, the user may decide it would be cheaper to pay the flat fee.

In some embodiments, the user may also select how it wants to interact during the appointment. For instance, the interaction may be done via live face-to-face video, telephone consultation, text, or secure messaging. The type of interaction available may be set automatically based on detected equipment. The type of interaction available may also be set based on the industry of the business.

After the system receives an appointment request, the system may place the request in a queue. The system may have several queues based on the services rendered. For example, in a translation service, there may be queues for each language. Each queue may be associated with a staff type. In some embodiments whenever a request is added to a queue, the staff members assigned to the staff type associated with the queue are notified. Any of the staff members may then take the appointment request. When an appointment request has been taken, it is removed from the queue and placed into the staff members' schedule(s). Notifications that a request has been added to a queue may be limited to only those staff members who are qualified and have an available schedule with time equal to the amount of time the customer wants to pay for.

There may be a separate queue for employees and independent contractors. In one embodiment, the queue for employees may be limited to a certain number of users, and excess users will be placed in a queue that is available to either an employee or an independent contractor. This may allow quicker and/or more effective customer service.

In various embodiments, they systems and methods described herein may be configured to additionally or alternatively, provide in-store providing virtual customer support. Such a system may be combined with the translation and other on-demand services, AzovaShop, and other healthcare provider and sales combinations. In various embodiments, a virtual sales support system may interact with a customer to provide pertinent information about a product. A virtual sales support system may include a plurality of sales support devices. Each sales support device may be connected to a customer support network. The network may connect the sales support devices to each other and a plurality of representative devices and/or customer devices.

One reason a product might have limited sales in a retail store (e.g., a pharmacy, drugstore, etc.) is because of a lack of information and visibility. In other embodiments, a product may have limited sales because of lack of information and/or because consumers cannot differentiate between products and/or fully comprehend the advantages, uses, applications, etc. of a specific product. While many of the embodiments, described herein are related to healthcare and health supplies, this specific embodiment is universal and could be equally applied to pharmacies, hospital stores, convenience stores, grocery stores, and especially home improvement stores.

Currently, manufacturers may send human representatives to stores to present products to potential customers. For example, an air conditioner specialist may set up a table at a home improvement store, a food vendor may set up a sample station at a grocery store, or specialists may be sent to educate consumers and/or local representatives regarding specific treatments, medical devices, medications, and applications thereof. A representative may increase the sales of a product because the representative can effectively communicate information through a presentation. However, the increase of sales will be limited to the store that the representative visits, and it is cost prohibitive for the manufacturer to send a representative to every store all the time.

According to various embodiments, the systems and methods described herein further include or as a stand-alone product, provide a virtual sales support system that allows a representative to present a product and/or answer customer questions at multiple stores on demand and in real-time. The representative may be a staff member of the store, or a sales representative from a manufacturer, and/or another employee, contractor, or volunteer person.

A sales support device may comprise one or more display, microphone, speaker, camera, and/or network interface. A representative may communicate with a customer via the sales support device. For example, a remote representative for a cosmetic company may demonstrate makeup products to a customer through the sales support device. The representative may appear on a display and be heard through a speaker. The customer may interact with the display and/or ask questions to the remote representative through one or more microphones. The representative can answer the questions on a remote representative device and the customer may hear the answers through the speaker.

A representative may connect to the sales support devices through a representative device. The representative device may comprise a display, a microphone, a speaker, a camera, and a network interface. The representative device may be located within a store. Alternatively, the representative device may be located remotely. In some embodiments, the representative may use a sales support device as a representative device. For example, if a representative was giving a demonstration on a tool set at a first hardware store, the representative may use a sales support device to record and/or broadcast the demonstration to other sales support devices located within the first hardware store or in a second hardware store.

The representative may be seen on multiple sales support devices at multiple stores presenting a live demonstration. For example, a representative demonstrating a smoker or grill usually can only sell to an audience at one store. With a sales support system, the representative can stream a presentation of a smoker to multiple stores and/or facilitate live questions.

In one embodiment, the sales support devices may present icons of several brands of products located in a store, or more specifically brands of products located proximate a sales support device. The brands may be different on each sales support device. For instance, the brands found on the aisles near the sales support device may be the only ones that the sales support device displays. Alternatively, the sales support device may display the brands in an order based at least partially on the location of products. For example, the sales support device may place the brands at the top that have products near the sales support device. In another embodiment, the manufacturers may pay to have their brand presented more prominently.

A customer may select one of the displayed icons to find out more about a brand and/or product. The sales support device may then send an alert to a representative of that brand. The representative may then use a representative device to connect with the sales support device and interact with the customer.

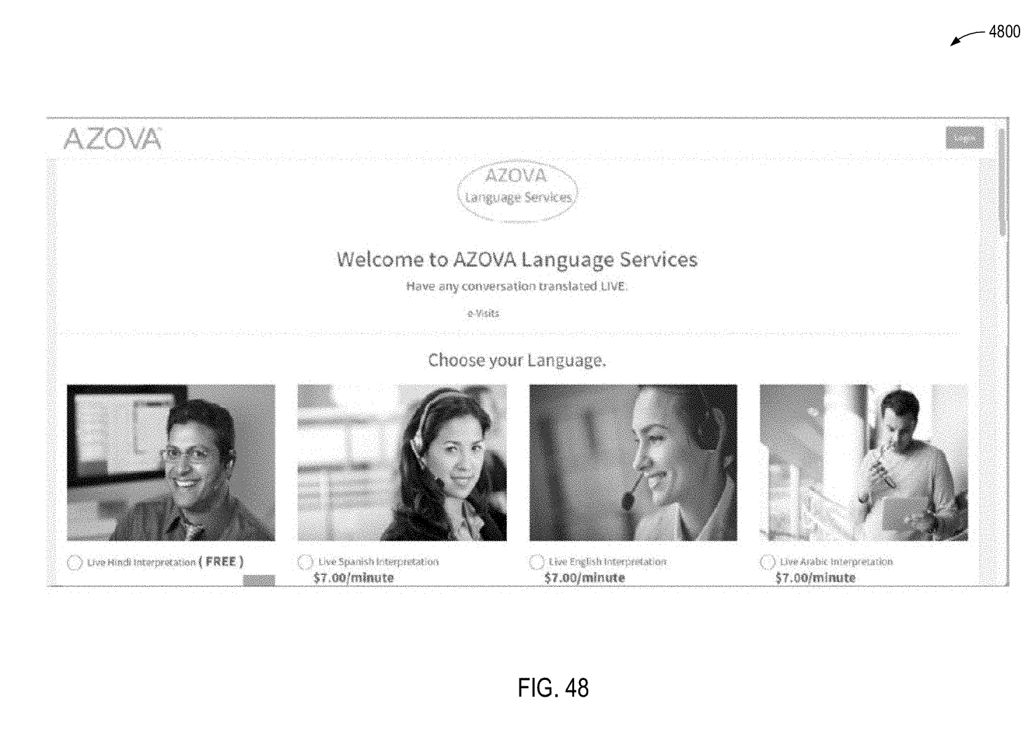

For a customer needing assistance in a foreign language, the sales support device may offer on demand translation to provide multilingual support in real time, as described above and in conjunction with FIGS. 48-75 herein.

The representative may transfer between sales support devices. For example, a sprinkler system representative may answer a customer's question on one sales support device. Then the representative may help the customer pick out a sprinkler part by telling the customer what aisle the part is on and virtually meeting the customer there by transferring to a sales support device near that part (i.e. virtually meeting the customer by moving between displays and associated microphones).

The customer may allow the representative to transfer to the customer's personal device. The customer device may be a portable electronic device such as a cell phone or tablet. The customer may initiate the transfer through a software application downloaded onto the customer device. Alternatively, the customer may interact with the sales support device to indicate a desire to transfer the representative to a customer device. The sales support device may send a link to the customer device. The customer may select the link to initiate the transfer.

The sales support devices may be used to track customer's movements and buying habits. For example, the camera may track what items a customer picks up and what items the customer ultimately buys.

The sales support device may also include a payment module that allows the customer to pay right at the sales support device. Further, the sales support device may also present add-on options to the purchase, such as warranties and installation assistance. If a user selects the installation assistance add-on, the customer's personal device may present an option to initiate an interaction with a representative of that product. For example, a home installation instruction option may appear on a customer device after the selects the installation assistance add-on for a home theater system purchase. When the customer selects the option, a representative may appear on the customer device and provide support and instructions to the customer for the home theater system.

The systems and methods described herein can additionally or alternatively (e.g., as a stand-alone system) provide vaccine management and associated process, methods, and systems. In various embodiments, a patient or prospective patient may schedule online visits, some of which include various vaccine options and visit types.

Thus, a wide variety of healthcare management systems, such as Azova and the like, may include an online vaccination management system (VMS) for scheduling vaccination visits, in-office/pharmacy patient registration for vaccines. It may also provide a price-transparent way of selling vaccines and associated services. The system may include inventory management to manage the stock of vaccines and reorder them as necessary. It may also limit appointment scheduling to include those appointments for which the necessary or recommended vaccines are in stock. The vaccine management system may also allow for improved care coordination among healthcare professionals.

In various embodiments, the VMS may determine an eligibility for vaccines and verify that pre-requisite vaccines and or studies have been administered. Identify of patients may be performed via usernames and other login credentials. In some embodiments, verification of identify may be conducted using credit services, third-party verification, using a sovereign identity (e.g., a blockchain-based identity).

The VMS allows healthcare professionals, pharmacists, health departments, schools and universities to offer online booking for in-office vaccinations of any type. When the patient signs up for a vaccination visit or for any other visit with the healthcare professional, the system automatically prompts the patient to create and then share an online vaccination history.

The patient can build and validate his/her online vaccine record and then share it with his school or university with the click of a button. Healthcare professionals, pharmacists and health departments can manage all of their vaccine patients from one dashboard. The VMS may allow for onsite vaccine and healthcare clinics or event-type scheduling for any number of employer groups or companies. Each company may receive a unique online clinic where employees may schedule their vaccinations or other health screenings/clinics on site without any waiting.

In various embodiments, patients and/or providers can track vaccines, utilizations, supplies, future scheduled visits, demand form prior years, etc. Such data may be useful for scheduling and/or precise inventory management decisions.

Each vaccine type may be tied to a NDC (national drug code), its wholesale and/or retail price, insurance coverage, and/or other information. A patient can choose which vaccines are wanted and the system can add up the cost of each vaccine and/or run eligibility checks to determine if the patient's insurance will cover the vaccine and, if so, how much will be covered. The system, a third-party payor, the healthcare provider, and/or the patient may utilize this information and/or personal preferences to determine which vaccines, orders of vaccines, and even brand of vaccine to receive/provide.

Patients scheduling vaccines via the VMS may upload, share, or otherwise provide access to medical records on a one-time use basis, perpetually, or until such access is revoked. Patients may have options via a VMS interface (e.g., a website or mobile application) to determine which healthcare professional, pharmacist, school or university, laboratory, imaging center, family or friend with whom he/she would like to share his/her medical records.

When the patient selects a healthcare professional and that professional already has an account on AZOVA (or other healthcare management system), electronic medical records and/or the request for a vaccine may be transmitted to that professional's vaccination tab on his/her dashboard. If that professional does not have an account on AZOVA, then the professional may be contacted (e.g., via mail, email, SMS, phone, or the like) with a notification making available the vaccination records from the patient, the scheduling request, and options to subscribe, purchase, or otherwise become a member of the system.

In some embodiments, a professional can validate receipt of vaccines and the patient and/or professional can share the validation with schools, governments, or other entities as approved by local regulations and/or the patient. Once a vaccine is validated, a patient may be prohibited from editing it without losing the validation, but the patient may use the validated vaccine as proof of vaccine reception.

In various embodiments, a VMS system automatically presents all the vaccines that are currently FDA approved for each age. For example, certain vaccines in any one series are only approved to be used for dose four or five, but are not approved for dose 1, 2, or 3. The system may allow the patient or provider to add vaccines that are approved for each particular dose and offers a dynamic recommended age as well as recommended time between vaccinations. These recommendations may be programmed to notify the patient when they are due or overdue for a vaccination and displays to the patient, and, optionally, with one or more providers with whom the patient has opted shared information, that there are vaccines that are due or overdue and/or any vaccines that have been given in the past. This way, the VMS system can help to prevent over and under vaccination.

In various embodiments, a system may aggregate various vaccination information, such as manufacturer, brand name, NDC code, lot number, an identify of an induvial or facility that administered the vaccine, facility name, location of the vaccine, volume of the vaccine, location of injection and whether the vaccine was valid along with comments. As a specific embodiment, a baby may be injected with the MMR vaccine, but the nurse may not have attached the needle to the syringe tightly enough. Accordingly, the vaccine may not have been fully injected and a large portion of it may have squirted all over the child's arm or leg. This vaccine is considered an invalid vaccine and must be recorded as such and must be made up form in the future. A date may be scheduled for the makeup vaccine and the proper entities may be notified to manage payments and discounts for the mistake.

One aspect of the VMS system may be to provide price transparency. Price transparency may allow the consumer to check benefits (e.g., cash discounts or insurance coverage) on the spot and elect to purchase procedures (or not) with confidence in the expected immediate and future costs.

Certain medications (vaccines) have been identified for increased efficacy based upon a person's lab test results. This is generally referred to as “Precision Medicine” and is explained in an article titled “Personalized medicine: new genomics, old lessons” by Kenneth Offit, which is hereby incorporated by reference in its entirety as incorporated in U.S. Provisional Patent Application No. 62/378,590, to which this application claims priority.

Since vaccines are medications, lab test results will be utilized to better select which vaccine are most appropriate for a specific person, based upon their race, ethnicity, and genomic analysis. The Mayo Clinic reported in 2014 that the Rubella vaccine performed better on certain individuals, as described in the appendices of U.S. Provisional Patent Application No. 62/378,590.

The VMS system may utilize lab test results and other data from the EMRs of patients to identify the best doses, potential allergic reactions, recommended boosters, and the like to increased vaccine efficacy and safety. For instance, a gap-in-care analysis may be performed based on the data supplied by the patient, electronic health record data, data from a health information exchange (HIE), bloodwork test results, and/or results from genomics testing.

The VMS system provides a technical solution to a problem originating in the computer implementation of vaccination management. The functionalities of the various modules provide significantly more functionality than the mere computerization of standard vaccination management that is performed manually (e.g., via pen and paper). Moreover, the presently described embodiments to not tie up the automation of vaccination management—rather they provide a unique and specialized vaccination management system that provides a specific solution in specific instances and to specific problems, many of which did not exist prior to the computerization of health records and vaccine management in particular.

Software offerings available may include software (e.g., computer programs or applications for portable electronics) for practitioners, organizations, or individuals (e.g., patients). The described features, operations, or characteristics may be combined in any suitable manner in one or more embodiments. The order of the steps or actions of the methods described in connection with the embodiments disclosed may be varied. Thus, any order in the drawings or Detailed Description is for illustrative purposes only and is not meant to imply a required order.

Embodiments may include various features, which may be embodied in machine-executable instructions executed by a general-purpose or special-purpose computer (or another electronic device). Alternatively, the features may be performed by hardware components that include specific logic for performing the steps or by a combination of hardware, software, and/or firmware. Any of the various embodiments may include various encryption and/or authentication measures to ensure the security and/or authenticity of the data.

Many of the embodiments described herein may be implemented and/or provided in the form of a computer program product, such as a non-transitory machine-readable medium having stored thereon instructions that may be used to program a computer (or other electronic device such as a controller, processor, or microprocessor) to perform processes and operations described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

The various functional components of the described systems and methods may be modeled as a functional block diagram that includes one or more remote terminals, networks, servers, data exchanges, and software/hardware/firmware modules configured to implement the various functions, features, methods, and concepts described herein. In many instances, each application, embodiment, variation, option, service, and/or other component of the systems and methods described herein may be implemented as a module of a larger system. Each module may be implemented as hardware, software, and/or firmware, as would be understood by one of skill in the art for the particular functionality, and may be part of a larger physical system that may include computer-readable instructions, processors, servers, endpoint computers, and/or the like.

Disclosed herein are embodiments of systems, methods, apparatus, circuits, and/or interfaces. As stated above, the embodiments disclosed herein may be embodied as executable instructions stored on a non-transitory machine-readable storage medium. The instructions may comprise computer program code that, when executed and/or interpreted by a computing device, causes the computing device to implement the processing steps and/or operations disclosed herein. The embodiments disclosed herein may be implemented and/or embodied as a driver, a library, an interface, an application programming interface (API), firmware, Field Programmable Gate Array (FPGA) configuration data, and/or the like. Accordingly, portions of the embodiments disclosed herein may be accessed by and/or included within particular modules, processes, and/or services (e.g., incorporated within a kernel layer of an operating system, within application frameworks and/or libraries, within device drivers, in user-space applications and/or libraries, and/or the like). Alternatively, or in addition, the embodiments disclosed herein may be implemented as particular machine components, which may include, but are not limited to: circuits, processing components, special-purpose processors, general-purpose processors, interface components, hardware controller(s), programmable hardware, programmable logic elements, FPGAs, Application Specific Integrated Circuits (ASICs), and/or the like.

The embodiments disclosed herein improve the operation of a computing device by, inter alia, enabling coordination between separate, standalone applications operating on the computing device. The embodiments disclosed herein improve the operation of networked computing devices by, inter alia, enabling coordination between separate, standalone applications operating on disparate computing devices. Accordingly, the embodiments disclosed herein may provide additional functionality that does not exist in a general-purpose computing device and/or may improve the operation of the computing device by coordinating operation of general-purpose applications that do not include coordination-specific functionality. Accordingly, the embodiments disclosed herein may improve the operation of the particular applications operating on the computing device and/or improve the operation of particular applications normally operated on disparate and distinct computing devices.

Additional understanding of the embodiments of this disclosure may be gained by reference to the drawings. Numerous specific details are provided for a thorough understanding of the embodiments described herein. However, those of skill in the art will recognize that one or more of the specific details may be omitted, or other methods, components, or materials may be used. In some cases, operations are not shown or described in detail. For example, well-known features and functions normally employed in other fields of use that are incorporated in the presently described embodiments in new ways are only described to the extent necessary to understand the integration of the features and functions in the respective embodiments of this disclosure.

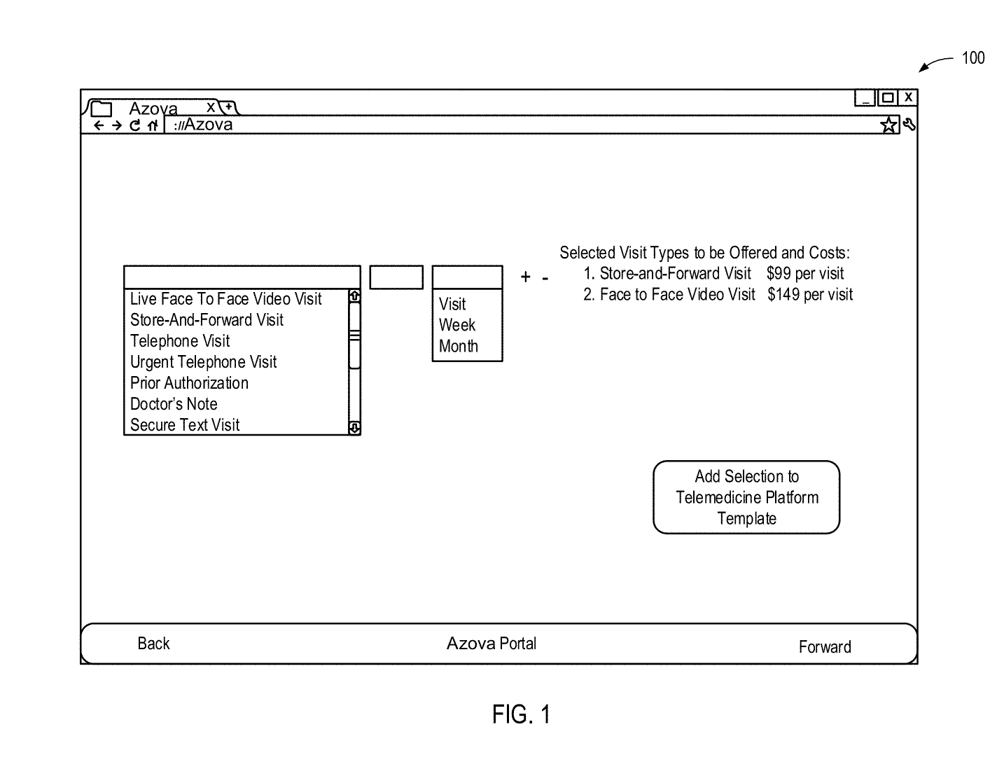

FIG. 1 illustrates a specific example of a simplified user interface (UI), such as a GUI that is configured to allow a healthcare practitioner to select content items from a drop-down menu of a content library of available services. As illustrated, the drop-down menu includes: live face-to-face video visits, store-and-forward visits, telephone visits, urgent telephone visits, prior authorization services, prescription drug price comparisons, medical procedure and office visit price comparisons, doctor's note services, and secure text visits. As indicated to the right of the drop-down menu, cost and/or unit pricing options may be selected.

In some embodiments, a healthcare practitioner may elect to include a content item that allows cosmeceutical visits. In such an embodiment, a practitioner-specific telemedicine platform may allow a patient to conduct a virtual office visit (real-time, store-and-forward, and via telephone, secure messaging, or other methods for communication) for the primary or sole purpose of obtaining a prescription, such as a prescription-strength cosmeceutical product. The system may allow the healthcare practitioner to issue the prescription and, in some embodiments, initiate delivery of the prescription through the system, the healthcare practitioner's mini-store discussed below, and/or a third-party prescription vendor.

In the illustrated example provided in FIG. 1, a healthcare practitioner has elected to include “store-and-forward visits” and “face-to-face video visits” within their customized or individual practitioner-specific telemedicine platform. In the illustrated embodiment, the healthcare practitioner has elected to charge $99 per store-and-forward visit and $149 per face-to-face visit. In some embodiments, additional customization of the pricing models may be available. In some embodiments, integration with insurance companies for medical billing may be available.

Once the healthcare practitioner has used the illustrated UI to select the desired content items from the drop-down menu representative of the content library, the selected content items may be added to the telemedicine platform template (e.g., they may be added as selectable icons to a practitioner-specific portal or webpage).

In various embodiments, the library of content items may include various content items that provide for and/or relate to patient medical records. In some embodiments, a healthcare practitioner may elect to include integration features in their practitioner-specific telemedicine platform that are configured to facilitate electronic medical record (EMR) integration within one or more existing EMR systems.

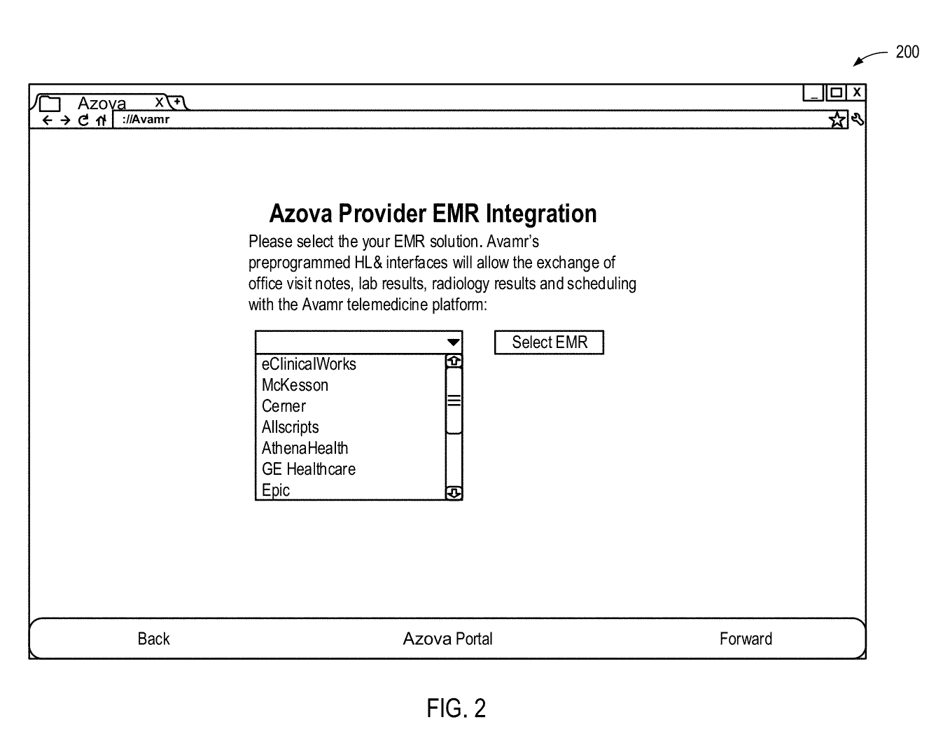

As illustrated in FIG. 2, a healthcare practitioner may elect to integrate their practitioner-specific telemedicine platform with any number of custom, standardized, and/or commercially available EMR solutions. In the illustrated embodiment, the service provider AZOVA™ provides EMR integration with a wide variety of commercial EMR systems. Such integration may be executed in part using preprogrammed HL7 interfaces or other necessary modes of integration. Integration with alternative standards, such as openEHR and other health record standards, may also be supported. As used throughout, EMR data or an EMR includes or may be substituted by any form of medical, health, personal, financial, or other patient information that pertains to treatments, healthcare, medications, consultations, diagnostics, and the like.

In various embodiments, the AZOVA™ system (i.e., the service provider's system) may allow existing EMR integration by uploading the EMRs from an existing EMR database to a patient-controlled or physician-controlled account.

Thus, in some embodiments, a healthcare practitioner may use the AZOVA™ system to create a practitioner-specific telemedicine platform and may elect to include EMR integration with their existing or former EMR system. In such an embodiment, the EMRs from the existing or former EMR system may be accessible and/or imported into the AZOVA™ system and/or made available within the practitioner-specific telemedicine platform to the healthcare practitioner and/or their patients.

In other embodiments, unrelated to the practitioner-specific telemedicine platforms, a patient may create a patient account on the system (e.g., the AZOVA™ system). The patient may then use the system to upload EMRs and/or request EMRs from healthcare practitioners and facilities. In some embodiments, the patient may select an existing EMR system of a healthcare facility (as illustrated in FIG. 2) and request that the patient's EMR data be imported into their personal account. In some embodiments, the patient may use the system to request EMR data from a healthcare facility and the system will contact the healthcare facility electronically or manually to request and ultimately upload the EMR data of the requesting patient into the patient's account. The patient and/or healthcare facility may pay for the patient's account and storage of EMR data.

Thus, a patient may have independent access to their EMRs through their own personal account. Alternatively or additionally, the patient may have access to their EMRs through the telemedicine platform of their healthcare provider. In either case, a patient may utilize the AZOVA™ system to access all or portions of their medical records, including but not limited to in-person office visit notes, laboratory results, radiological or other study results, medications prescribed, consultation notes, historical data, diagnoses, and/or other EMR data.

In various embodiments, the system may allow patients and/or healthcare practitioners to export EMR data for one or more patients to other EMR systems. Thus, notes, messages, pictures, or the like generated by or within the AZOVA™ system may be exported or shared with other EMR systems that the healthcare facility and/or patient may utilize.

Again, patients may have access to their EMR data through a personal account that is provided free (or by subscription, per use basis, etc.) by the AZOVA™ system and/or through one or more of their healthcare provider's practitioner-specific portals or telemedicine platforms. In either case, a patient may have access to a “controlled medical record share feature.” The controlled medical record share feature may allow patients to control access to their medical record. All or part of the EMR data may be accessible to the patient and a subset of that data (or all of it) may be shareable by the patient with other healthcare practitioners, insurers, and/or other third parties. For example, a patient may be able to control the access privileges of visit notes, lab results, radiology studies, etc. In various embodiments, the entire record can be shared or selective parts of the EMR may be shared. A patient may also rescind access to those parts of the medical record at any time. Thus, the proposed systems and methods give patients unprecedented control over their personal EMR data to share and rescind access to any third party.

In some embodiments, if a patient elects to share EMR data via the system with a healthcare practitioner that is not a system member (e.g., not an AZOVA™ member), the system may contact the healthcare practitioner out of the system (e.g., via email, phone, text, letter mail, etc.) and provide an option for one-time secure viewing of the EMR and/or invite the healthcare practitioner to create an account for one-time or continuous access to the shared EMR. As previously described, fees may be charged to any of the parties involved for uploading, viewing, sharing, access, and/or the other features and services provided by the system.

The AZOVA™ (or other service provider) system may actually store the EMR data or may act as a portal to access EMR data stored in other EMR systems managed by individual healthcare providers or third parties. Thus, a first doctor may use the AZOVA™ system to access EMR data of a patient where the EMR data is stored on the AZOVA™ system, where the EMR data stored in a database managed by the first doctor, where the EMR data is stored in a database associated with another EMR system, where the EMR data is stored in a database managed or associated with a second doctor, and/or where the EMR data is stored in a database managed by the service provider (e.g., in a situation in which a patient uploaded medical documents/files to the system).

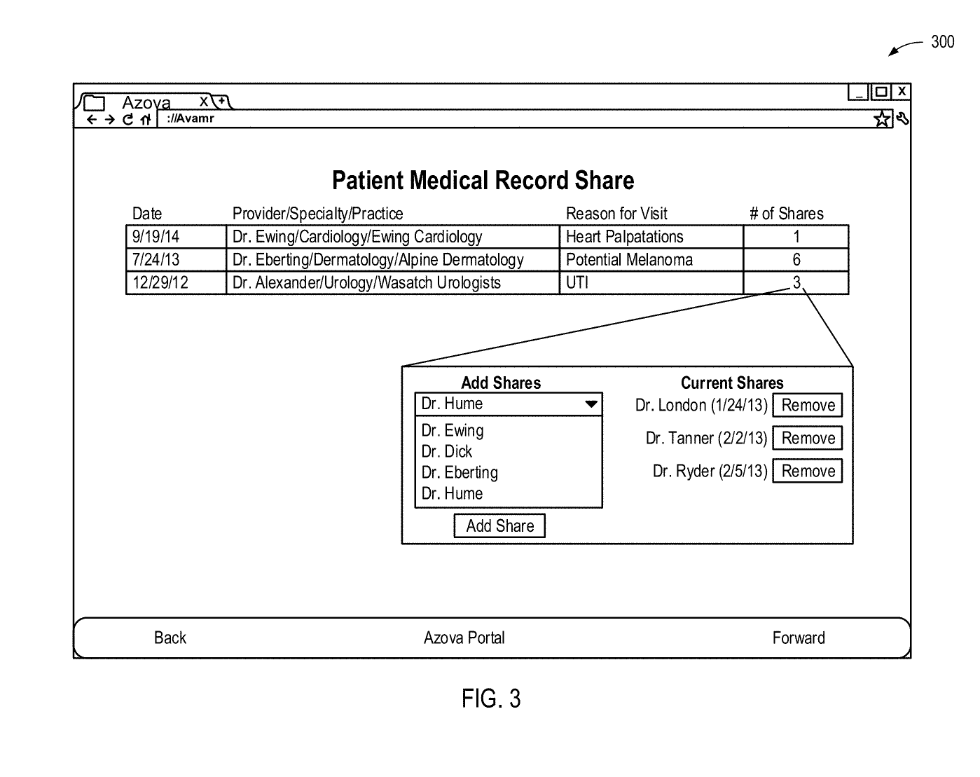

FIG. 3 illustrates a patient medical record share portal that shows three medical records of the patient with dates, provider, specialties, practices, reasons for visits, and the current number of times or people with whom the medical record has been shared. Selecting the share count may allow the patient to manage the sharing privileges relating to that particular medical record.

In various embodiments, a patient may share EMR data with healthcare practitioners who are subscribers or members of the AZOVA™ system (or other service provider) and/or with healthcare practitioners who are not members or subscribers. For example, in one embodiment, a patient may enter an email or telephone number of physician who is not a subscriber to the system. The system may then contact the physician using the telephone number and make them aware that EMR data has been shared. The physician my download or otherwise be provided with access to the EMR data and/or may be invited to become a permanent or temporary subscriber.

In various embodiments, patients or other users of the system may be able to securely share EMR data with any other person (not just healthcare practitioners) by entering contact information that the system will use to contact the intended recipient. As specific example, if a patient recently received an ultrasound of a baby, that ultrasound may be part of an EMR and accessible by the patient within the AZOVA™ system. The patient can choose to share the ultrasound with any number of people by simply entering the contact information of the intended recipients. In various embodiments, the patient may elect to share the ultrasound in a secure environment (e.g., within a communication platform or other portal associated with the AZOVA™ system) or outside of a secure environment (e.g., via an unsecure email or MMS message).

As illustrated, the system may provide a list of practitioners within a network, known to the patient, entered in the system, and associated with a particular healthcare facility; a list of current subscribers to the AZOVA™ system; and/or other list of healthcare practitioners. The system may also provide a list of “current shares” and allow the patient to rescind the sharing of the particular medical record with respect to one or more of the “current shares.”

Whether through an independent personal account or through one or more of their healthcare provider's practitioner-specific portals or telemedicine platforms, patients may have access to and control of their radiology study and associated medical records via a personal radiology study and medical record storage suite. In some embodiments, patients and/or healthcare practitioners may be charged for maintaining a database of medical records and/or radiology images/studies.

The personal radiology study and medical record storage suite may allow a patient to control access to their radiology studies and associated records. In one embodiment, patients may have the ability to request their radiology or other studies (ultrasound, echocardiograms, etc.) and have them uploaded to the system or to have them made available via a short-term or long-term portal.

There may be a one-time or subscription-based fee charged to the patient and/or medical practitioner. Any of a wide variety of financial models might grant access to the study for an unlimited (or limited) amount of time. All or part of the studies and associated images, graphs, measurements, or the like may be accessible to the patient, and a subset of that data (or all of it) may be shareable by the patient with other healthcare practitioners, insurers, and/or other third parties.

In some embodiments, if a patient elects to share the data with a member healthcare practitioner, the member healthcare practitioner may receive a notice that the data has been made available and access it via a corresponding portal. If the healthcare practitioner with whom the data has been shared is not a member, the system may contact the healthcare practitioner (e.g., via email, phone, text, letter mail, etc.) and provide an option for one-time secure viewing of the EMR and/or invite the healthcare practitioner to become a member for continuous access to the shared EMR. As previously described, fees may be charged to any of the parties involved for uploading, viewing, sharing, access, and/or the other features and services provided by the system.

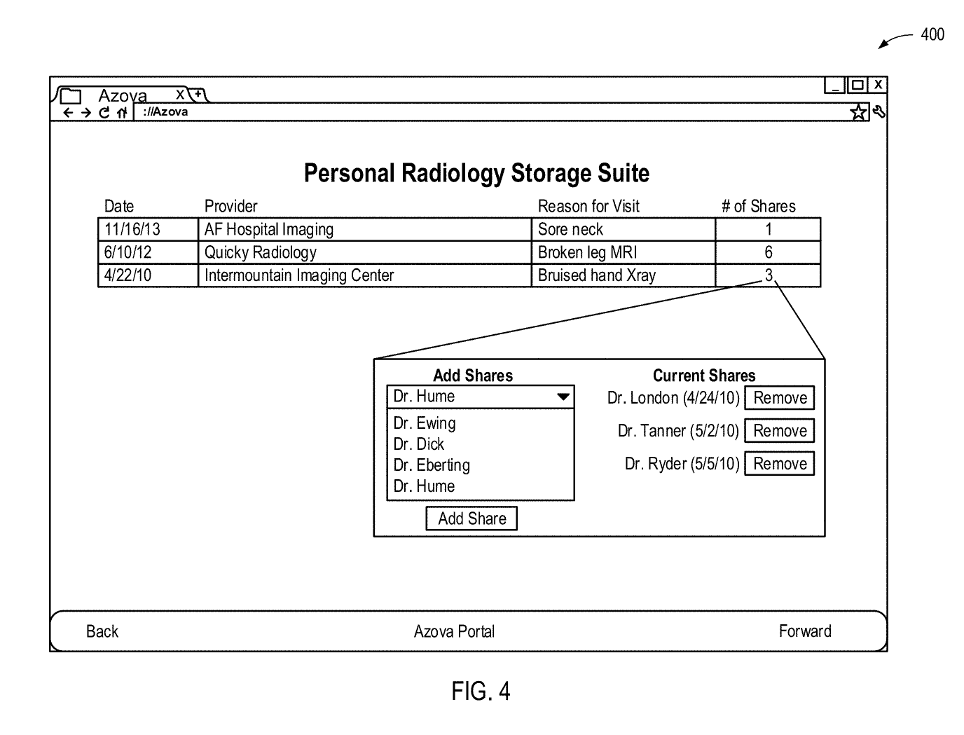

FIG. 4 illustrates a patient medical record share portal that shows three image records with dates, provider names, reasons for the visits, and the current number of times or people with whom the image record has been shared. Selecting the share count may allow the patient to manage the sharing privileges relating to that particular image record. Again, patients may manage sharing between healthcare practitioners and non-healthcare practitioners alike.

As illustrated, the system may provide a list of practitioners within a network, known to the patient, entered into the system by the patient, and associated with a particular healthcare facility; a list of current subscribers to the AZOVA™ system; and/or other list of healthcare practitioners. The system may also provide a list of “current shares” and allow the patient to rescind the sharing of the particular image record with respect to one or more of the “current shares.”

In various embodiments, the AZOVA™ system (or alternatively named system providing one or more of the functions described herein) may include a messaging platform. Whether through the practitioner-specific telemedicine platforms and portals described herein, through a related or auxiliary application, and/or through an independent application, the system may allow for secure messaging between practitioners, between patients and practitioners, between patients, and/or between practitioners and patients. A free, pay-per-use, or subscription model may be used to charge for the secure messaging application. Any or all parties involved and/or third parties (e.g., an insurance company) may pay for usage of the secure messaging features. The sharing management features may be limited to sharing between patients and healthcare practitioners. Alternatively, patients may be able to share, securely or otherwise, EMR data with any person using the contact information of the intended recipients.

The secure messaging features may utilize personal information to create an account for each individual or entity (e.g., patient, healthcare facility, healthcare practitioner), such as an email address, cellphone number, or other identification. A phone application or application on a desktop, laptop, tablet device, watch, and/or other personal electronic device may allow for secure communication that is compliant with the Health Insurance Portability and Accountability Act (HIPAA), aspects of which are sometimes referred to as the Health Information Patient Privacy Act (HIPPA) (hereafter “HIPPA” is used interchangeably with HIPAA). Additionally, as used herein, anything described as complying with or associated with HIPAA or HIPPA also includes compliance and conformity to the requirements of the Health Information Technology for Economic and Clinical Health (HITECH) Act as well.

In one embodiment, a doctor may receive a certain data amount (e.g., 1 Gb) from patients before their patients are billed. In other embodiments, patients are billed each time they upload an image or other media content. In some embodiments, the messaging is free to patients communicating with member-practitioners, but billed at a pay-per-use rate for communications with non-subscriber-practitioners.

In some embodiments, a “PhotoSafe” storage feature may be coupled with the messaging features that allows for photos, videos, audio recordings, images, charts, measurements, etc. to be stored in a HIPPA-compliant manner within an application on a desktop, laptop, tablet, mobile phone, or another personal electronic device. The PhotoSafe application may include a camera icon within the application that launches the device's camera and allows for the patient and/or healthcare practitioner to instantly upload a photo to the patient's EMR.

In various embodiments, the PhotoSafe application may help reduce the liability associated with photos and other protected information being lost or stolen from cell phones, unsecure messaging systems, personal or otherwise unsecure email accounts, and the like. PhotoSafe may provide for various encryption and data authenticity verification safeguards.

In various embodiments, a healthcare practitioner or other approved entity may be able to utilize and/or manipulate photos (and/or other multimedia) during live video consultations with patients. For example, a healthcare practitioner may conduct a live videoconference and bring up a photo (or other multimedia type) and show it or portions of it to the patient. The healthcare practitioner may have various tools for manipulating, annotating, redacting, editing, cropping, enhancing, and/or otherwise manipulating the photo (or other multimedia type) in real-time during the consultation. The application may allow the edited/manipulated photo to be saved for subsequent recall. In some embodiments, edits may be destructive and in others they may be made as non-destructive annotations to the original file. Various versions may be saved of each manipulated file as well.

As an example, a plastic surgeon or other surgeon may be able to show real-time variations to a photo or video of a patient to illustrate one or more potential surgical outcomes. The surgeon may be able to show estimates and manipulate an image as the surgeon explains a procedure or possible outcomes of a procedure.

In some embodiments, the system may include an eConsent portal. This may be provided as part of a patient account and/or may be a content item selected for inclusion in a healthcare practitioner's practitioner-specific telemedicine platform. The eConsent portal may allow a patient to securely eSign all of their eConsents and provide audit trails showing how and when documents were eSigned. This may be implemented as a stand-alone feature and/or may comprise an integration portal with a third-party e-signing company.

In some embodiments, patients and/or healthcare practitioners may have access through the eConsent portal to numerous (potentially more than 17,000) unique HIPPA-compliant forms. These forms may be accessible and used to import, export, request, share, make public, or otherwise control access to EMRs. In various embodiments, the healthcare provider can upload and deploy unique HIPPA consent forms, office policies forms, or other forms to their patients prior to a telemedicine visit.

In various embodiments, a healthcare practitioner and/or healthcare facility may incorporate an online store into their practitioner-specific telemedicine platform and/or into their existing webpage or webportal. The online store may, in some embodiments, be a “content item” as described above that is selectable from the library of content items when a healthcare practitioner is creating a practitioner-specific telemedicine platform.

The online store itself (e.g., AZOVAshop™) may be customizable and allow each healthcare practitioner to create their own mini-store of a subset of items selectable from a master list of items. The mini-store may be accessible to patients of the healthcare practitioner to browse and shop. Alternatively, the mini-store may or may not be browse-able by patients. The healthcare practitioner may make treatment recommendations to a patient that includes a list of treatment items that must be purchased.

The online store (e.g., AZOVAshop™) may also include a wholesale account link that allows healthcare practitioners, suppliers, patients, administrators, and/or other entities to create wholesale accounts with any distributor company that sells products through the general online store (e.g., AZOVAshop™). Such embodiments may allow companies to set up wholesale accounts quickly and seamlessly, potentially without the involvement of sales representatives. A vendor may create an interface for a wholesale account to set up a process or product and then market their products and services to any physician, including those who have previously selected to sell that vendor's specific products in their store. The vendor may “push” new products directly to a physician's store based on a pre-arranged agreement. The AZOVAshop™ can also be used as a marketing portal to end purchasers and providers.

An administrator of the online store, such as a healthcare provider or other manager of the online store, may be able to monitor the online store and manage, approve, review, characterize, restrict access to, and/or otherwise manage the products that are uploaded. In some embodiments, a vendor may upload products to the online store based on prior approval and/or for subsequent approval. The vendor may indicate whether a product or set of products should be made available by prescription only or by physician or healthcare professional recommendation only.

If an item is marked as “by physician/practitioner recommendation only” or “by prescription only,” a patient may be able to select the item for purchase from the online store, but it may not be shipped or delivered until approved by the healthcare practitioner and/or a prescription is confirmed.

In some embodiments, the selection of such an item by a patient or prospective patient may result in a pop-up warning or window making it clear that the item cannot be shipped until approval is confirmed. In some embodiments, a patient may be presented with an opportunity to obtain a prescription or other practitioner approval. For instance, a pop-up window or webpage may be presented to the patient offering an in-person, remote, videoconference, or other consultation for the patient to potentially obtain the necessary recommendation and/or prescription.

As a specific example, a pop-up window may state that “The following item(s) cannon be shipped to you without a prescription or health professional recommendation. Please click here to get one.” The patient may then be routed to a Prescription or Product Request page where a message is generated for a relevant or appropriate healthcare practitioner that identifies the items that the patient has purchased and potentially other relevant patient information. In some embodiments, the patient may automatically be requested to provide health-related information that is pertinent to the requested products.

As a specific example, the healthcare practitioner may be presented with a message that says “Your patient (or potential patient), NAME, has ordered the following items. Will you issue a recommendation (or prescription) for these products?” If the practitioner or provider responds in the affirmative, then the order may immediately be send to the vendors. Alternatively, the practitioner may respond in the negative and the patient may be refunded and the products will not be shipped to the patient. In some embodiments, the practitioner may recommend related or alternative products. For example, the practitioner may approve some of the products and not others.

The healthcare provider may provide a URL, electronic hyperlink, QR code, or other pointer that allows the patient to quickly purchase the recommended treatment items from the healthcare practitioner's mini-store. The healthcare practitioner and/or associated facility may receive a portion of the profits on the sale and/or discounts applied to other aspects of the practitioner-specific telemedicine platform.

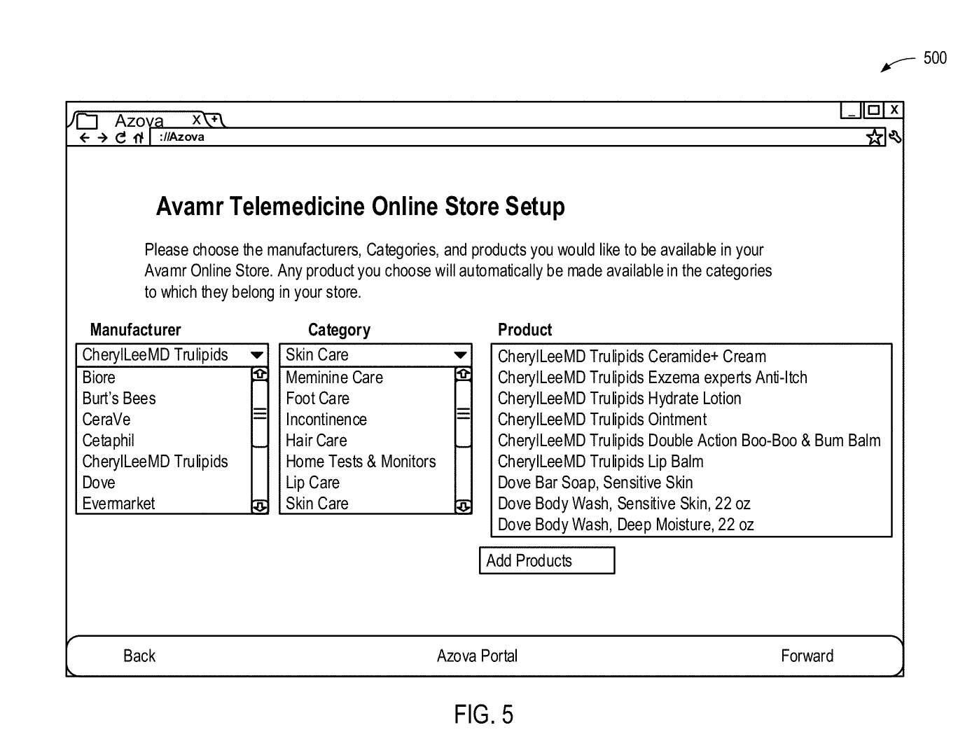

As illustrated in FIG. 5, the healthcare practitioner may customize the mini-store by selecting categories of products, manufacturers of products, and/or individual products that they would like to add to their mini-store. In some embodiments, the inclusion of a brand-name product in the mini-store may automatically result in the inclusion of a generic version of the same product.

In some embodiments, products may be selected by narrowing down the category and/or manufacturer first. In some embodiments, the manufacturer and/or category classifications may be carried through into the practitioner's mini-store. Alternatively, the classifications may be removed or customized by the healthcare practitioner.

The mini-store presented on the healthcare practitioner's practitioner-specific telemedicine platform may look like it is managed and run by the healthcare practitioner, when, in reality, the products may be managed and shipped by the service provider (e.g., AZOVA™). Profits may be shared according to any of a wide variety of profit sharing sales approaches commonly used in the industry.

As a specific example, a physician may meet with a patient and recommend that the patient use a particular soap and lotion combination as a skin treatment for a certain time period. The physician may conduct the visit via a teleconference visit through the physician's telemedicine platform and then provide a treatment summary via a secure messaging application. The treatment summary may have a link that allows the patient to purchase the recommended skin treatment products from the physician's mini-store. The link may utilize previously stored financial and/or shipping information, such that a single click (e.g., one click) may be all that is required to complete the order of the skin or other healthcare treatment products.

The master list of items that can be included by selection in the practitioner's mini-store may include any of a wide variety of healthcare or other items, such as, but not limited to: bandages, medical supplies, medical equipment, skin care, personal care, supplements, medications, treatment plans, educational material, books, soaps, lotions, personal hygiene items, foot care items, incontinence items, hair care, tests, monitoring equipment, lip care, feminine care, therapeutic devices, hot pads, ice packs, etc.

In some embodiments, a healthcare facility may include a mini-store of items that are accessible to healthcare practitioners associated with the healthcare facility. Such a mini-store may include supplies, clothing, medical devices, and/or other equipment commonly used by healthcare practitioners.

In such an embodiment, the healthcare facility may utilize the system (e.g., the AZOVA™ system) to track inventory and usage of supplies and equipment by internal healthcare practitioners. Such a system may allow the healthcare practitioners to “pay” for items on an account basis that simply provides for internal monitoring. Purchases made under such a system may be shipped by the AZOVA™ system or simply routed for internal shipping to a supply manager of the healthcare facility.

The AZOVA™ system may allow for the integration of a telemedicine visit into the product description page of any product or service. For example, the AZOVAshop.com marketplace described herein may include products that are physician-dispensed only products. These products may require a physician recommendation, code, or prescription. A link to a providers' telemedicine clinic may be displayed on the product page so that patients/shoppers can select it and get the appropriate recommendation for the product (potentially via a telemedicine visit with a physician or pharmacist). The product “buy buttons” may trigger a pop-up that indicates that the product requires a physician (or other provider) code, recommendation or prescription and/or initiates the proper telemedicine visit.

Such links and notices may be provided anywhere within the marketplace to prompt a perusing customer to get a consultation to determine if a particular product or service is right for them and/or to give the provider the opportunity to close the sale and/or to upsell.

In various embodiments and/or in combination with any of the other embodiments described herein, the service provider (e.g., AZOVA™) may allow corporations, employers, insurance companies, and/or other groups to form wellness communities. These communities can utilize healthcare providers who are contracted with and/or employed by the service provider. Alternatively, the wellness communities can utilize their own doctors or other independent doctors. Any or all parties involved may utilize any or all of the software solutions described herein.

In one embodiment, patients may be identified with specific treatments or illnesses and invited to join groups, forums, chat rooms, and/or otherwise collaborate in a secure environment with people who can relate to their current situation. Patients may be grouped based on a common illness or a common treatment plan. The data exchanged freely between these patients may be analyzed and/or otherwise data-mined for important information regarding the patients, the treatments, and/or the illnesses. The mined data may be sold to interested parties.

In various embodiments, patients may be asked to consent to receive offers associated with their medical conditions or to participate in data-gathering forums that are meant to aggregate data based upon particular diagnoses and particular treatment regimens for particular diagnoses.

The AZOVA™ system may also provide various services and/or functions for pharmacies, pharmacists, and/or other entities associated with medication therapy management (MTM). For example, a pharmacist may customize a telemedicine platform using the AZOVA™ system that allows them to conduct MTM visits with patients remotely.

The AZOVA™ system may allow the pharmacist to configure a dashboard to allow for MTM visits and to facilitate telemedicine visits with other associated healthcare providers. This facilitation “visit” type allows the pharmacist to charge in exchange for taking the time to help a patient to get care with distant or remote healthcare providers.

In such an embodiment, a pharmacist's “Online Clinic” may include an “MTM visit,” for which the pharmacist may bill the patient's insurance, the patient, and/or an associated healthcare provider.

The pharmacist's online clinic may also include a “Help with an Online Visit” that directs the patient to a page that explains that the pharmacist can help them to use technology to see any healthcare provider in their state who subscribes to the AZOVA™ system. The pharmacist may set a fee for this type of help/visit/facilitation. Once the patient has paid for this visit (automatic billing may bill the patient later), the patient may then select a provider available via the AZOVA™ system by entering the AZOVA handle of the provider.

Once redirected to the provider's telemedicine platform interface, the patient may pay for (or not, depending on the patient's benefits etc.) the visit and proceed to obtain a telemedicine consultation with the healthcare provider (e.g., a physician) in conjunction with the assistance of the pharmacist or their staff member.

In various embodiments, when a patient selects “MTM visit” a form may be presented to capture requisite or useful data for the pharmacist to conduct the MTM visit. The platform can be integrated with drug, food and/or vitamin/supplement interaction monitoring software such as that offered by Surveyor Health™ or other similar company. The interface may help the pharmacist conduct an efficient and thorough MTM visit.

The AZOVA™ system may also provide an interface with medical supply companies, such as durable medical supply (DME) companies, diabetic supply companies, continuous positive airway pressure (CPAP) supply companies, Orthopedic supply companies, and/or other medical supply companies.

The AZOVA™ system may provide discounts on diabetes supplies, CPAP supplies, DME and orthopedic supplies. Similarly, the AZOVA™ system may provide discounts on prescriptions drugs. In some embodiments, a telemedicine visit may be preceded by a direct recommendation for services or products on one dashboard and/or as the direct result of a telemedicine consultation. Thus, the AZOVA™ system may drive demand and/or increase awareness of patients for particular products or services.

In some embodiments, the AZOVA™ system may implement a bidding process to the DME or other supply companies to be presented to a provider that selects one of the buttons for the diabetes supplies, CPAP supplies, DME and orthopedic supplies. The bidding process may be used to provide the best price to the purchasing provider and/or to maximize the percentage collected by the AZOVA™ system.

Customization of the AZOVA™ system may be used by any of a wide variety of businesses to conduct instant live, face-to-face video or store and forward “consultations” for prospective and established clients. Industries for which the AZOVA™ system can be adapted include, but are not limited to, law, sales, insurance sales and brokerage, architectural consultation, education, retail stores, consumer products and more.

The AZOVA™ system can be adapted for any of these industries to do “Online Specials” in conjunction with an in-person face-to-face video consultation or a store and forward or other on-line or digital consultation type (including telephone). The On-Call Button can also serve as an answering service for these businesses. The use of the AZOVAshop.com model can also be adapted for one or more of these industries. All the features of the AZOVA™ system can be configured specifically for each industry.

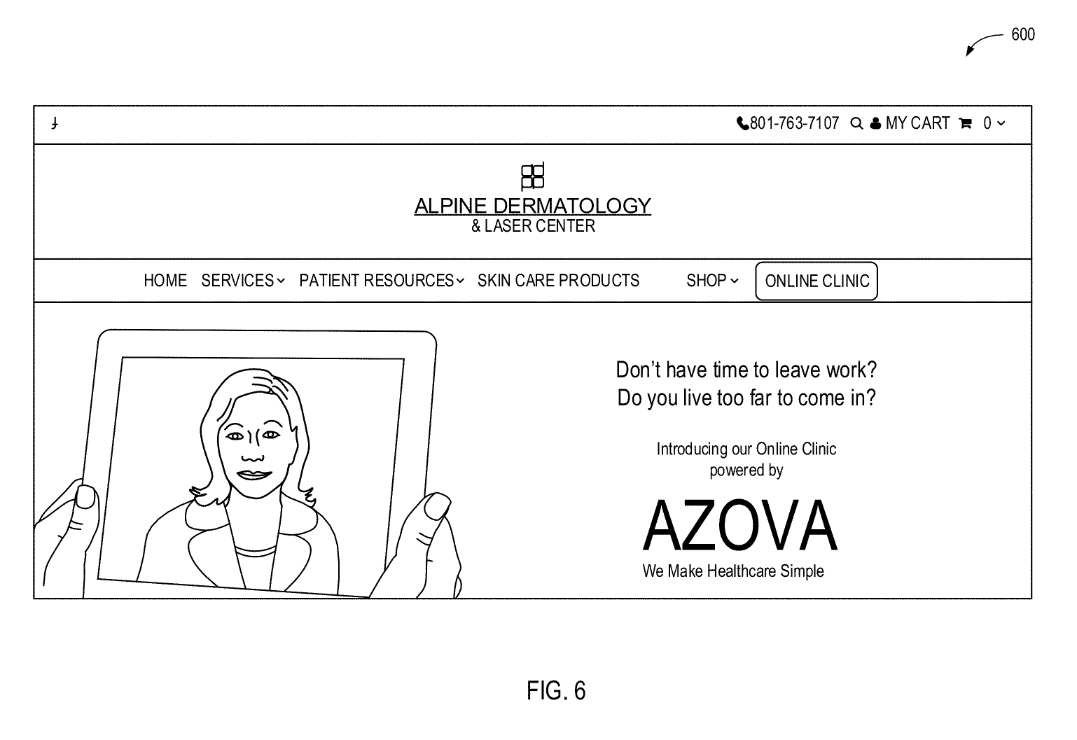

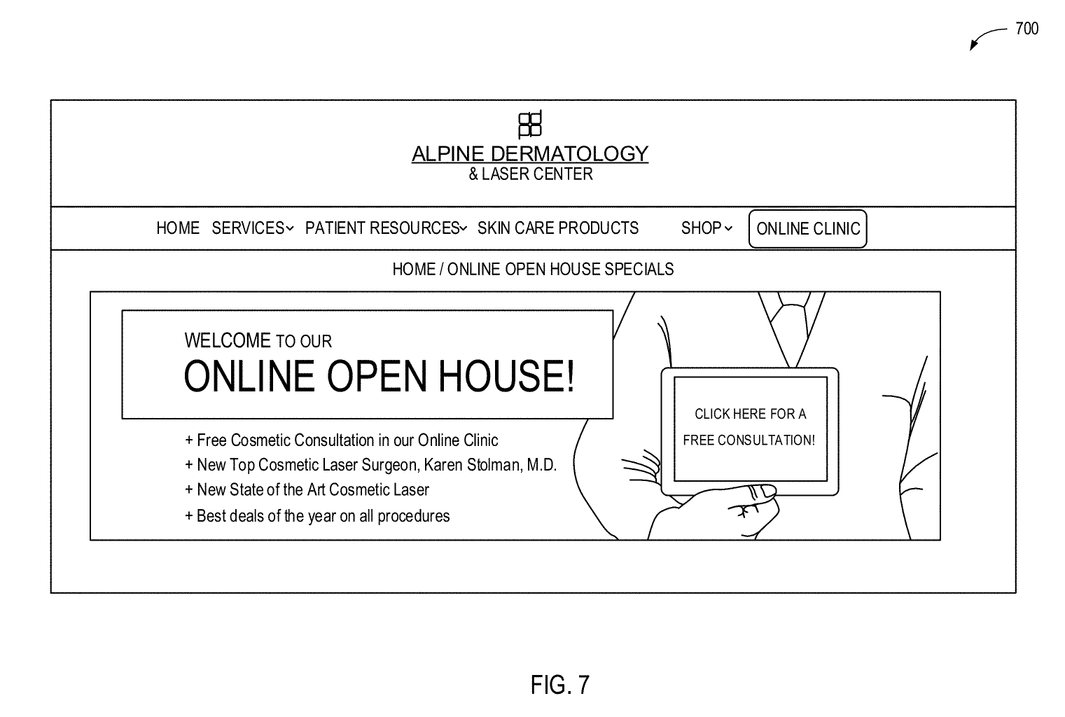

FIG. 6 illustrates a screen shot 600 of a UI of an existing website of a healthcare organization incorporating an “online clinic” link that provides access to the features and services provided by a backend AZOVA™ platform. FIG. 7 illustrates another screen shot 700 of a UI of a healthcare organization advertising an online open house that incorporates any of the various features and functions described herein as part of an embodiment of the AZOVA™ platform.

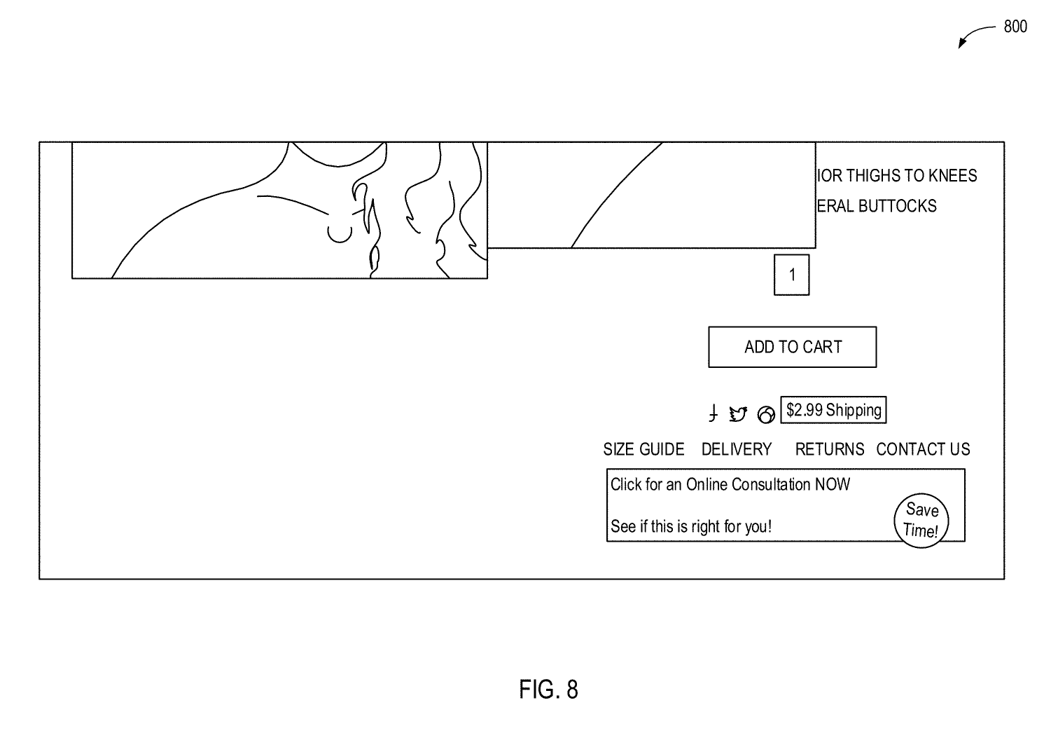

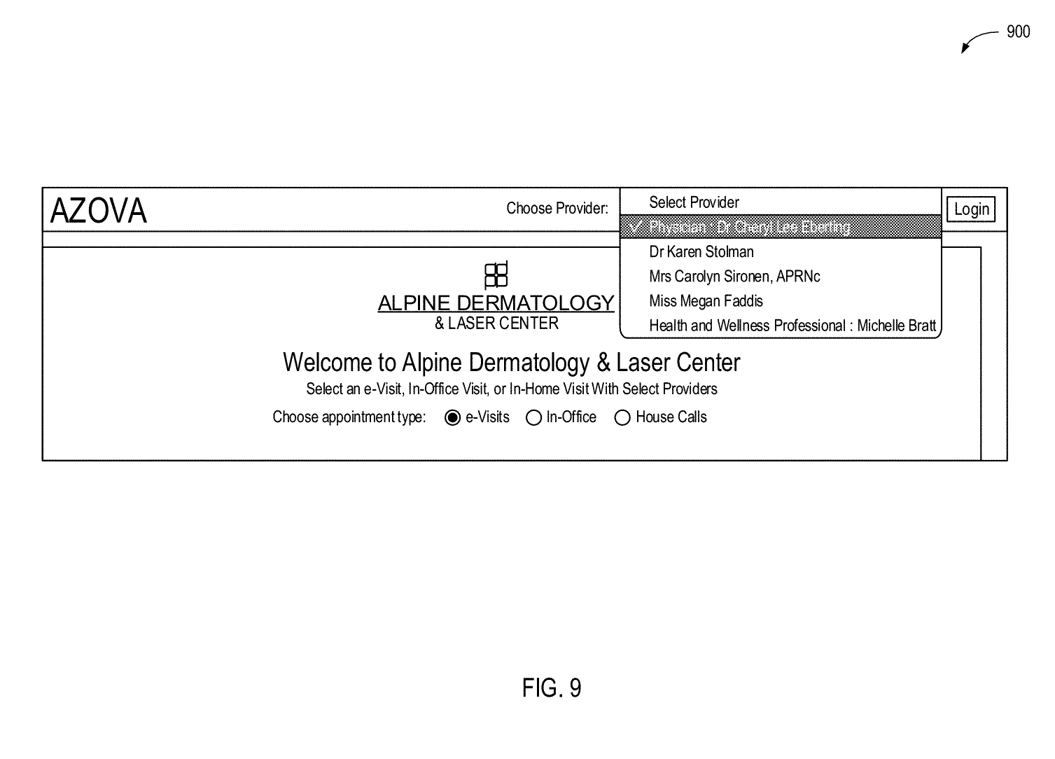

FIG. 8 illustrates an example UI 800 of a product available via a combination or integrated e-commerce and telemedicine platform, such as the AZOVA™ platform. In various embodiments, the selection of a particular product may result in an automatic or offered consultation that is optional or mandatory for the selected product. FIG. 9 illustrates an online clinic supported by the AZOVA™ platform integrated into a healthcare organization's website 900. The website 900 may allow for the selection of a healthcare provider via a drop-down menu.

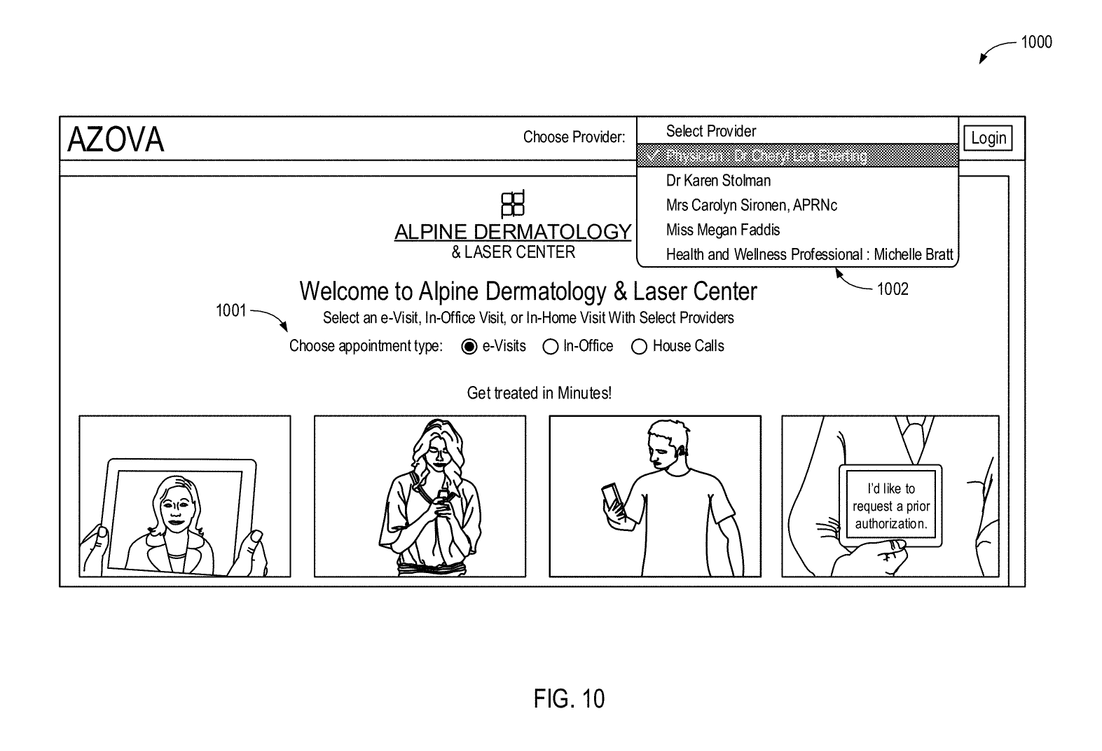

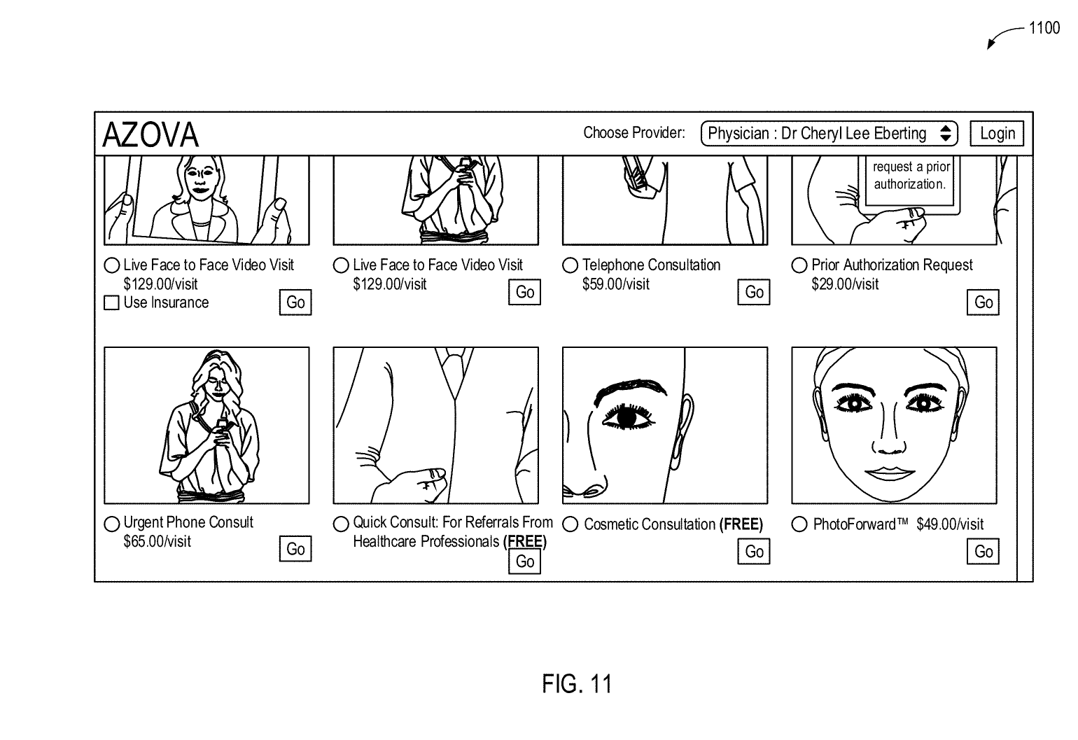

FIG. 10 illustrates a UI 1000 for a patient to select the type of telemedicine visit in which they are interested. Options may include e-visits, in-office visits, and/or house calls. For each given type of appointment type 1001, the drop-down menu 1002 of available practitioners may change to reflect those practitioners that offer the selected type of visit. FIG. 11 illustrates a UI 1100 for a patient to shop online for various classifications, categories, types, or classes of telemedicine visitations. Pricing may reflect cash-payment pricing, insurance pricing, and/or affiliation discount pricing based on a login status, coupon code, or healthcare practitioner selected discount.

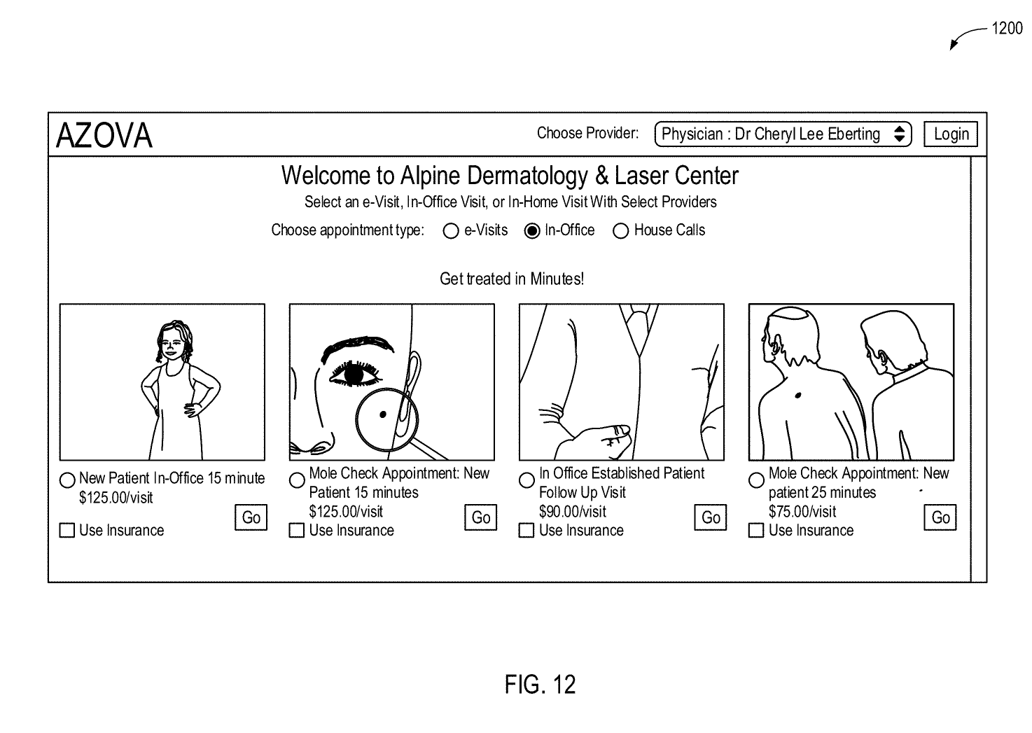

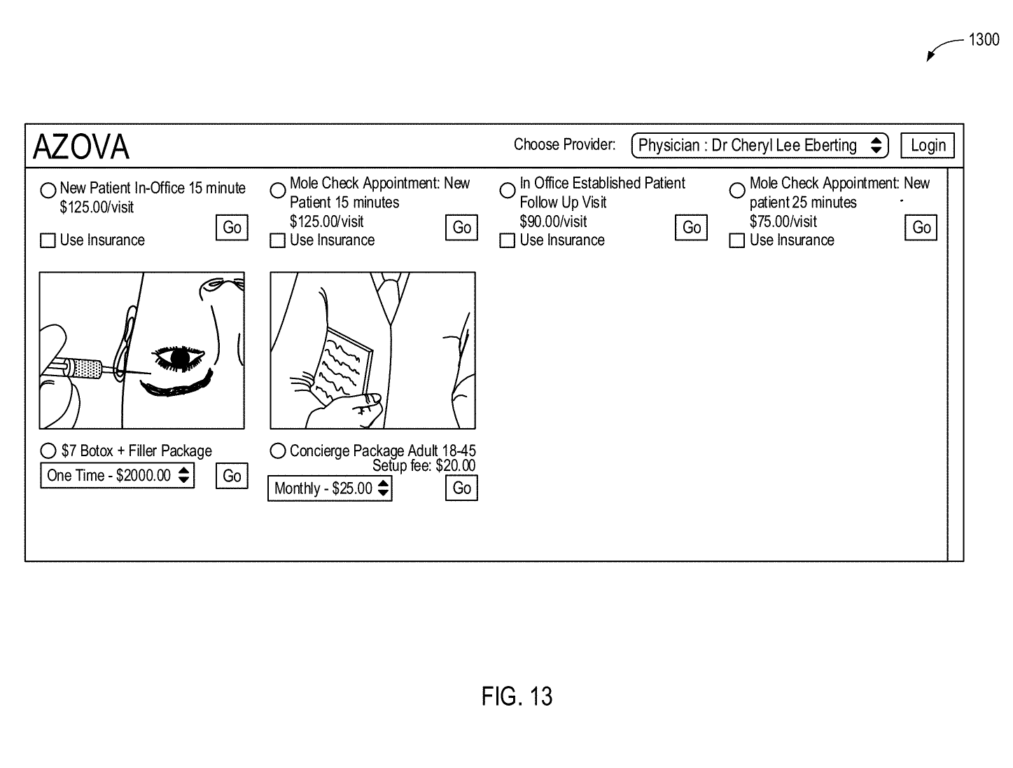

FIG. 12 illustrates a UI 1200 for a patient to shop for and/or schedule an in-office visit. FIG. 13 illustrates a UI 1300 for a healthcare practitioner to offer consultation and/or product packages at reduced or bulk pricing. As an example, a service provider may charge a periodic (weekly, monthly, yearly, multi-year) fee to a healthcare practitioner based on the number and types of content items selected for inclusion on the practitioner-specific telemedicine platform. For instance, pricing models may be created for each content item and/or for packages of content items. In some embodiments, a flat pricing model may be implemented in which a healthcare practitioner pays the service provider a flat rate (one-time or subscription-based) to create a practitioner-specific telemedicine platform with any number or type of content items from the library of content items. In other embodiments, the pricing may be a la carte based on the specific content items selected. In yet other embodiments, the pricing may be based on the actual usage of each of the elected content items included in the practitioner-specific telemedicine platform.

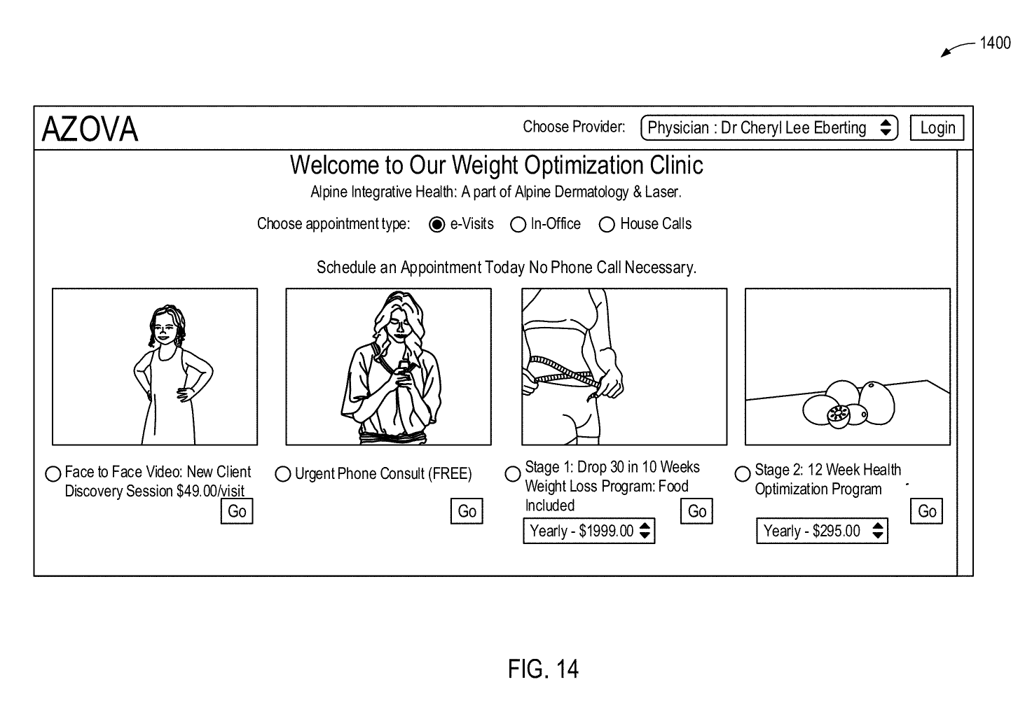

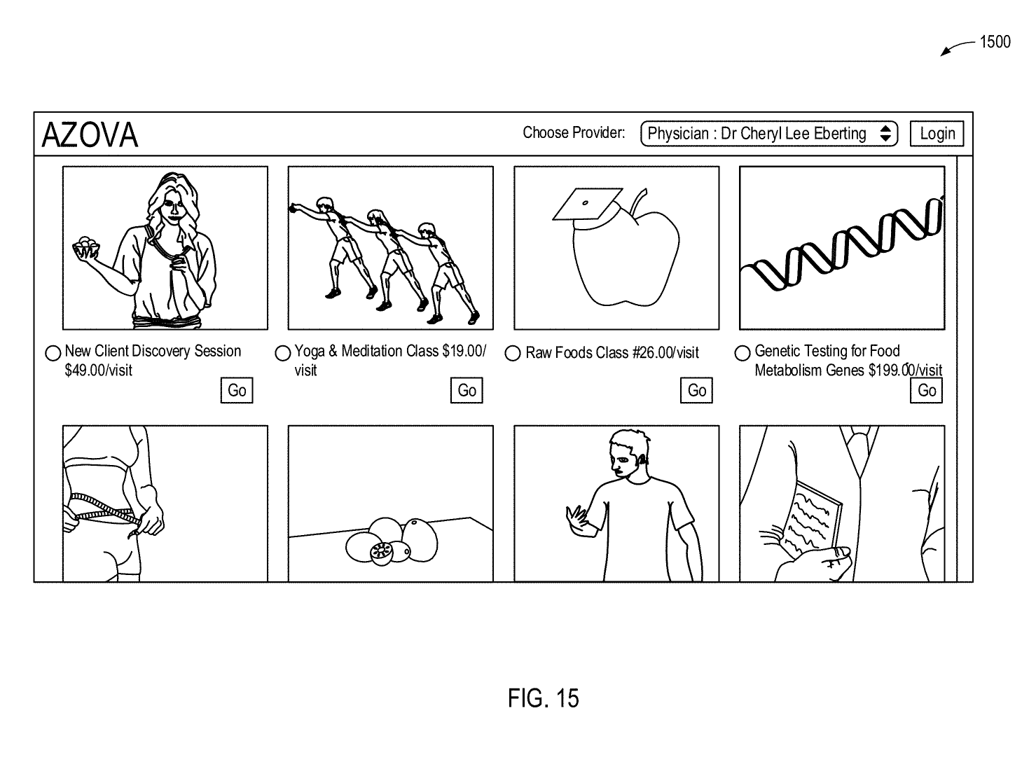

FIG. 14 illustrates the AZOVA™ platform 1400 used to combine e-commerce with a variety of professional service industries. FIG. 15 illustrates various consultations offered by a healthcare practitioner via the AZOVA™ platform 1500.

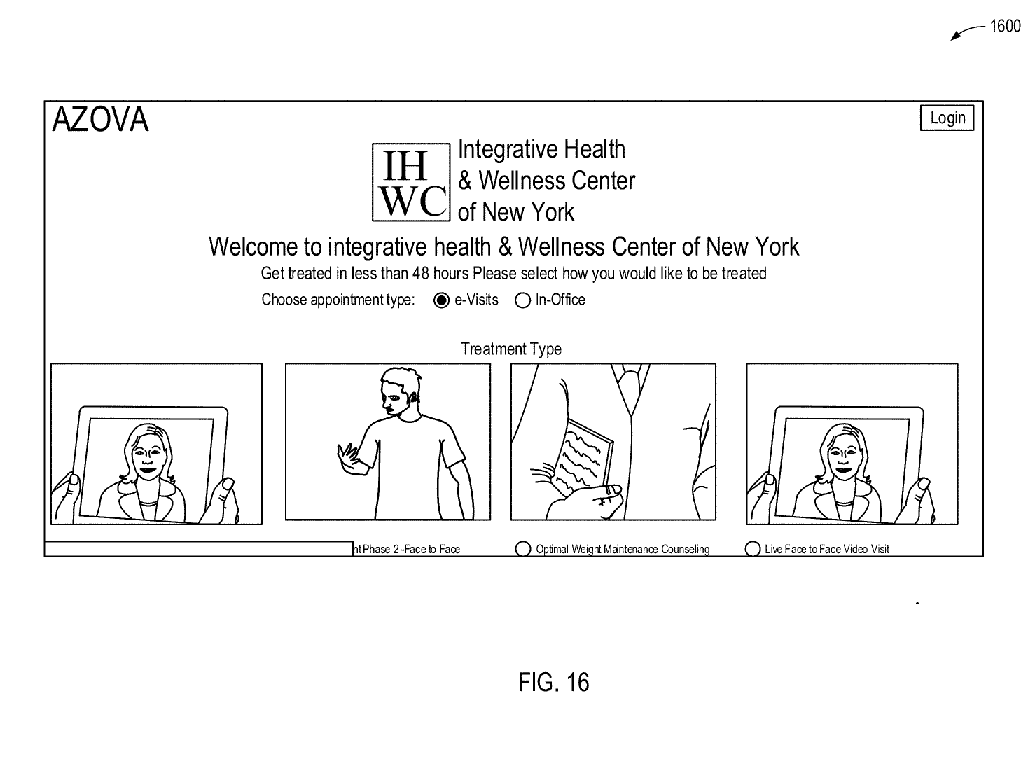

FIG. 16 illustrates the integration of telemedicine and/or other consultation services integrated as part of a concierge offering of an existing website of a business using the AZOVA™ platform 1600 for backend support. In some embodiments, the platform is used to configure a concierge offering for existing businesses. For example, the platform 1600 can be customized in a matter of minutes for integration with an existing website to provide a concierge package of products and services that can be customized for the particular business.

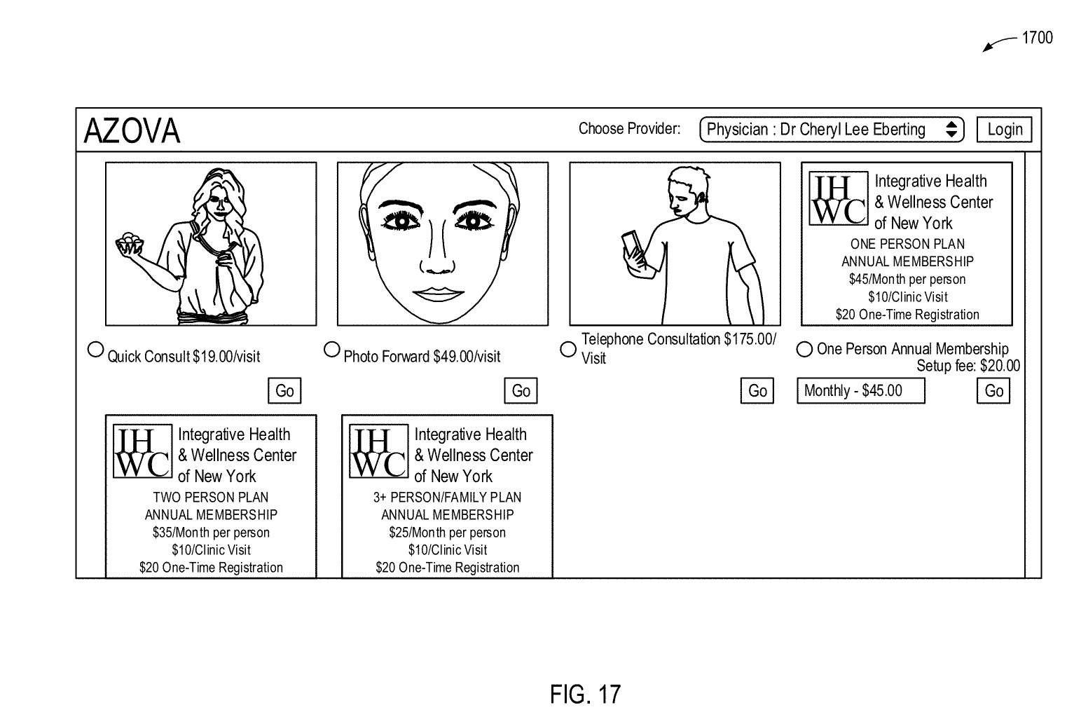

FIG. 17 Illustrates various consultation offerings supported via the AZOVA™ platform 1700 integrated into an online concierge offering. Any of a wide variety of tiered, discounted, incentive-based, and other financial models may be used. For example, in some embodiments, a variation of a concierge subscription model may be used where the patient pays the healthcare provider on a monthly or yearly basis for predetermined telemedicine and/or in-person services.

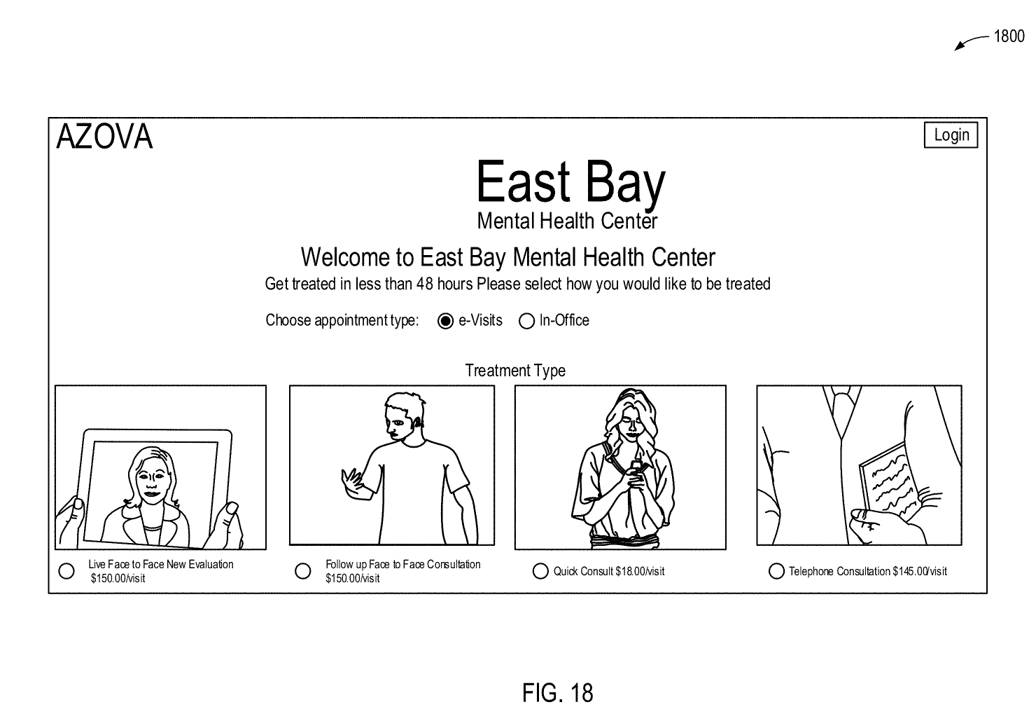

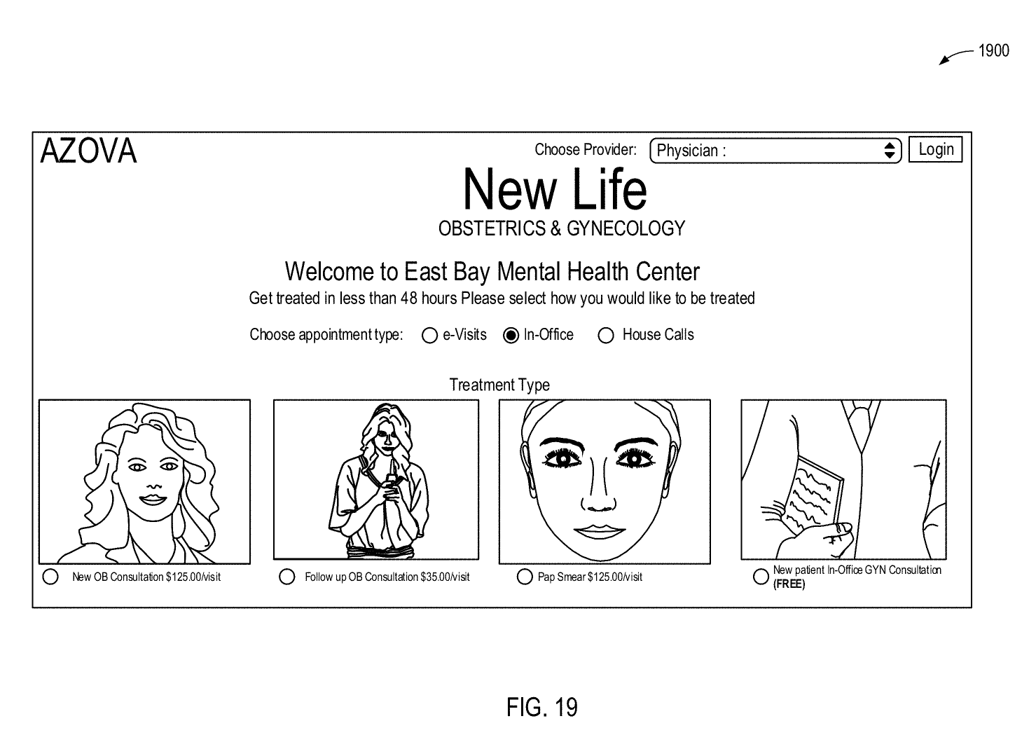

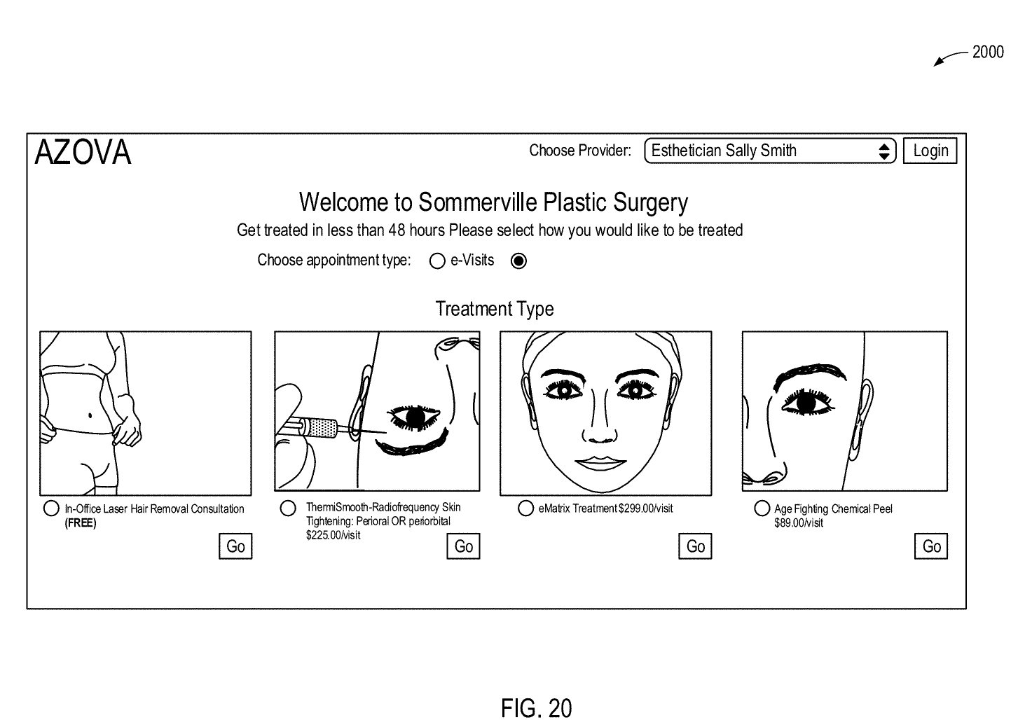

FIGS. 18-20 illustrate various UIs 1800, 1900, and 2000 of a mental healthcare practitioner, a gynecology healthcare organization, and an esthetic healthcare organization, respectively, offering various telemedicine consultations.

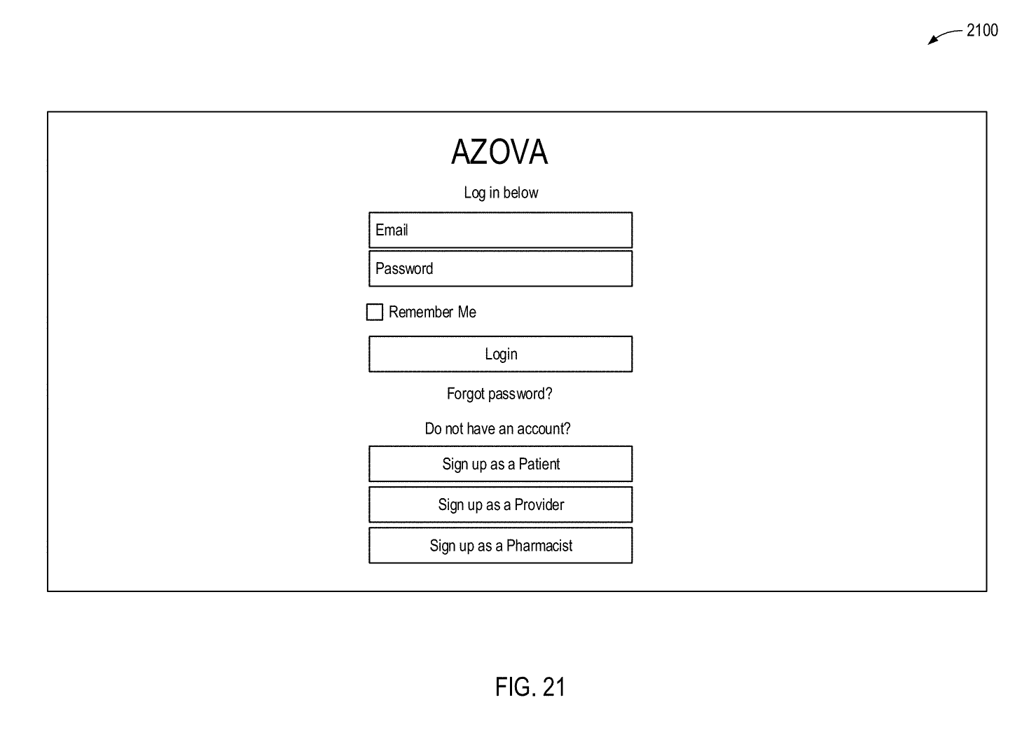

FIG. 21 illustrates a UI 2100 of a login and signup portal for patients, providers, and pharmacists, according to various embodiments. The system may then allow the patient or potential patient to sign in or sign up for a secure account that is HIPPA compliant.

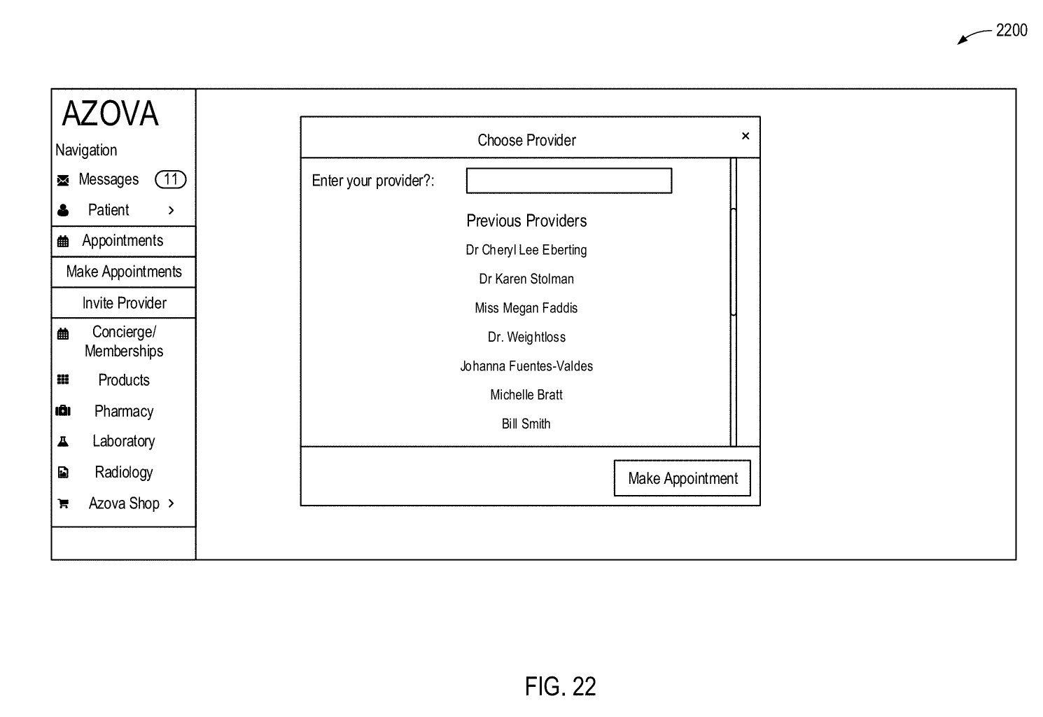

FIG. 22 illustrates a UI 2200 for a patient or prospective patient to select any provider, including providers unaffiliated with the telemedicine platform. In some embodiments, adoption of the platform is encouraged by allowing patients and prospective patients to select, contact, and/or be connected with any service provider, even those service providers that are not affiliated with the platform. In such embodiments, the unaffiliated service provider may be encouraged to become an affiliate.

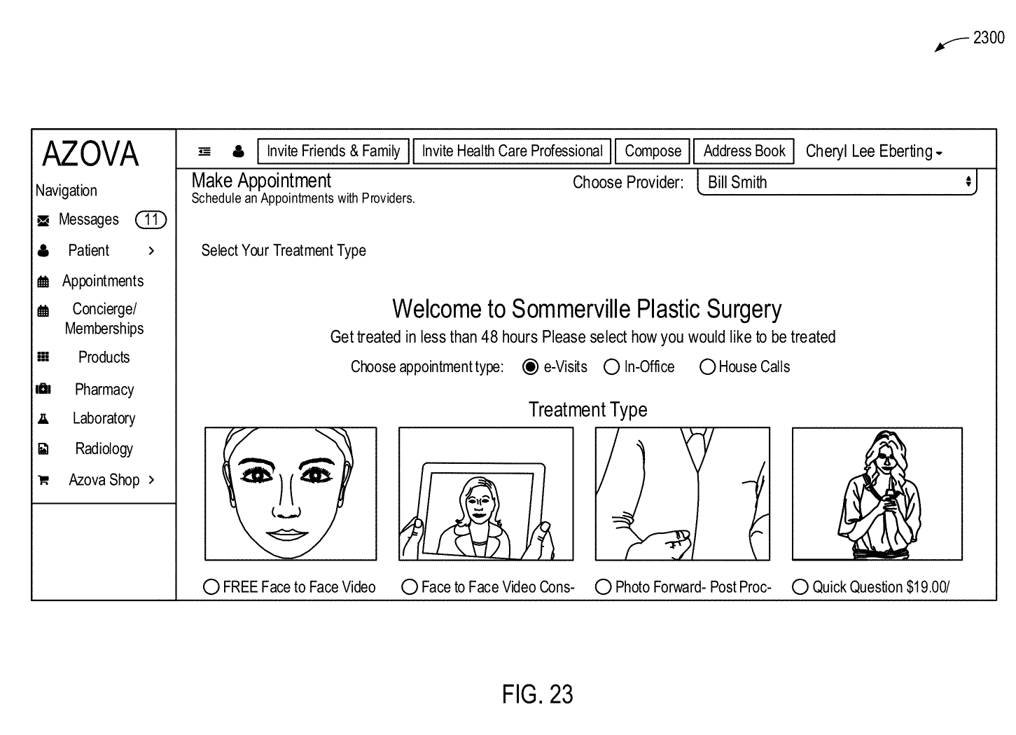

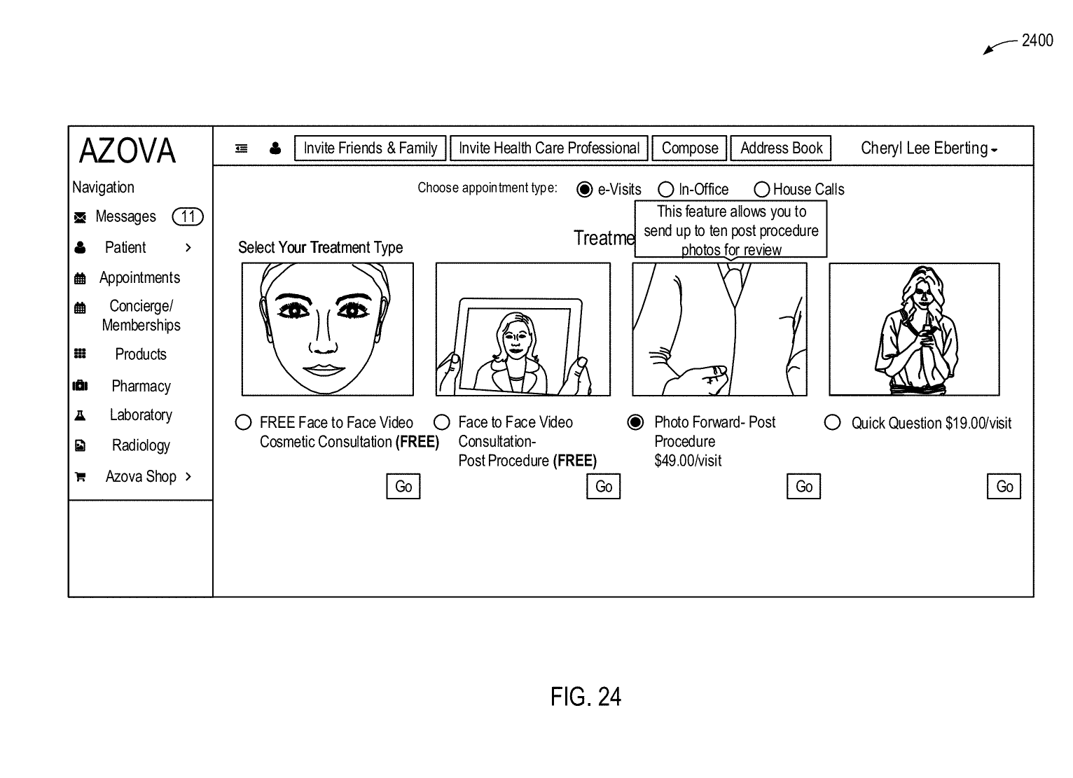

FIG. 23 illustrates a UI 2300 for an esthetic healthcare organization that allows a patient or prospective patient to select a treatment and visitation type. FIG. 24 illustrates a UI 2400 for a healthcare practitioner to customize the telemedicine offerings. In some embodiments, free consultations may be offered to entice new customers or retain existing customers. In some instances, consultations that would normally cost money may be offered for free or at a discounted price if selected in the context of purchasing a product. For example, the purchase of a particular face cream or subscription to a medication may include a free telepresence consultation. Such a consultation may also be required for the purchase. For instance, a prescription medication available for purchase may be coupled to a telepresence consultation during which the healthcare practitioner can provide the requisite prescription for the medication.

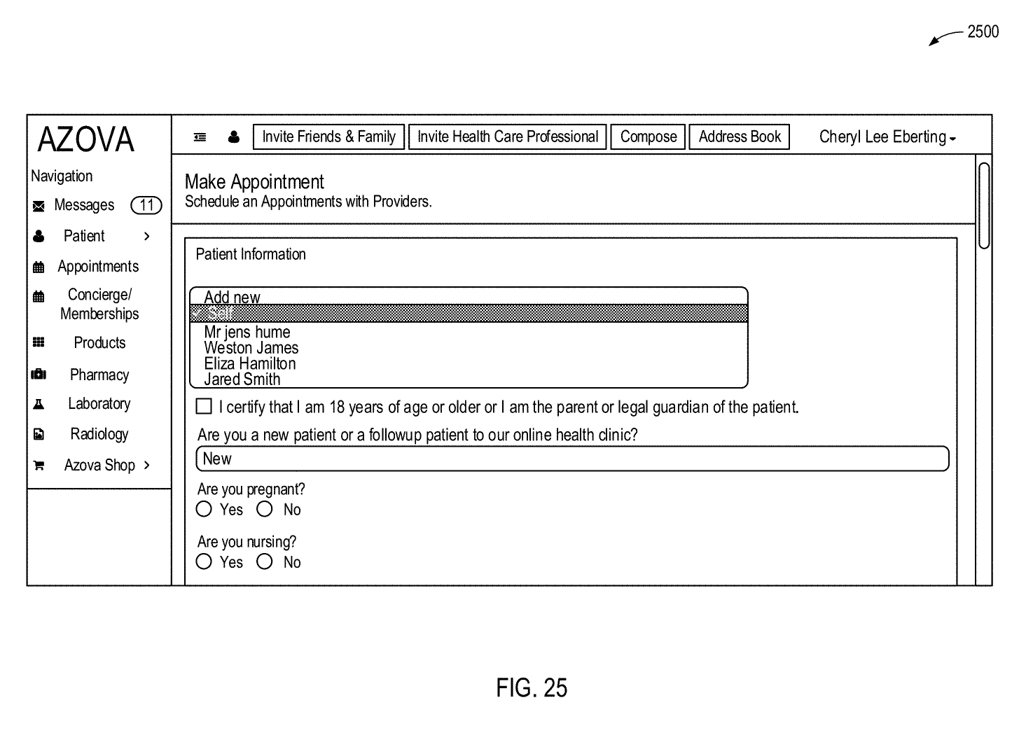

FIG. 25 illustrates a UI 2500 for a user to see, review, and/or schedule a visitation with any healthcare practitioner on behalf of themselves or another. In various embodiments, visits of any type can also be customized based on a referral from another provider. In some embodiments, in-office appointments and procedures can be offered and scheduled by a patient without generating a phone call.

Offerings may include products and services, some of which may be coupled with consultations. Memberships and packages may also be offered. Thus, a provider can offer a combination of products and services and package them together. Such combinations may be offered at discounts and may include one-time purchases, monthly subscriptions, and/or other periodic recurrence.

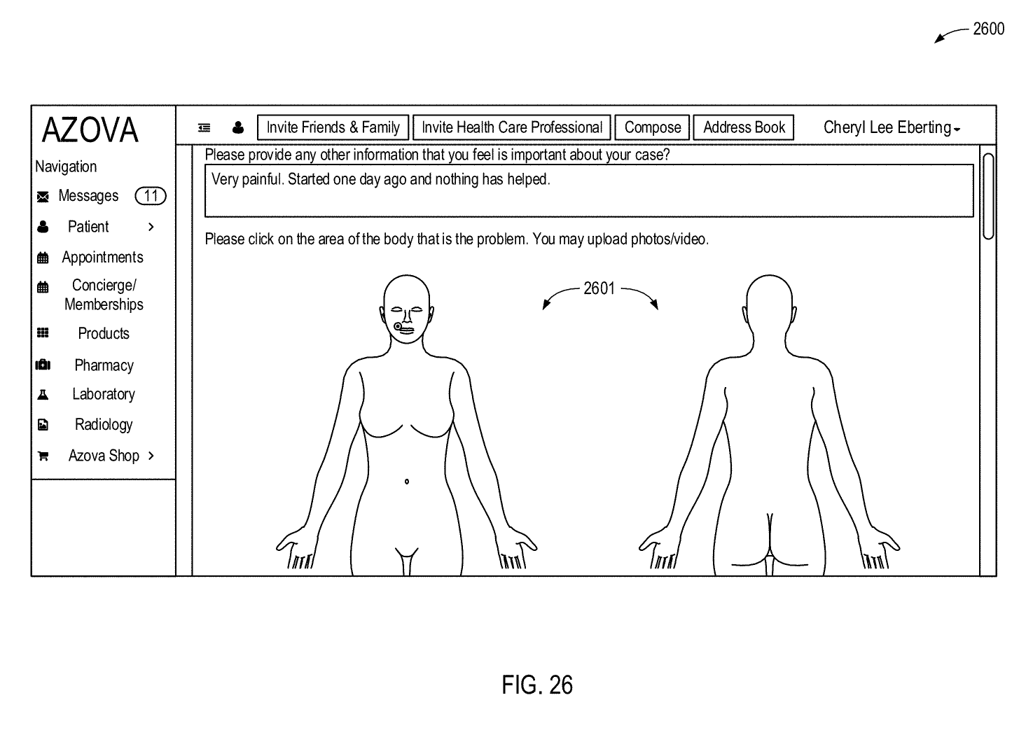

FIG. 26 illustrates a UI 2600 of an online intake form for a patient or potential patient. In some embodiments, an intake form or patient submission form may allow a patient, prospective patient, and/or agent of a patient to describe the reason for their visit (e-visit or otherwise). The intake process may allow the user to provide images, videos, or documents. In some embodiments, a model 2601 of a human may be shown that allows the patient to indicate where exactly the problem or issue is on the body.

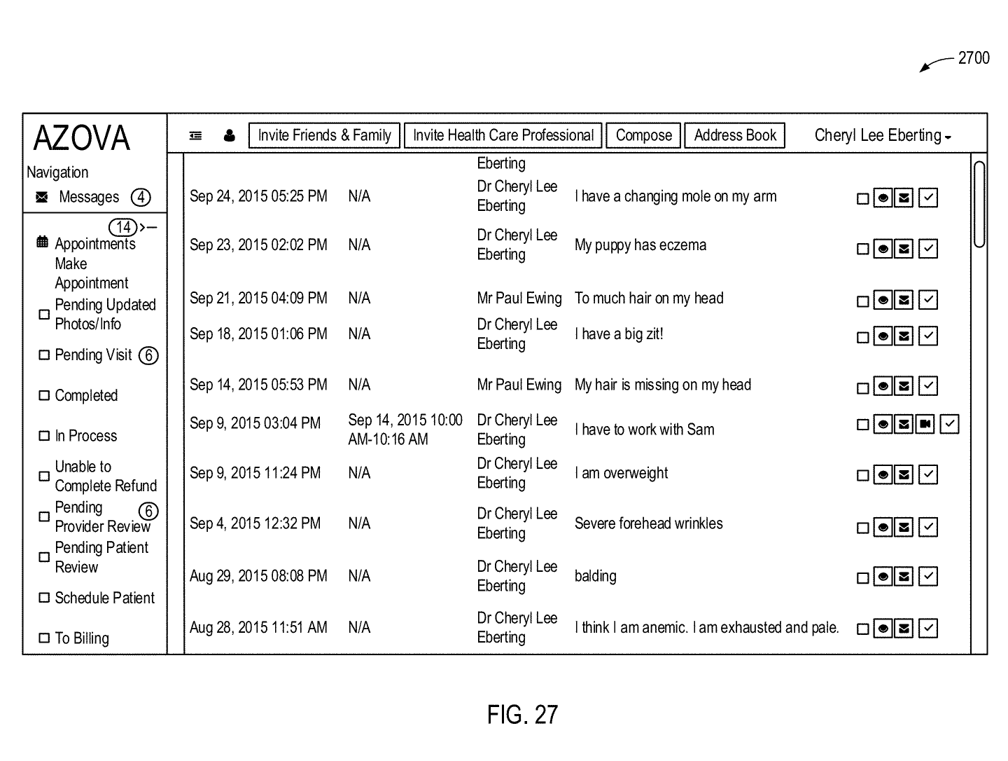

FIG. 27 illustrates a UI 2700 for showing historical consultations and visits, according to various embodiments. Historical data may be made accessible to patients and/or healthcare practitioners to view past appointments. The historical information may include only the history relevant to the particular healthcare facility or organization, or may include all history from all health professionals, pharmacists, laboratories, or imaging centers. In such embodiments, a patient may be able to selectively hide some of the information from other practitioners.

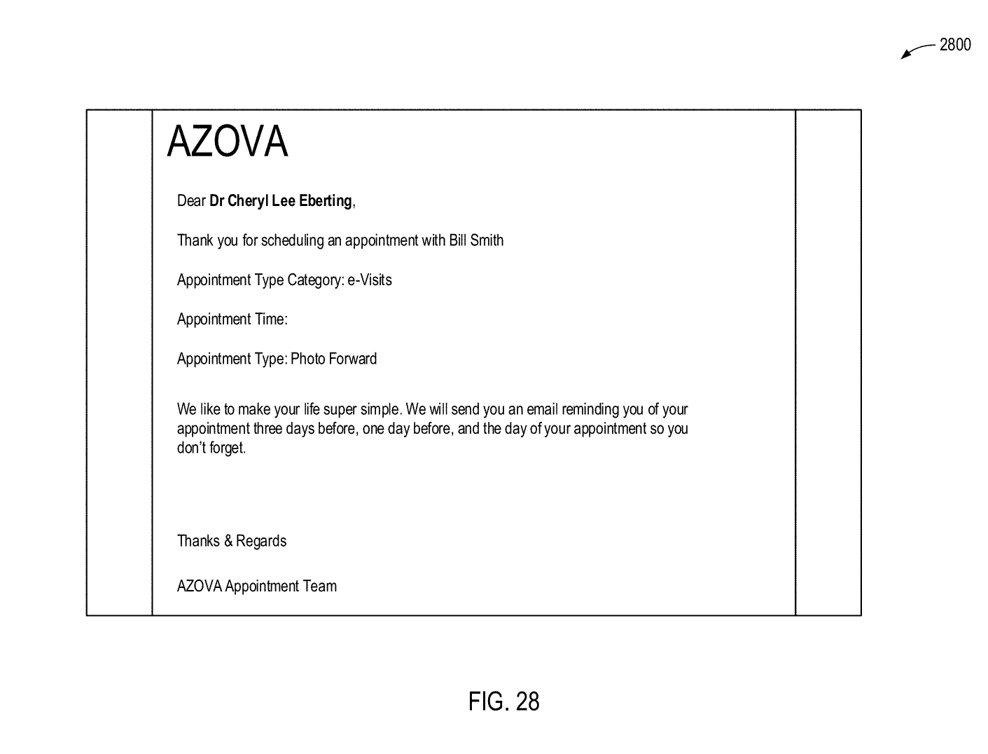

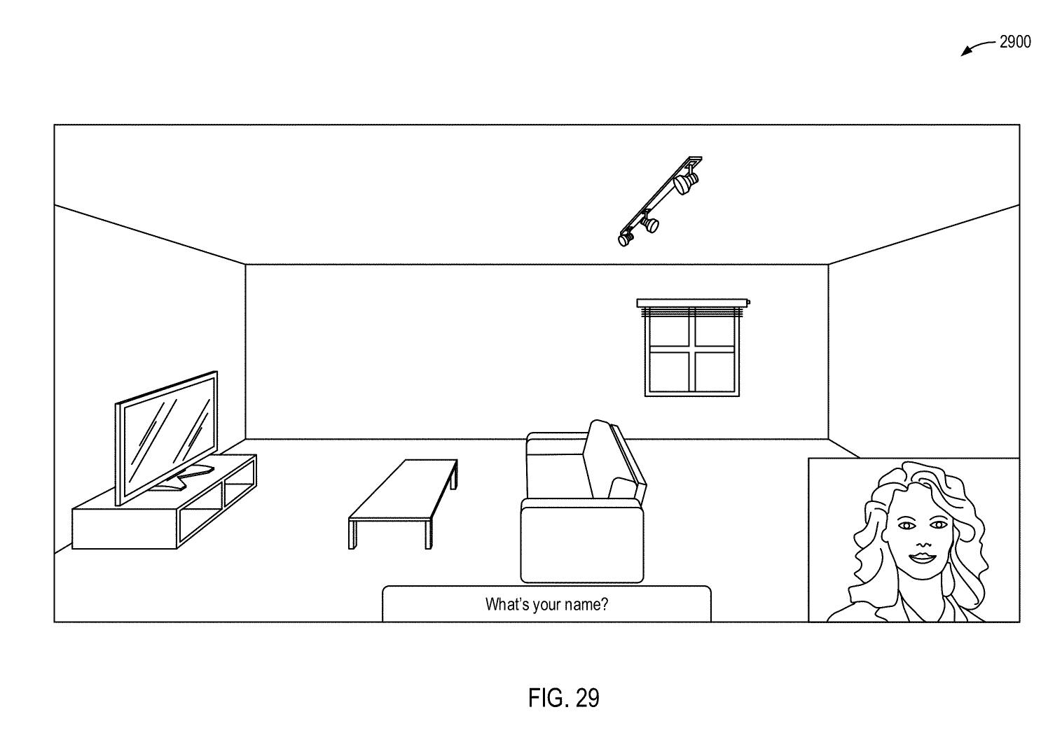

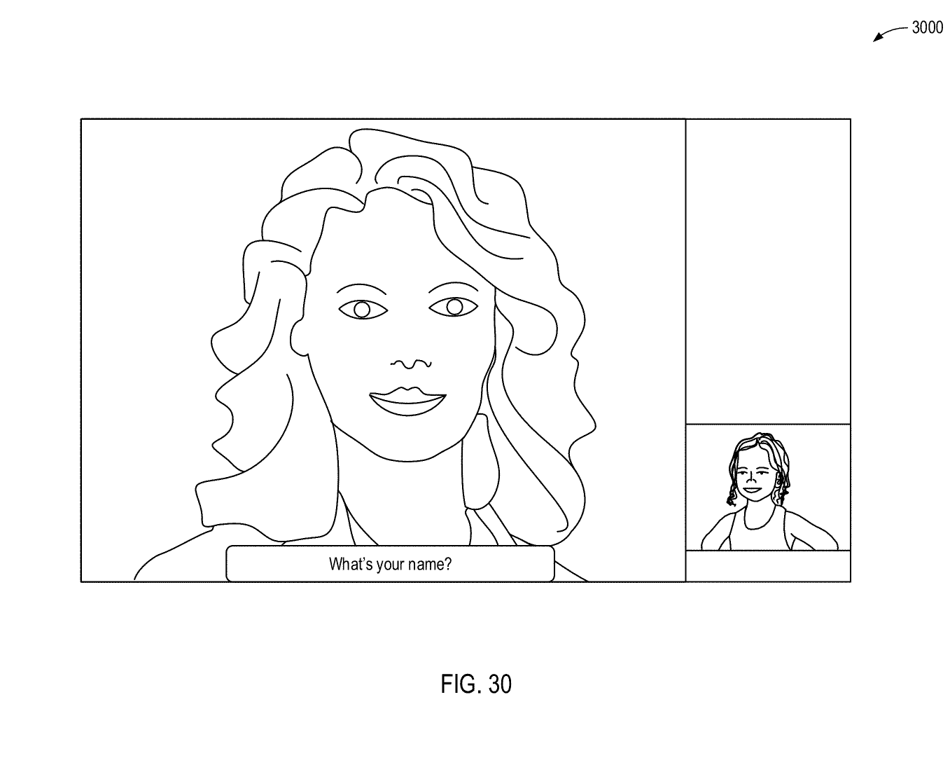

FIG. 28 illustrates an automatic appointment reminder 2800 generated via the AZOVA™ platform that can be customized. FIG. 29 illustrates a videoconference picture-in-picture 2900 that can be used as part of a telemedicine consultation. FIG. 30 illustrates another videoconference picture-in-picture 3000 that can be used as part of a telemedicine consultation. In some embodiments, during an e-visit, such as a video telemedicine consultation, a patient is asked “would you like to record this video (or phone) consultation for future reference?” If the patient consents, a fee may apply.

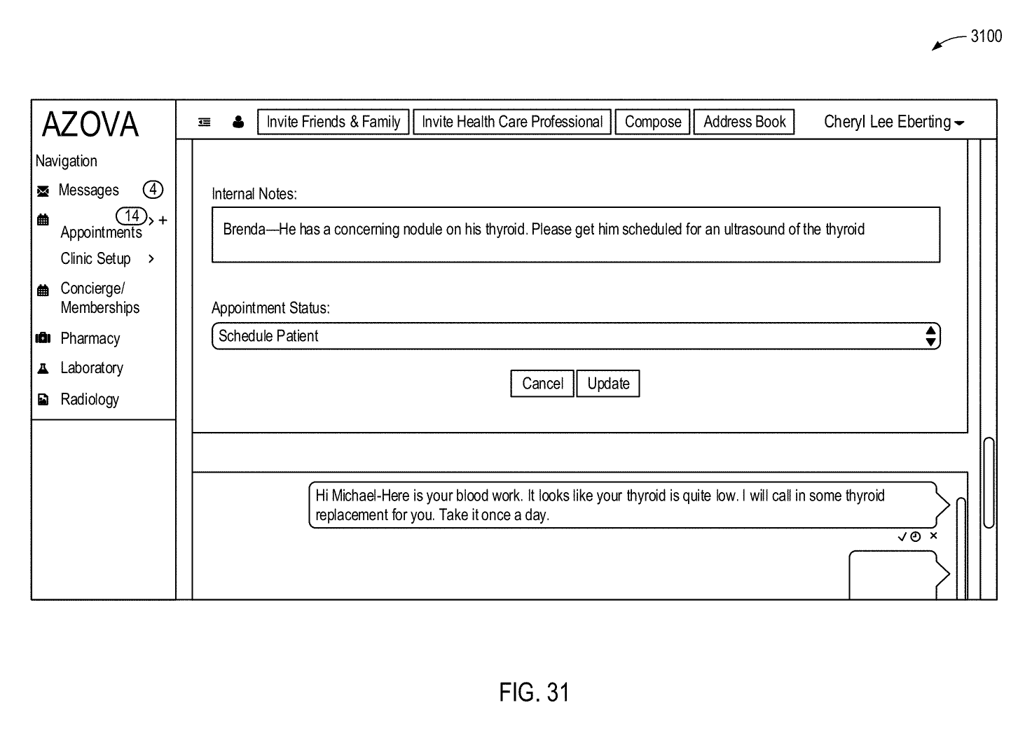

FIG. 31 illustrates a UI 3100 for providing a consultation or appointment status and notes, according to various embodiments. A status of a consultation or visit may be accessible to patients and/or healthcare practitioners to allow for easy tracking of next-steps or outstanding tasks. In some embodiments, a change in status of a consultation may trigger a notification to relevant parties. For instance, each update may be sent to a patient so the patient knows what is being done for them (e.g., “Your order has been sent to the lab” or “Prescription sent to the pharmacy”).

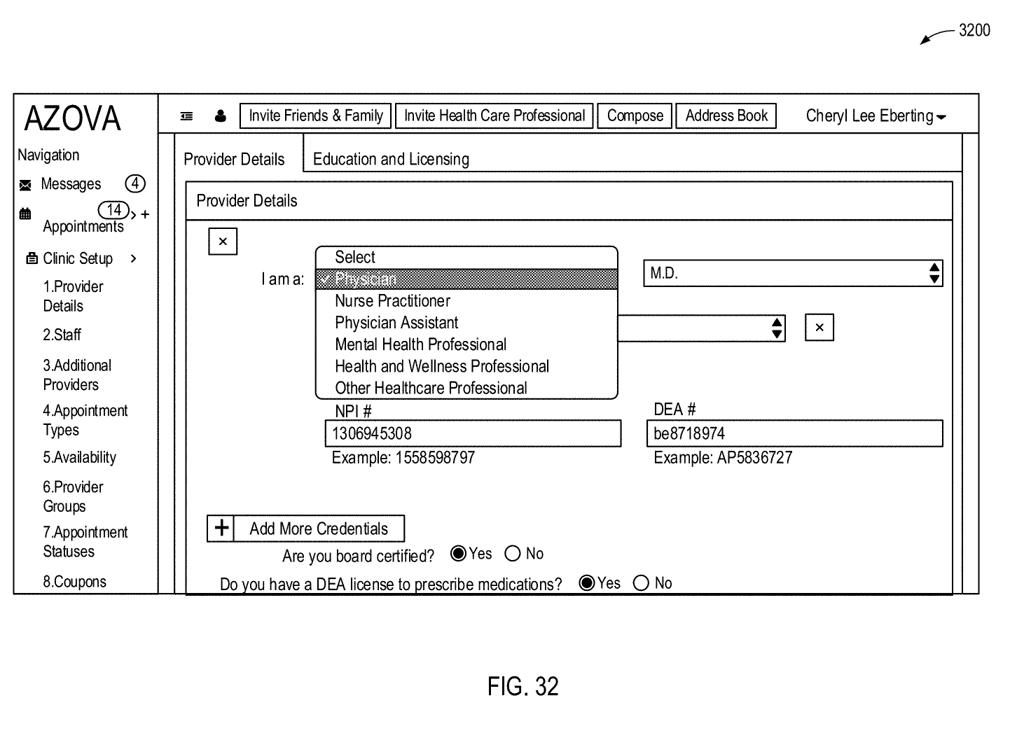

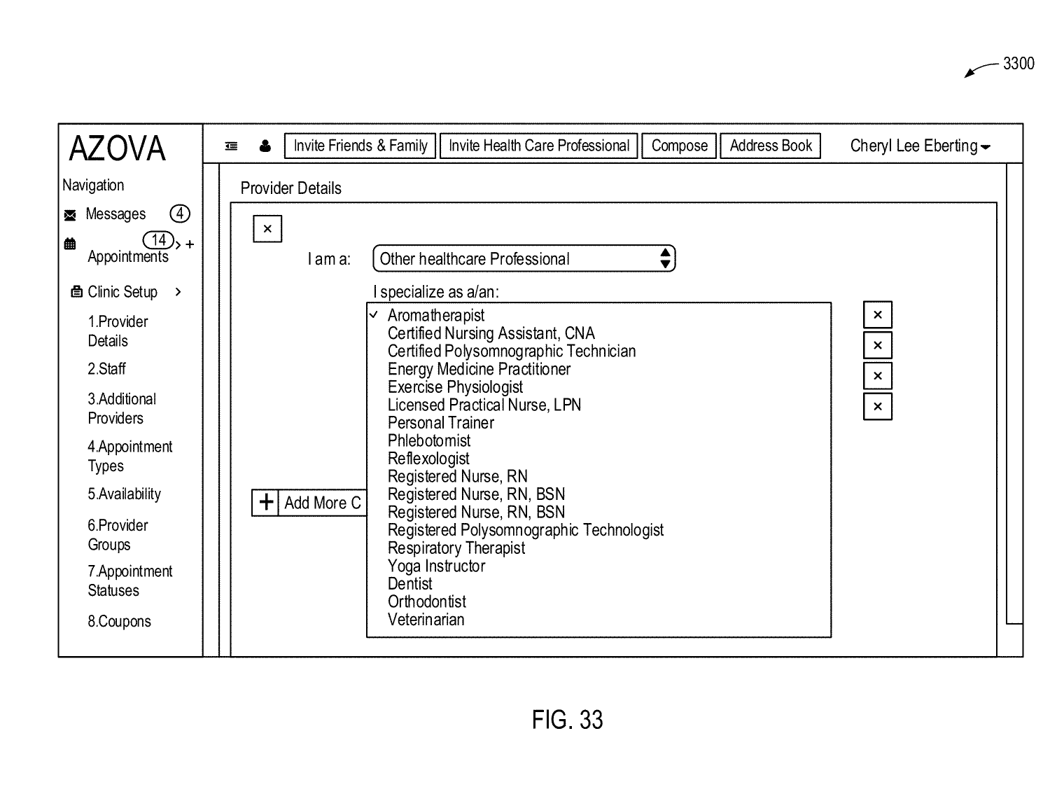

FIG. 32 illustrates a UI 3200 for a provider of any of a wide variety of professional service types to a register for the AZOVA™ platform. FIG. 33 illustrates another embodiment of a UI 3300 for a provider of any of a wide variety of professional service types to a register for the AZOVA™ platform.

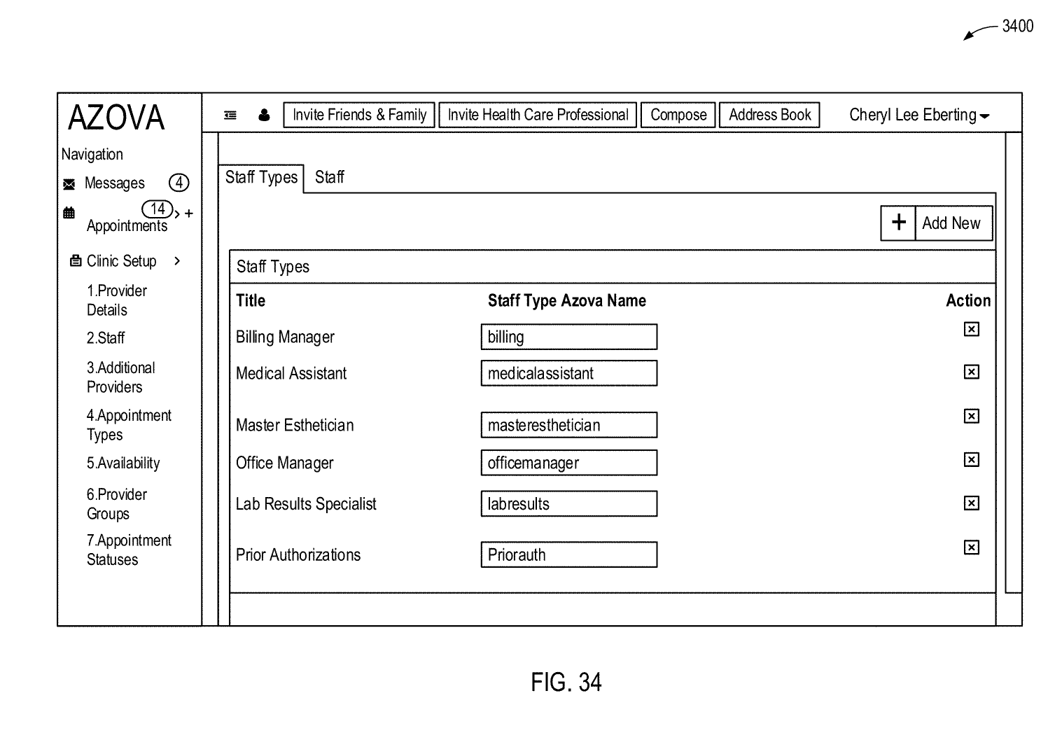

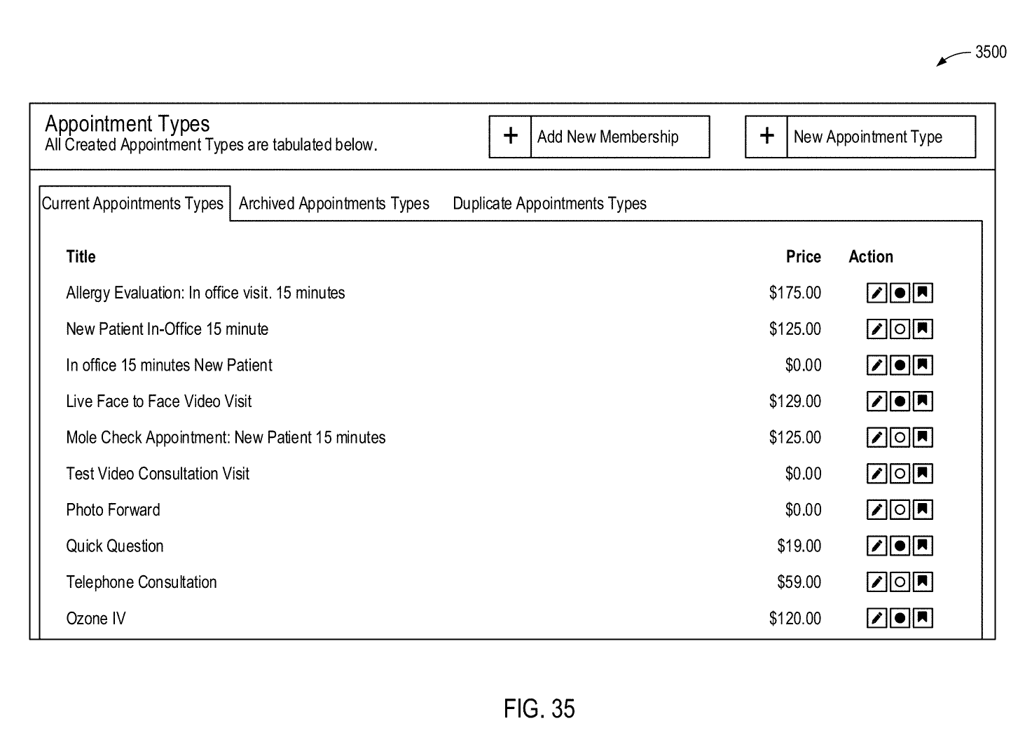

FIG. 34 illustrates a UI 3400 for assigning individuals various roles with the AZOVA™ platform, according to various embodiments. FIG. 35 illustrates a UI 3500 for customizing and configuring appointment types, according to various embodiments.

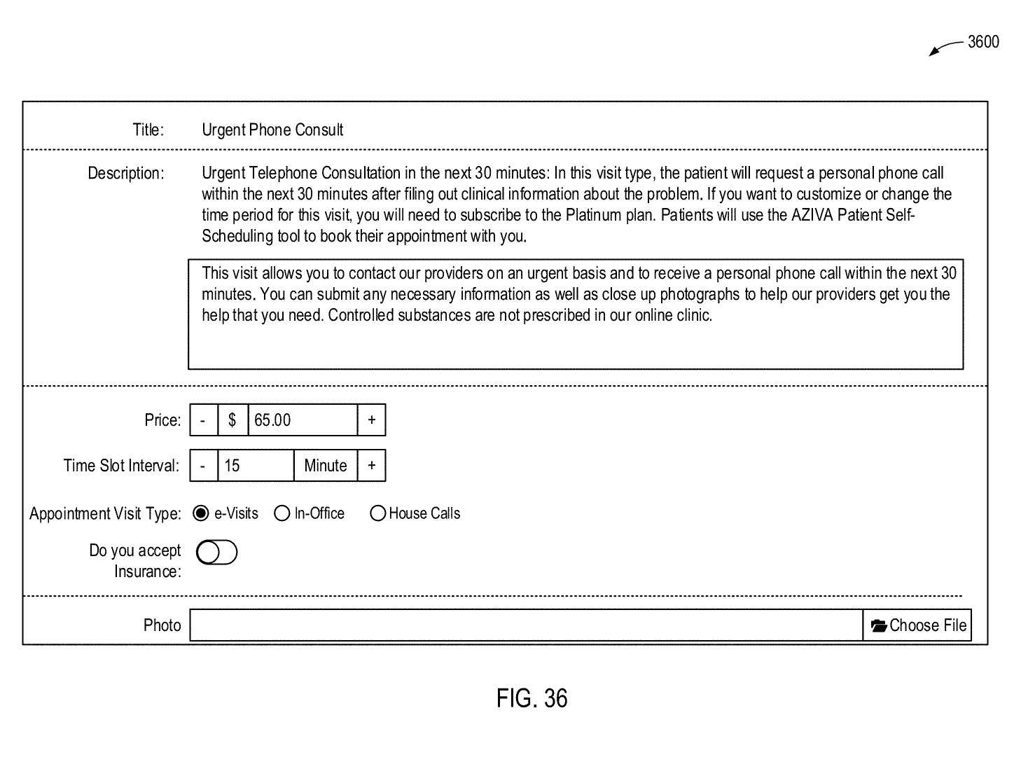

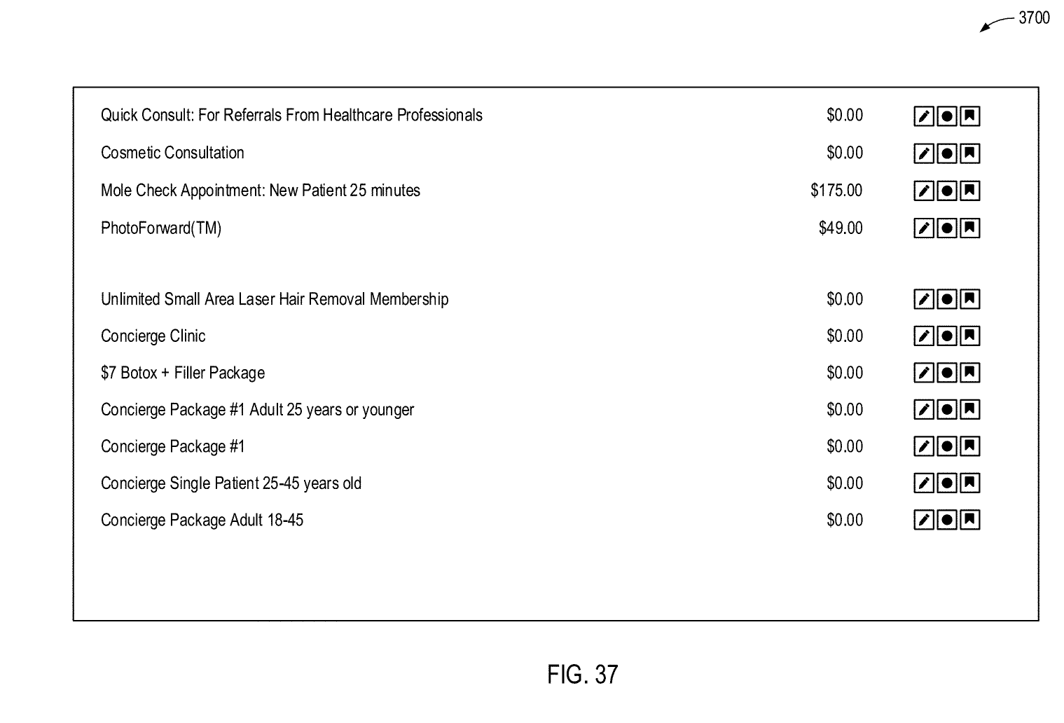

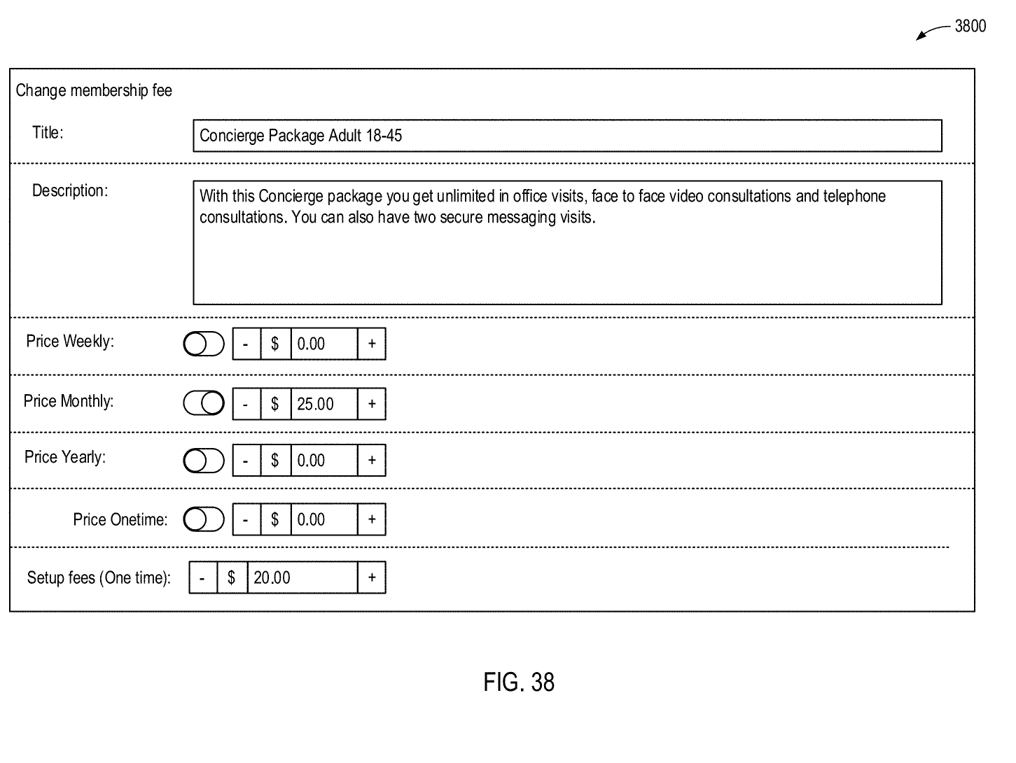

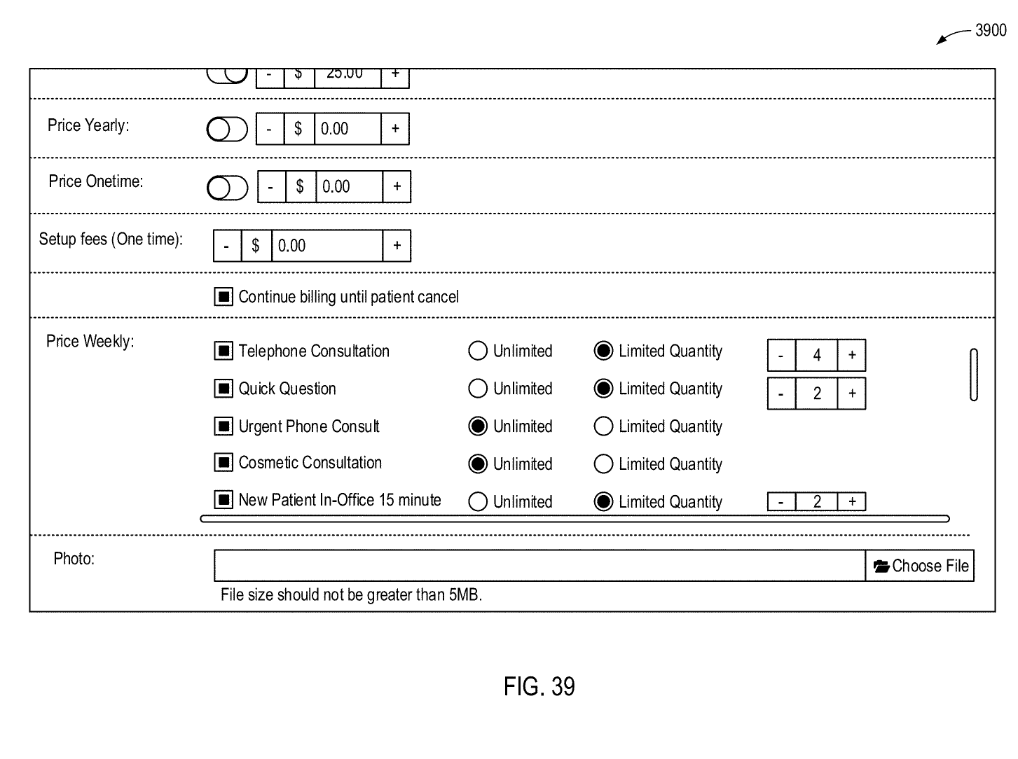

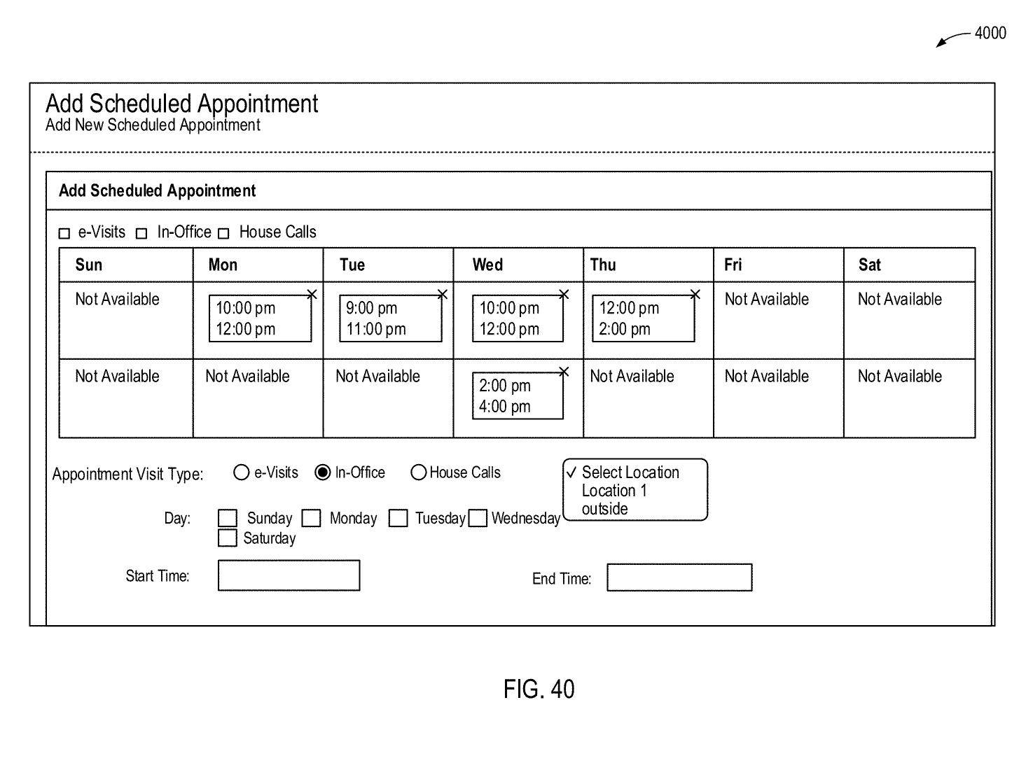

FIGS. 36-40 illustrate UIs 3600, 3700, 3800, 3900, and 4000 for customizing and configuring appointment types, according to various embodiments.

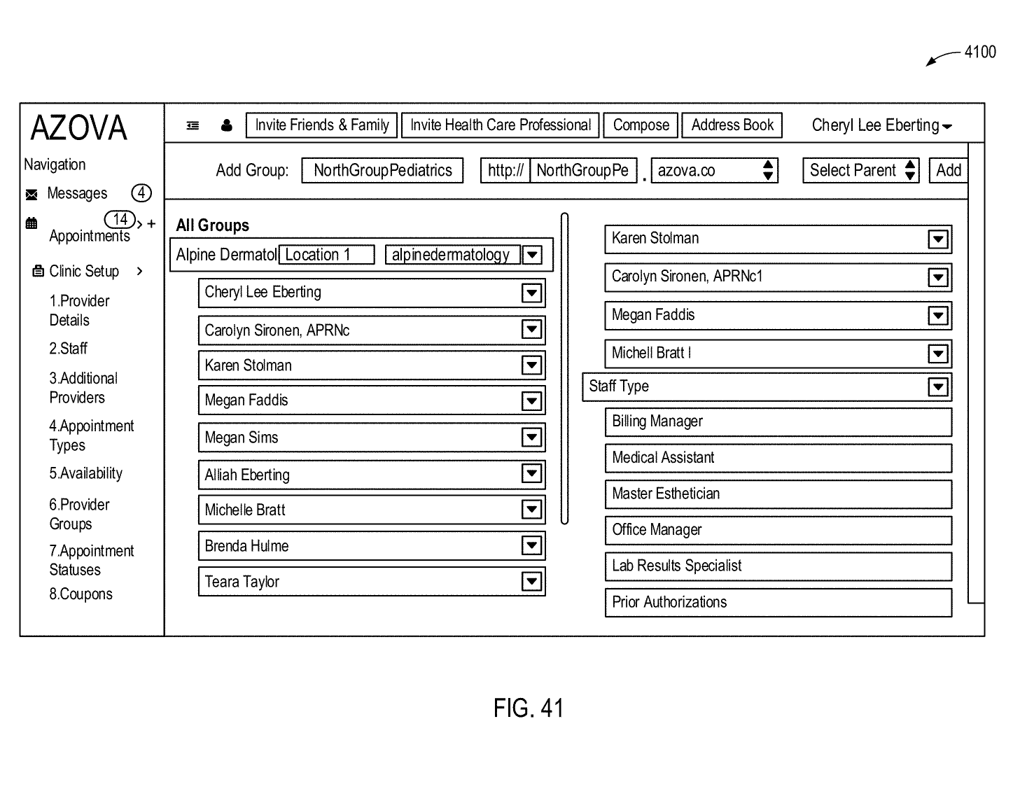

FIG. 41 illustrates a UI 4100 for group management to create groups of staff and/or healthcare practitioners within an organization and between organizations. Groups may be created that include various staff members and healthcare professionals. A unique clinic URL can be created for each provider or combination of providers and staff members. As an example, a primary care physician or a mental health or wellness provider may be included in any number of other specialty clinics. These groups may include various specialists and general practitioners that are not physically near each other. Specialists may be included in multiple groups to effectively share their specialized skills between various groups, potentially minimizing the costs of care with specialists and providing an introduction of specialists into unique circles of general practitioners.

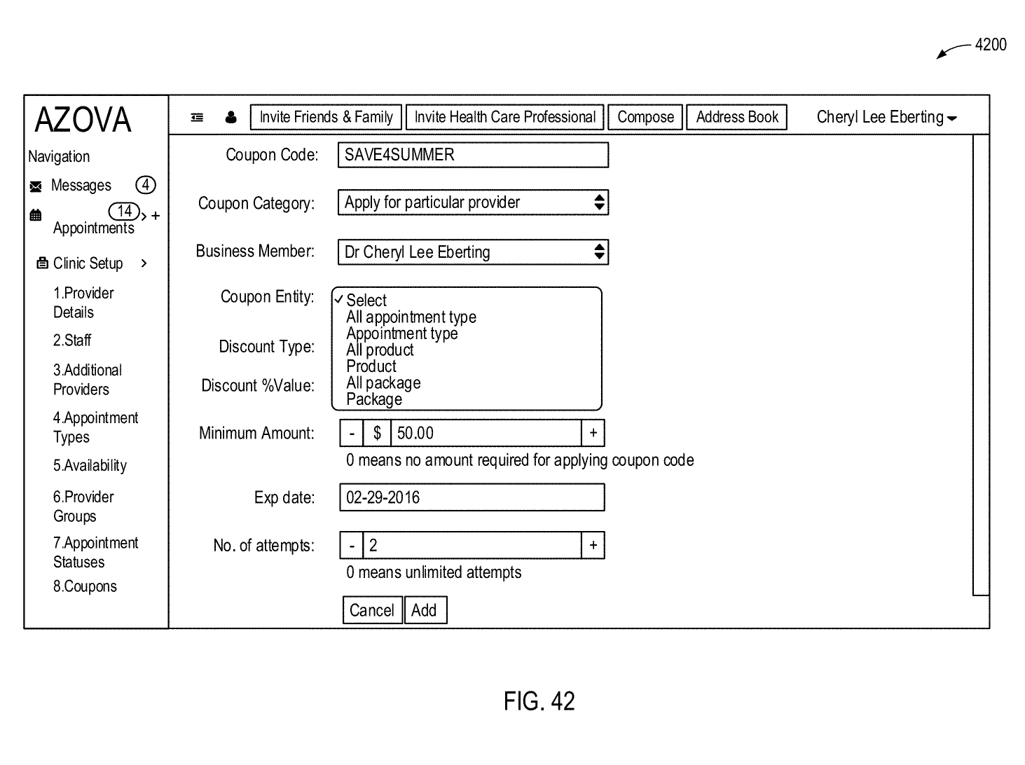

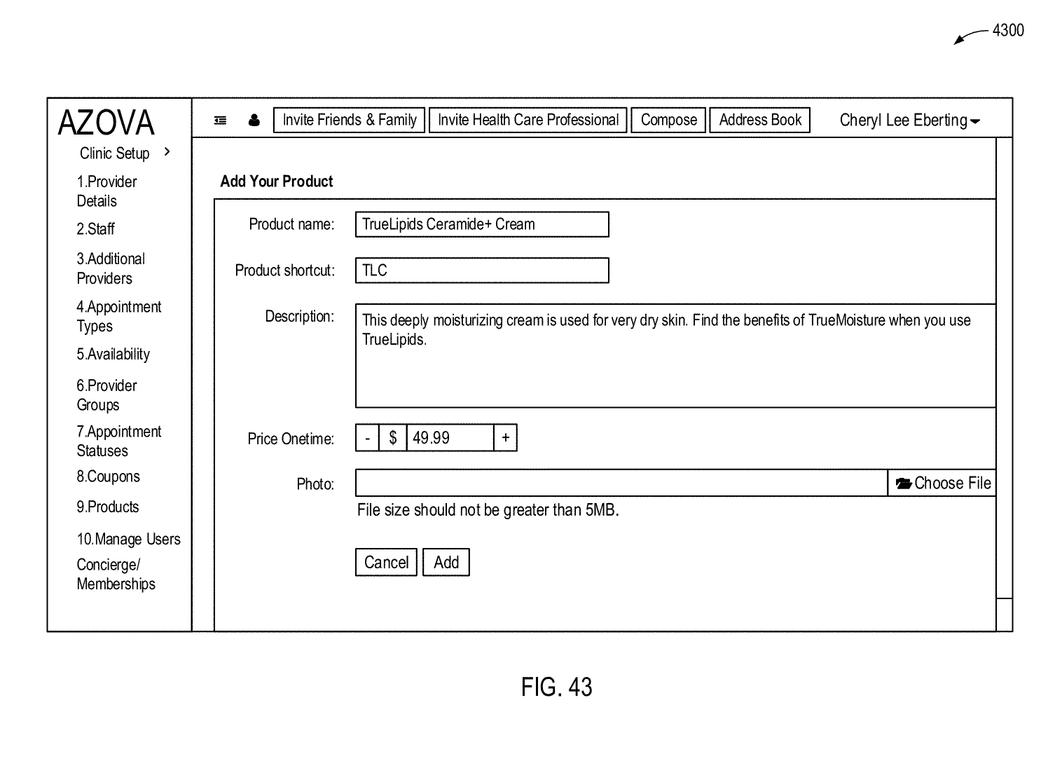

FIG. 42 illustrates a UI 4200 for creating coupons for various products and services, according to various embodiments. FIG. 43 illustrates a UI 4300 for adding and/or customizing product and/or service offerings, according to various embodiments.

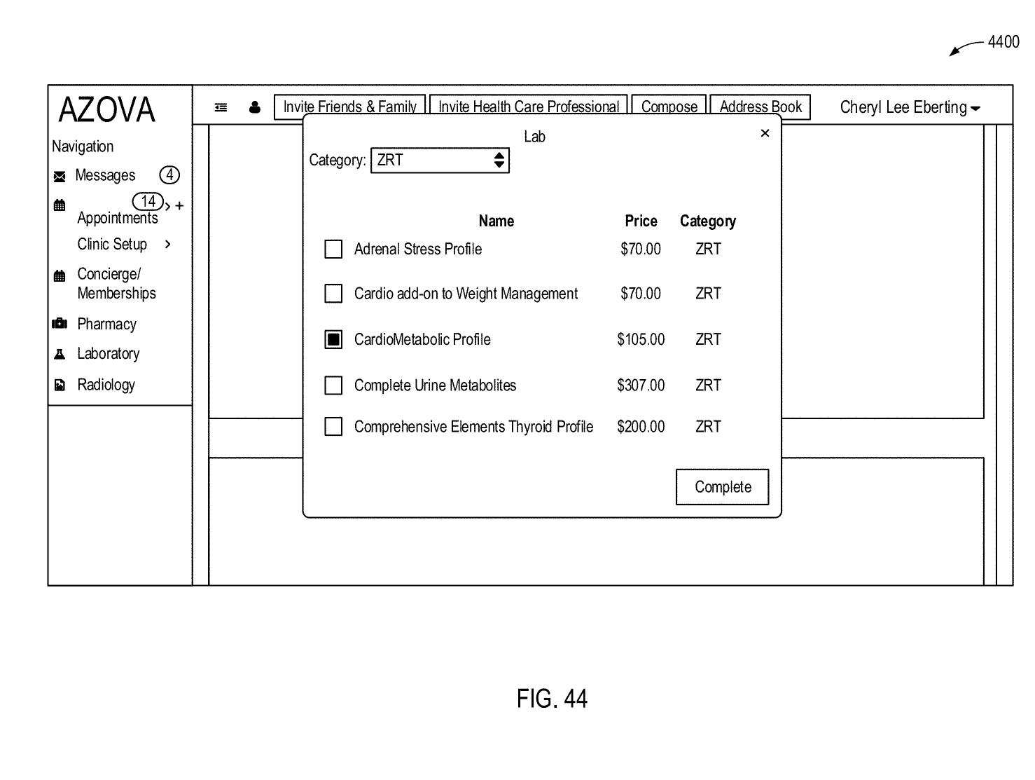

FIG. 44 illustrates a UI 4400 for ordering or requesting various imaging, studies, prescriptions, products, and/or services, according to various embodiments. Laboratory ordering, imaging, and prescriptions may all be integrated and connected. Lab tests, prescription drugs, and imaging studies can be offered for sale on the health professional's online store or can be ordered by the health professional as the result of a consultation purchased through the online clinic.

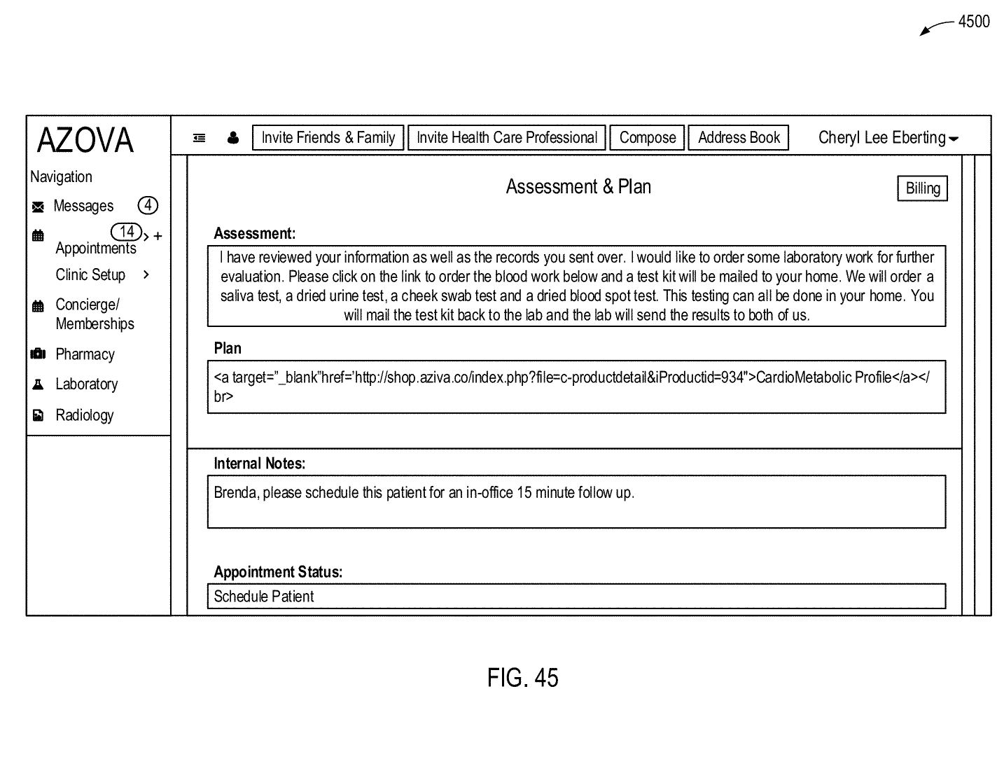

FIG. 45 illustrates a UI 4500 for creating and/or viewing an assessment, plan, and/or internal notes associated with an appointment, including a status identifier.

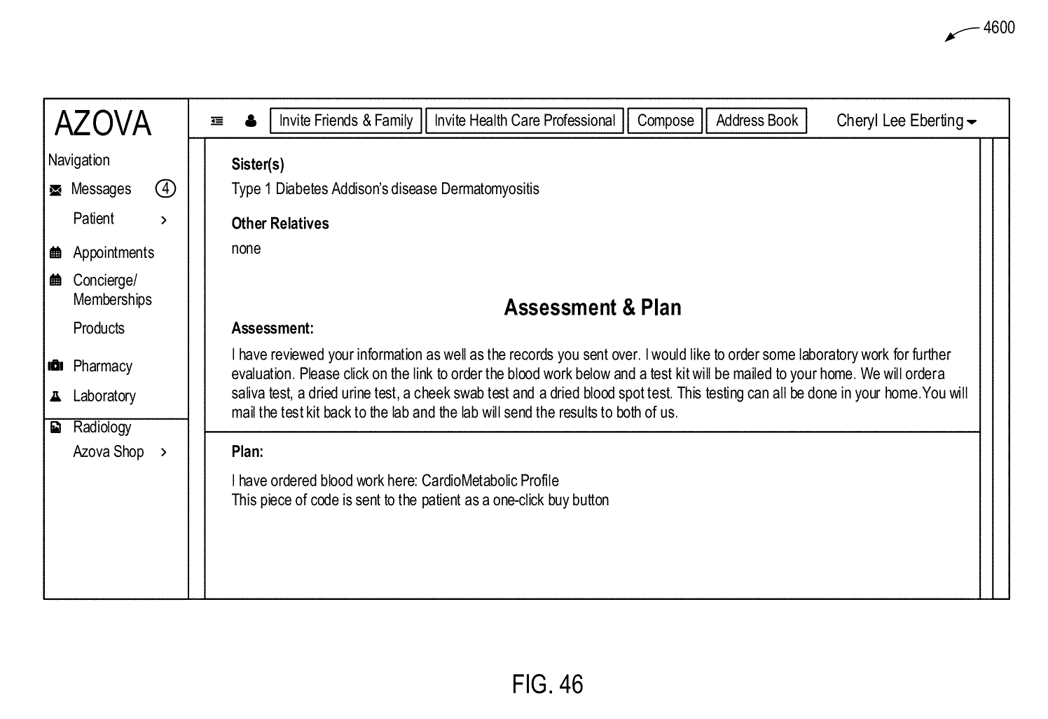

FIG. 46 illustrates a UI 4600 for a healthcare practitioner to provide an assessment and plan to a patient that includes a click-to-order or click-to-buy link for imaging, studies, prescriptions, products, and/or services. Thus, the platform allows for the integration of physician-recommended-only products, lab studies, and pharmaceutical drugs that are offered for “sale” to the patient on the doctor's website and which are then integrated into a mandatory online consultation.

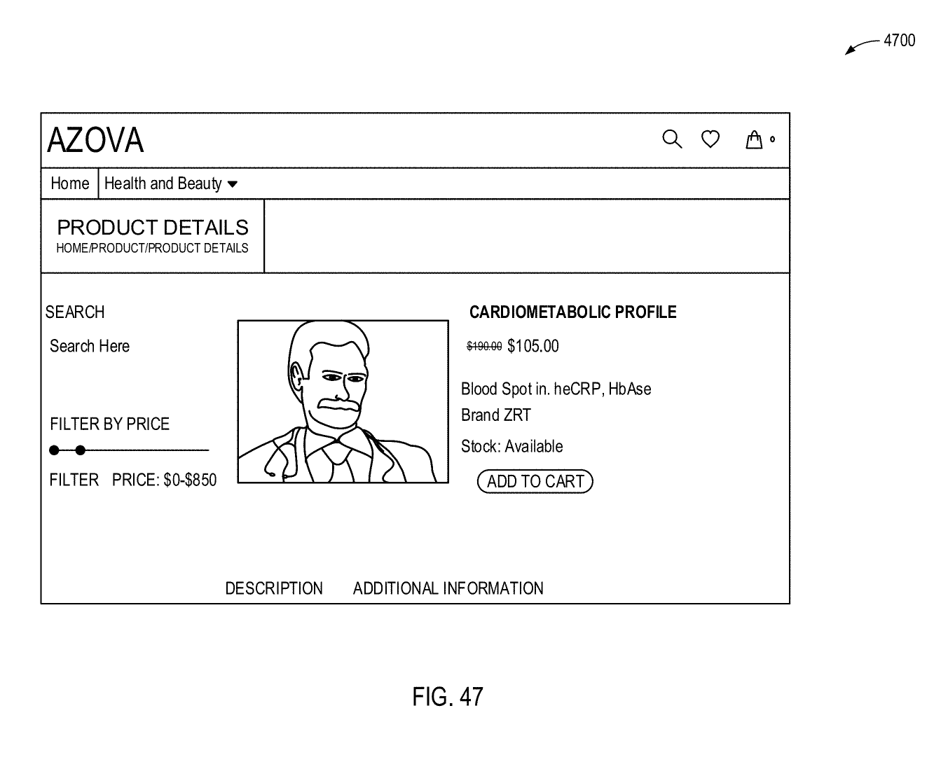

FIG. 47 illustrates a UI 4700 of one embodiment of an e-commerce integrated offering of the AZOVA™ platform, according to various embodiments. When a provider recommends or approves a request to buy a pharmaceutical drug, imaging study, or lab test, the provider may select the pharmaceutical, lab test, or imaging study and then send a click-to-buy button or link to the patient for purchase.

FIG. 48 illustrates a graphical user interface 4800 of a consultation sourcing system for selecting a language, according to various embodiments. As shown, a user may be presented with service options. The interface may show the price and the availability of the services and a brief description. In various embodiments, mouse-overs may present additional information.

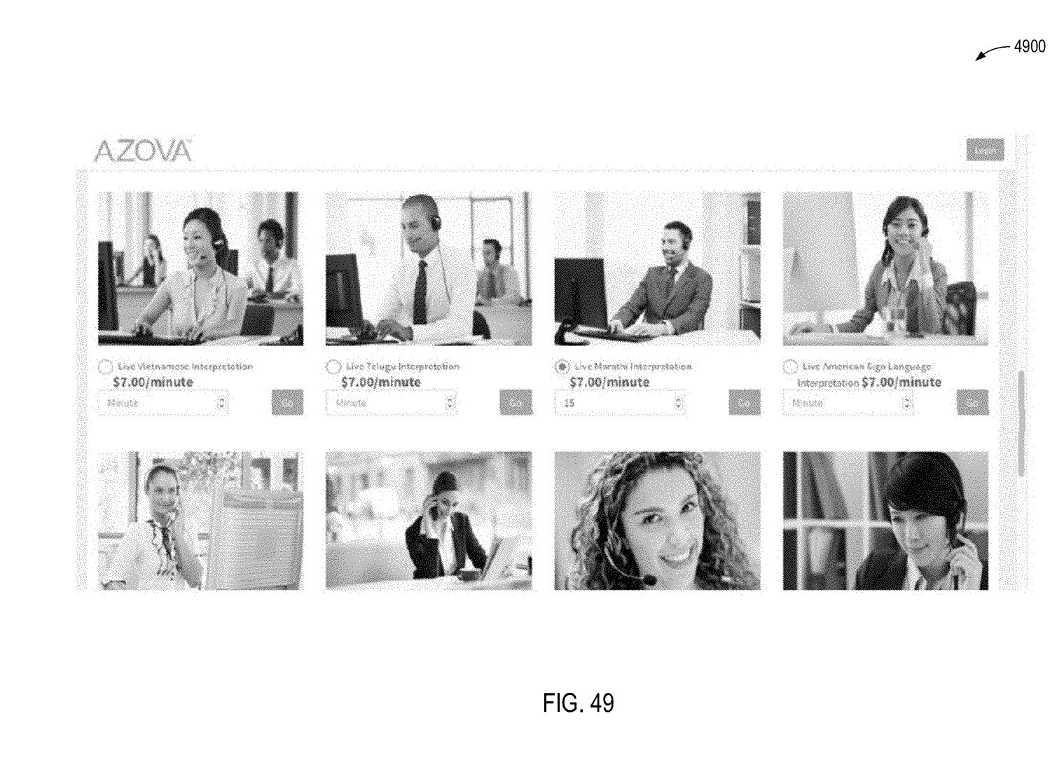

FIG. 49 illustrates another graphical user interface 4900 of a consultation sourcing system for selecting a consultation language and time, according to various embodiments. The user may interact with the interface by selecting a radio button and entering a time and/or a maximum time associated with a flat fee. After this is entered if the user selects “Go,” an appointment request would be added to the appropriate queue and/or a real-time connection may be made with the selected service.

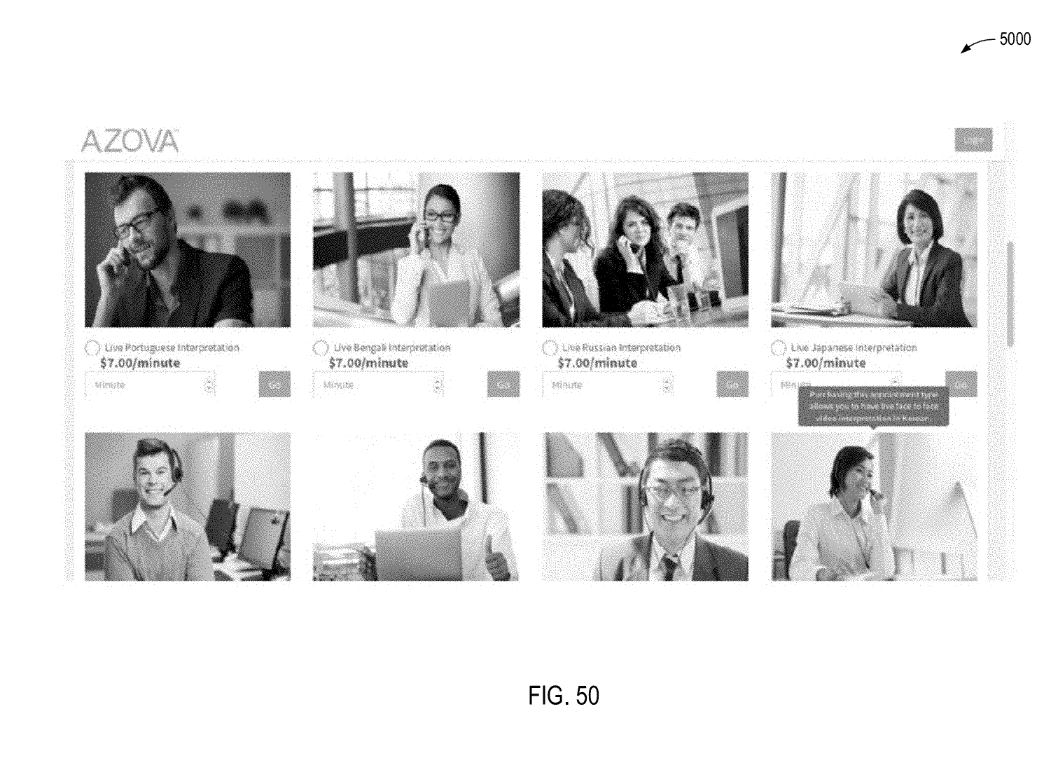

FIG. 50 illustrates additional options via graphical user interface 5000 of a consultation sourcing system for selecting a consultation language and time, according to various embodiments. In various embodiments, the user may hover over an icon on the interface and be presented with more information. Selection of an icon, pictures, or description may provide further information. The service options may be grouped into categories, as illustrated

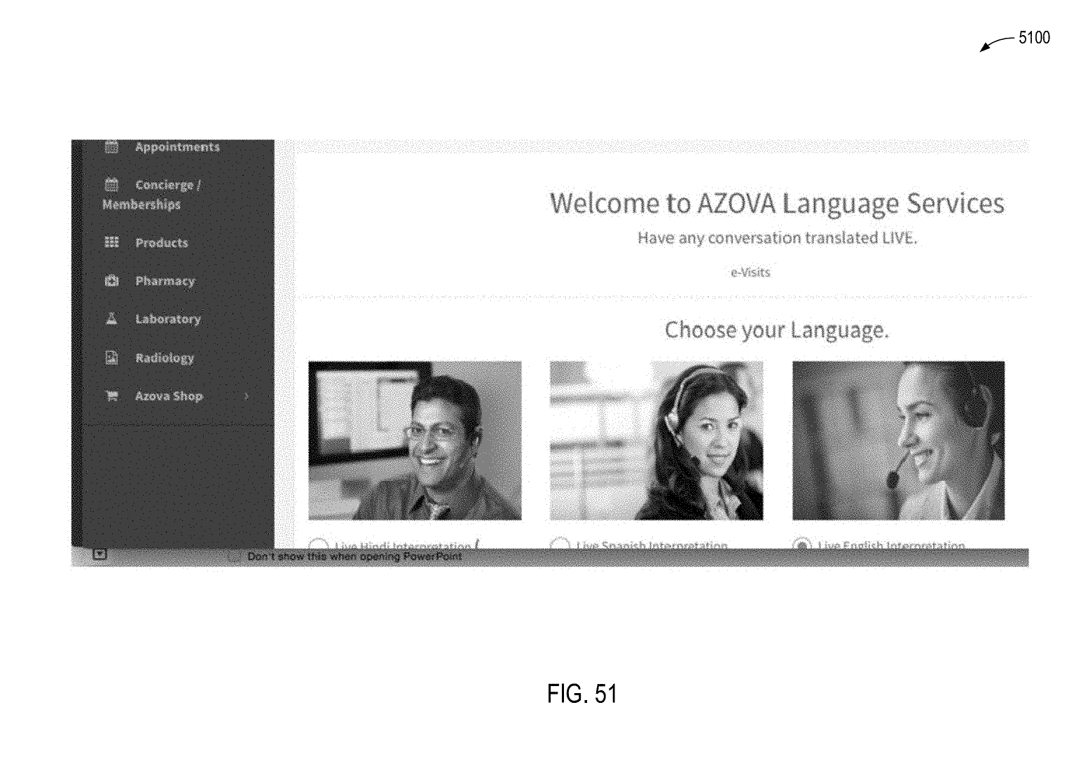

FIG. 51 illustrates another graphical user interface 5100 of a consultation sourcing system for menu navigation of categories of health services available for interpretations, according to various embodiments. The user may navigate to different categories through a quick link menu. Categories may include products, pharmacy, laboratory, radiology, interpretations, and more. Links to Azova Shop or AzovaShop, as described herein may be available as well.

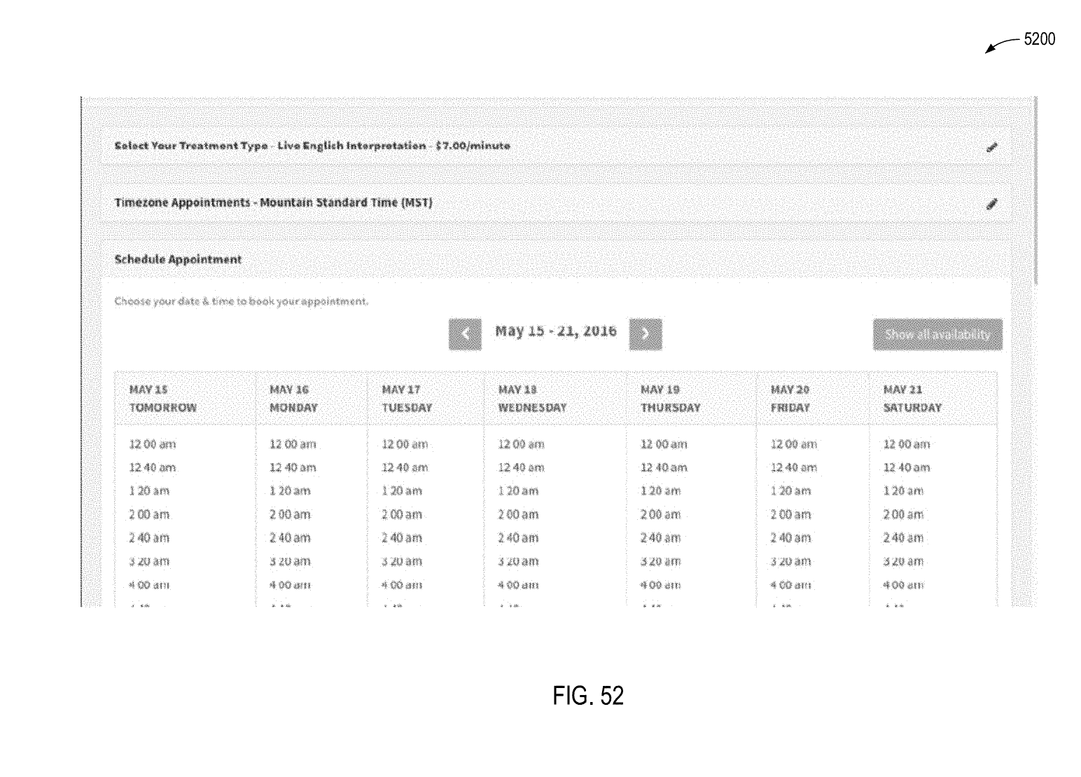

FIG. 52 illustrates an appointment scheduler interface 5200 for a consultation sourcing system, according to various embodiments. After a user selects a service option, the system may show the available times for that service. The system may do this by finding all of the staff members with the necessary staff type and check their schedules.

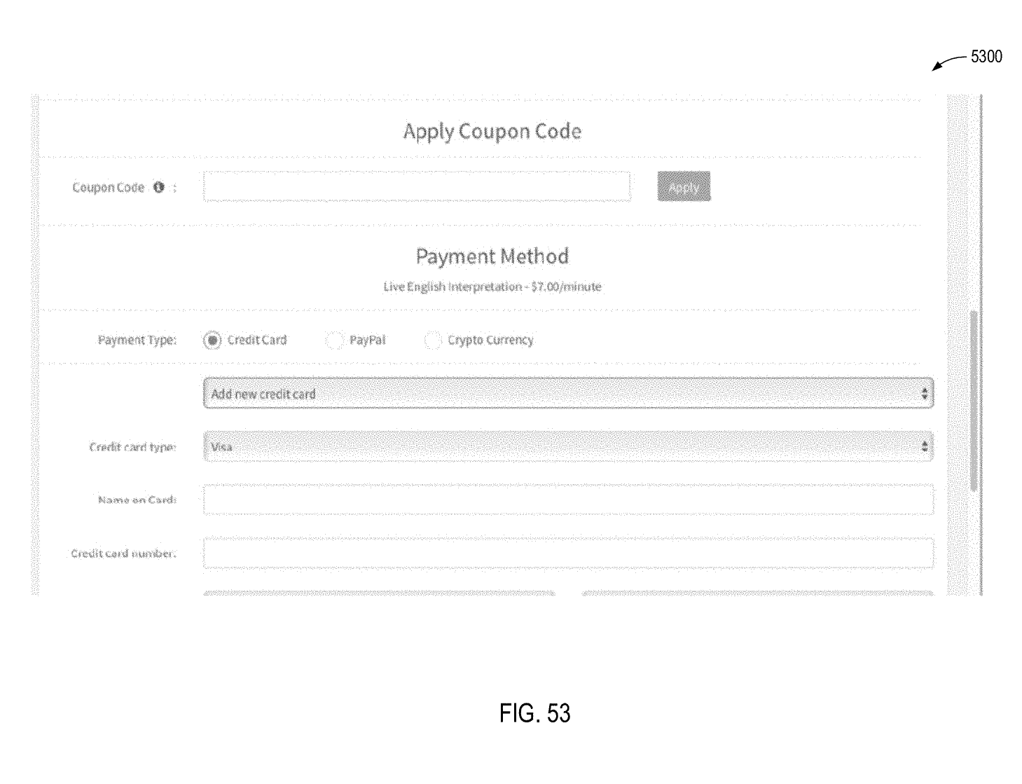

FIG. 53 illustrates an interface 5300 for a secure payment system of a consultation sourcing system, according to various embodiments. The system may require that the user pay in advance. In such an embodiment, the user may be presented with the secure payment system shown. As shown, the system may accept coupons, credit, PayPal, or other online currencies, including currencies such as Bitcoin and other cryptographic currencies.

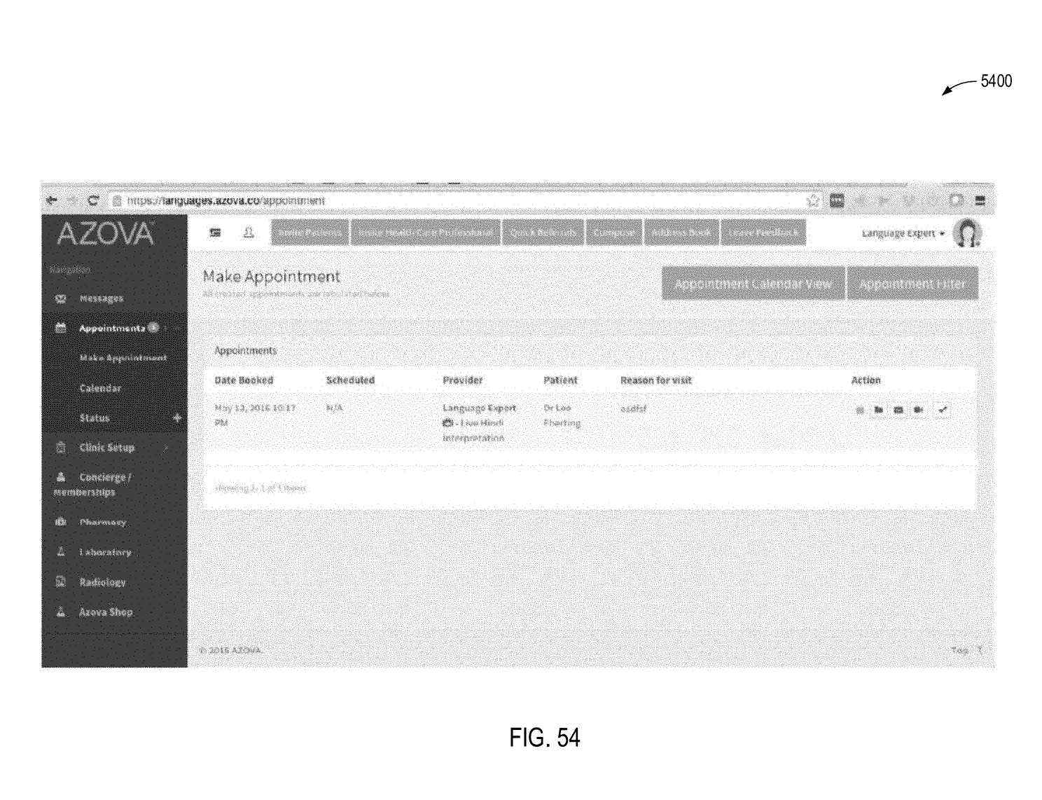

FIG. 54 illustrates a user calendar interface 5400 for a consultation sourcing system, according to various embodiments. The user calendar may include a list of booked appointments and options to change or cancel them. The appointments may be filtered on different aspects.

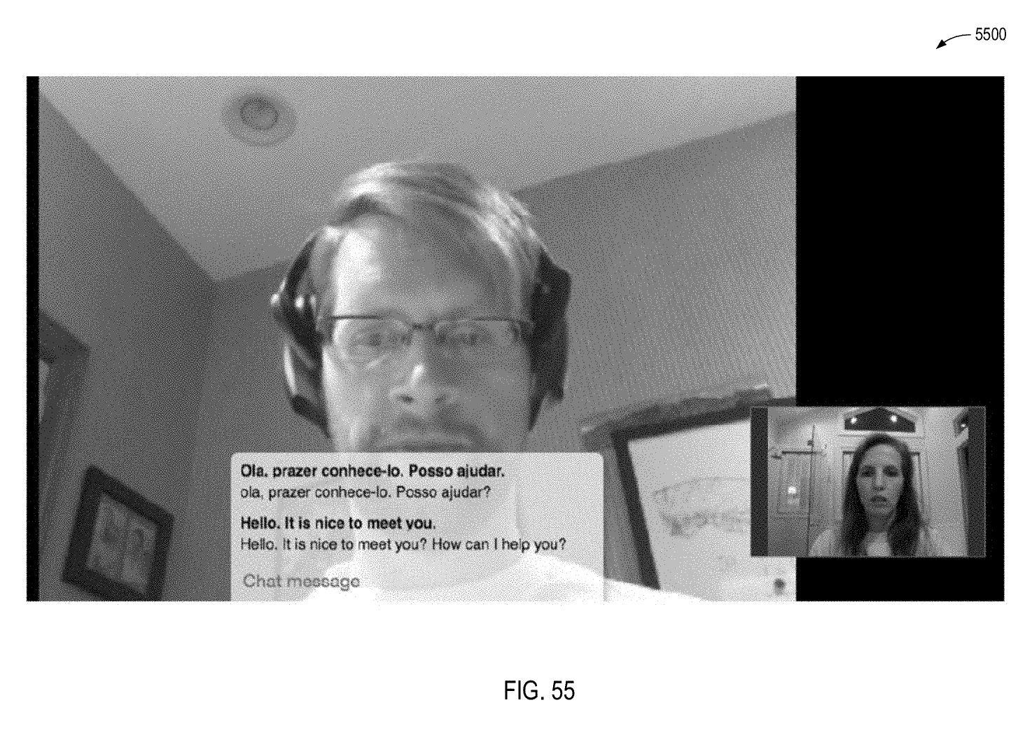

FIG. 55 illustrates a live translation service 5500 using a consultation sourcing system. As shown, the consultation sourcing system may be used for live face-to-face video interpretation. The user may be attempting to video conference with someone speaking another language. A staff member for the consultation sourcing system may provide a text translation over the video feed to assist in the video conference.

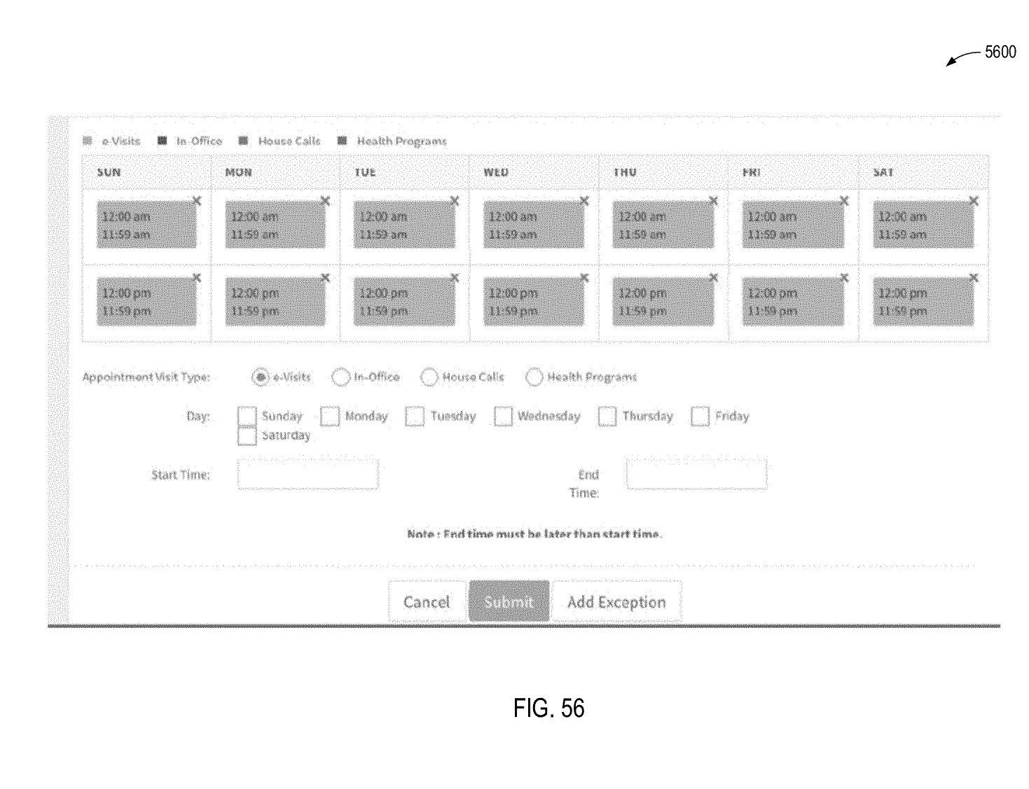

FIG. 56 illustrates a staff member schedule 5600 for a consultation sourcing system, according to various embodiments. A staff member may have the ability to set when he or she wants to work and where he or she wants to work. In some embodiments, this schedule may be edited at any time.

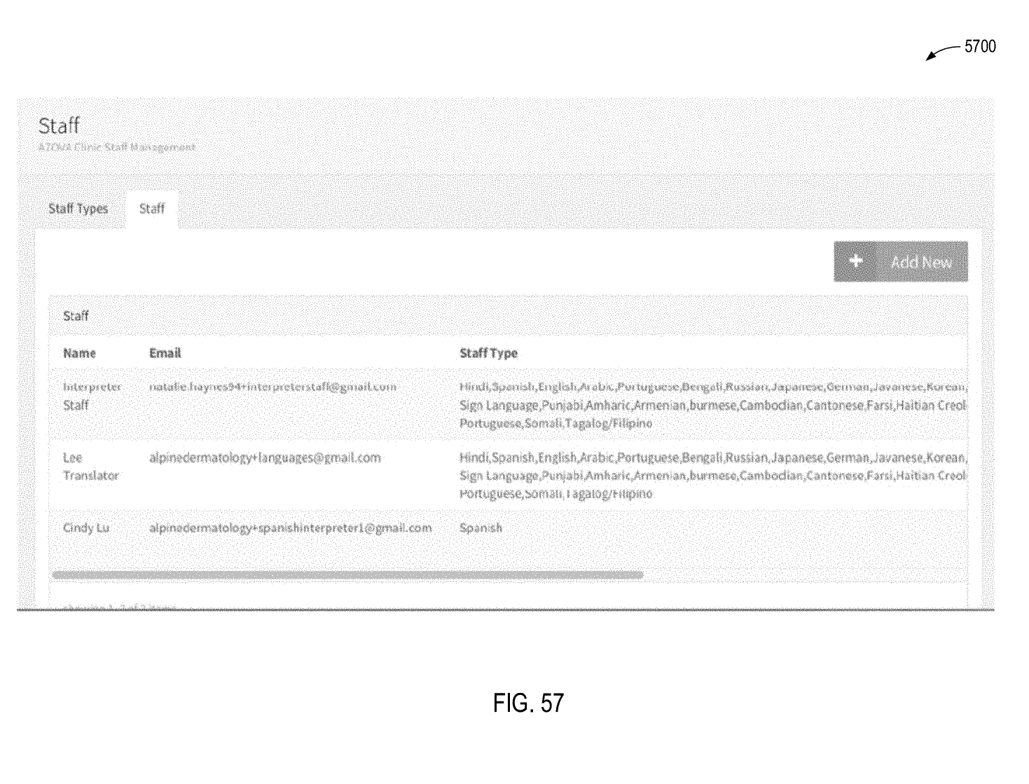

FIG. 57 illustrates a staff member view 5700 for a consultation sourcing system, according to various embodiments. As shown, the system may display information about all the current staff members. This includes name, contact information, and staff type.

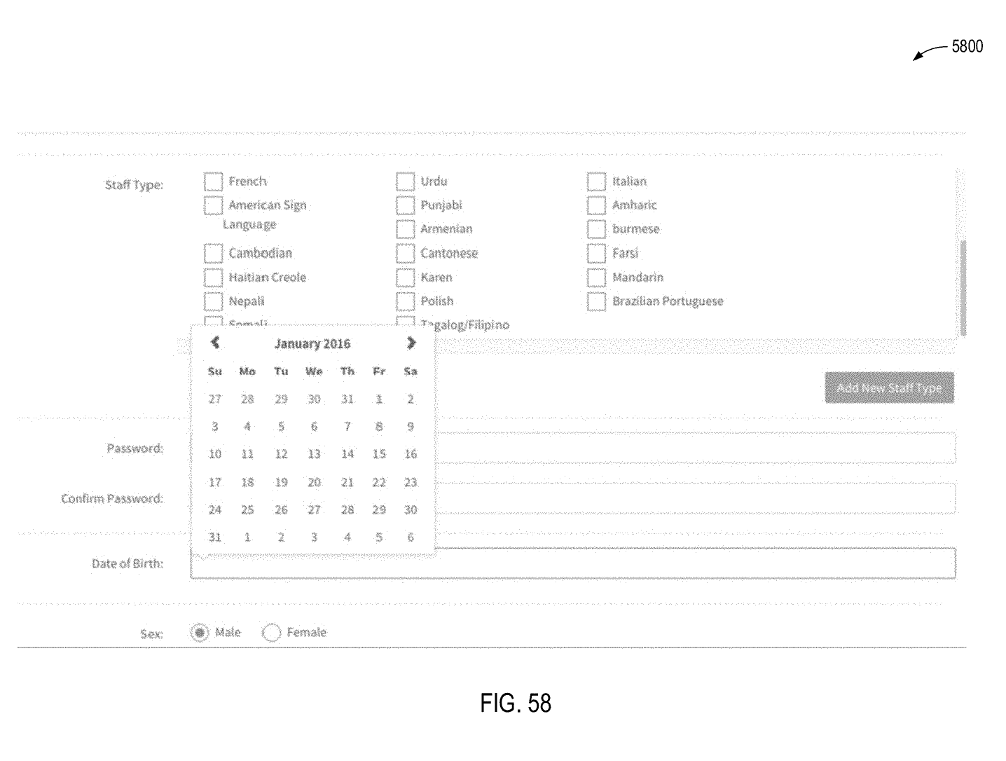

FIG. 58 illustrates an interface 5800 for a staff member profile generator, according to various embodiments. The staff member profile generator receives the credentials of a staff member to create an initial profile.

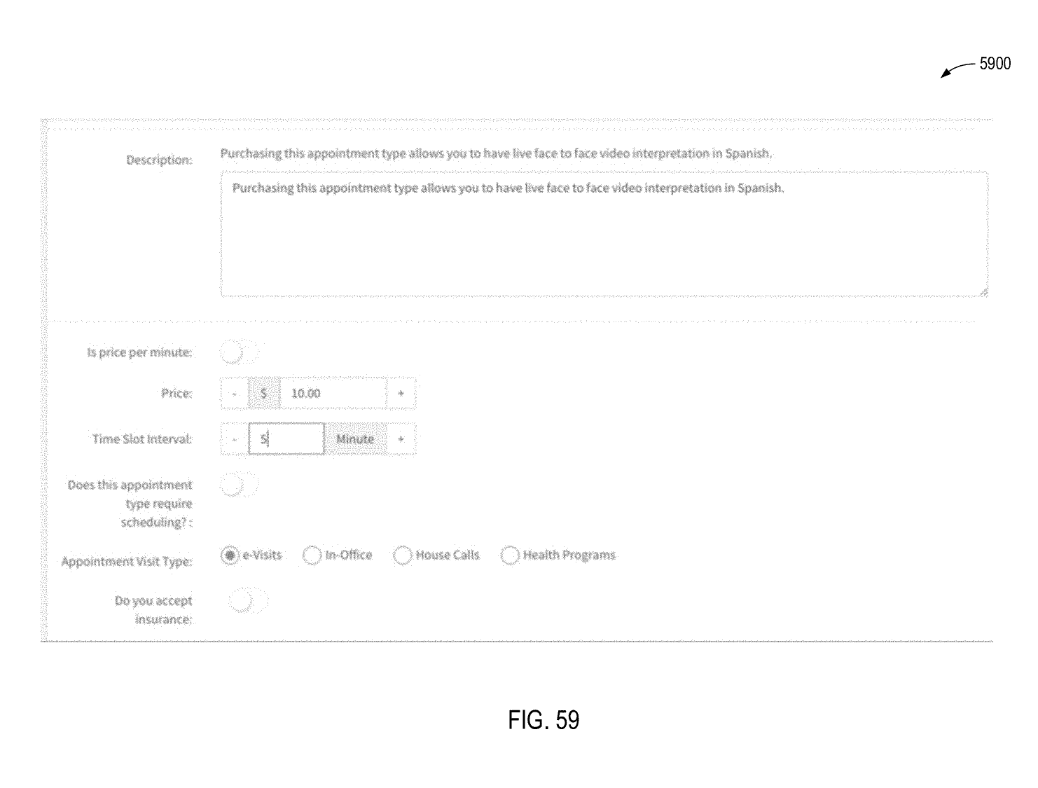

FIG. 59 illustrates additional features of a staff member profile generator 5900, according to various embodiments. As illustrated, a staff member may set a price (in various currencies, for time slot intervals. For instance, the staff member may charge $50 per hour, with a minimum charge of one hour, or may set a price of $10 per five minutes. The staff member may decide, for each described appointment type, whether he or she desires to require advanced scheduling or allow for real-time on-demand services (when online or available).

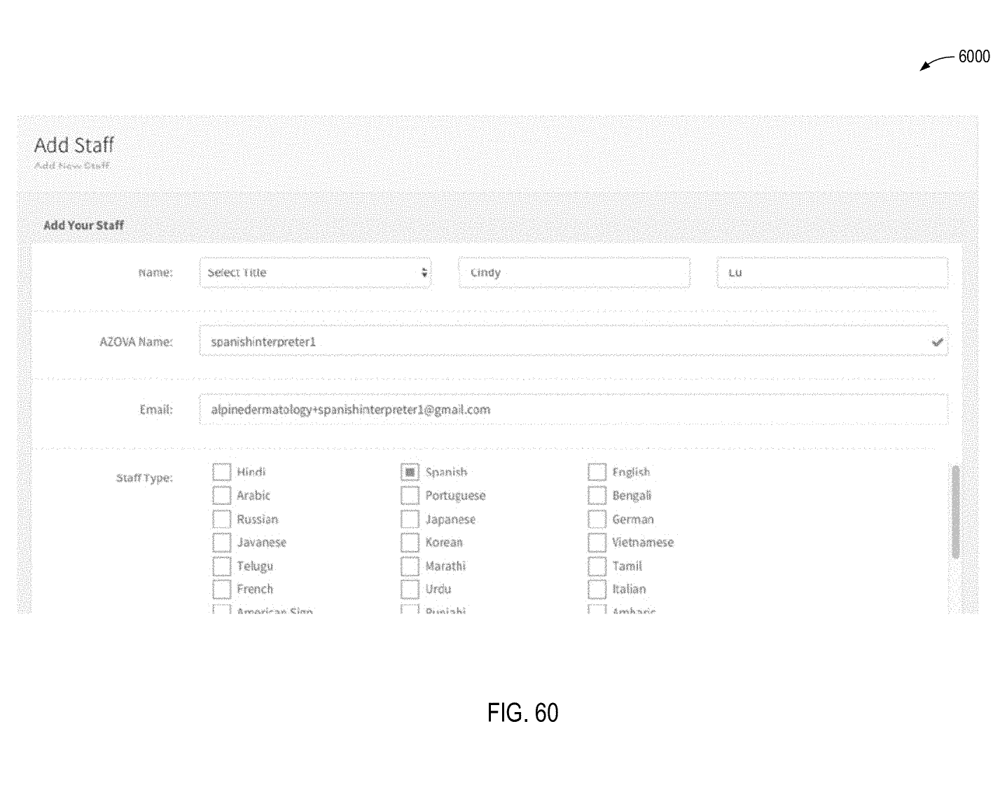

FIG. 60 illustrates additional features of a staff member profile generator 6000, according to various embodiments. As illustrated, radio buttons may be used to select a variety of languages that the staff members is able to speak/translate.

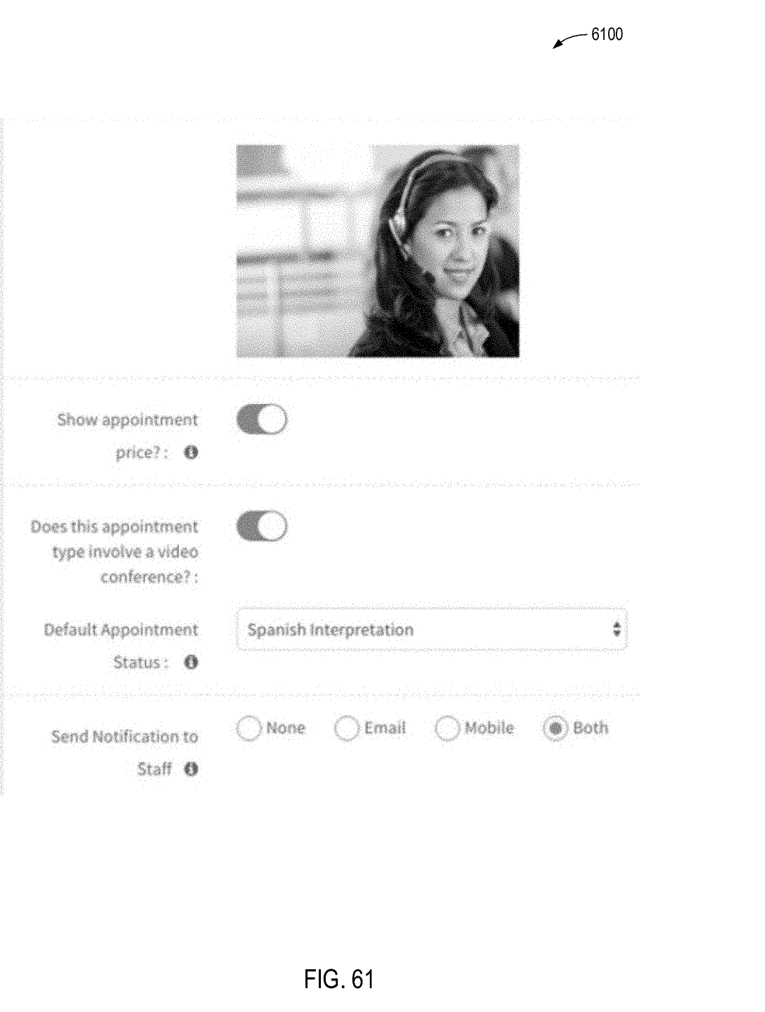

FIG. 61 illustrates additional features of a staff member profile generator 6100, according to various embodiments. As illustrated, the staff member may configure various settings. In some embodiments, independent contractors may have more or different options than employees who may be required to provide specific services and/or have specific availabilities.

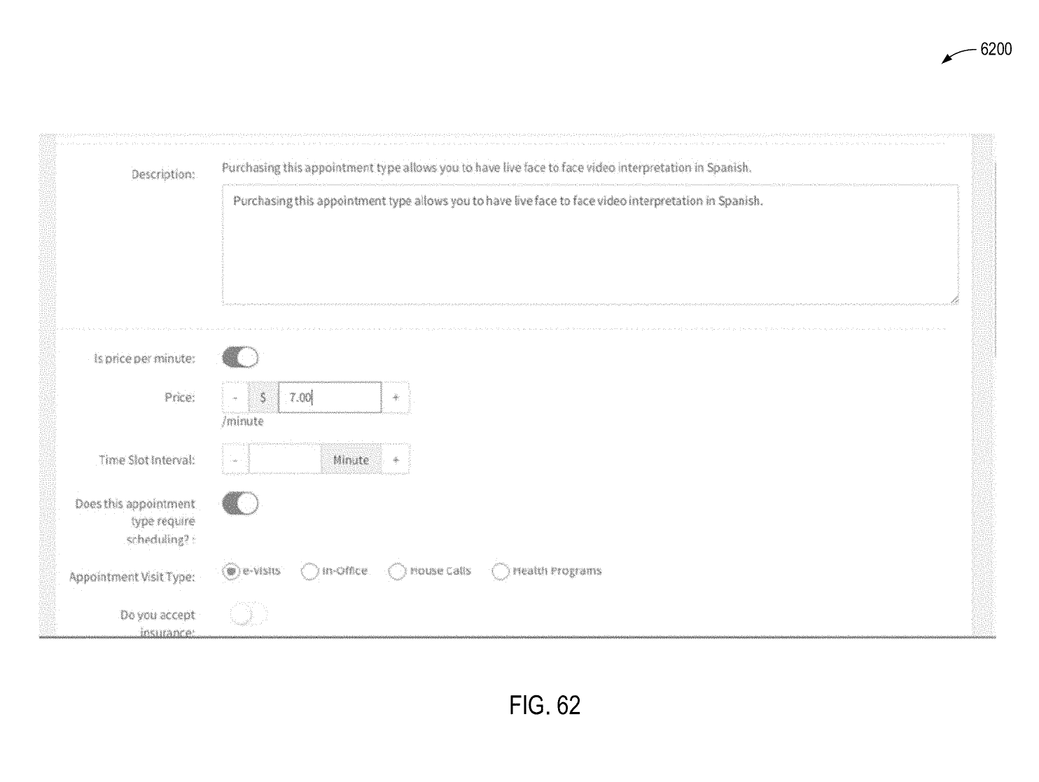

FIG. 62 illustrates additional features of a staff member profile generator 6200, according to various embodiments. As shown above, in FIGS. 59-62, various options, features, and availability settings may be customizable, include language skills, price, the amount of time allocated for a time slot, service location, contact information, and contact preference.

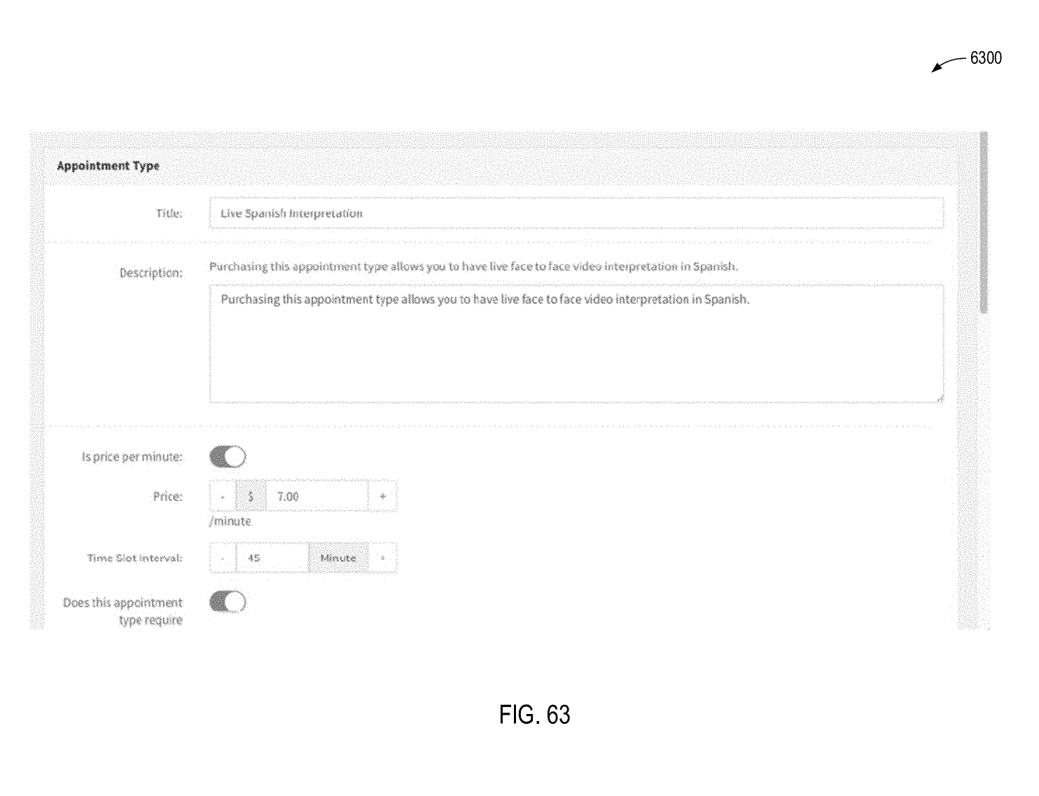

FIG. 63 illustrates an interface 6300 for creating an appointment, according to various embodiments. As illustrated, a user may select a “Live Spanish Interpretation,” as described. A price may be set per minute and an expected duration may be selected.

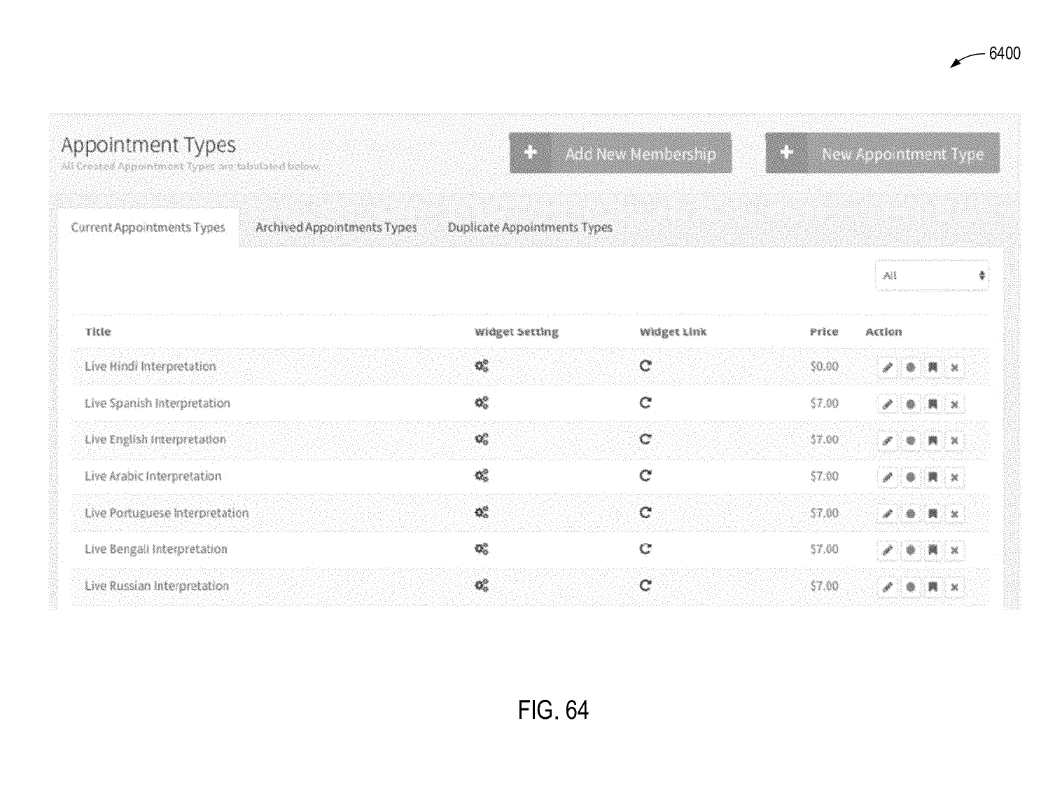

FIG. 64 illustrate a first portion of an interface 6400 for an appointment-type editor, according to various embodiments. A company or manager of various appointment types (such as multiple language translations) may be able to configure various global settings, widget settings, widget links, and the like.

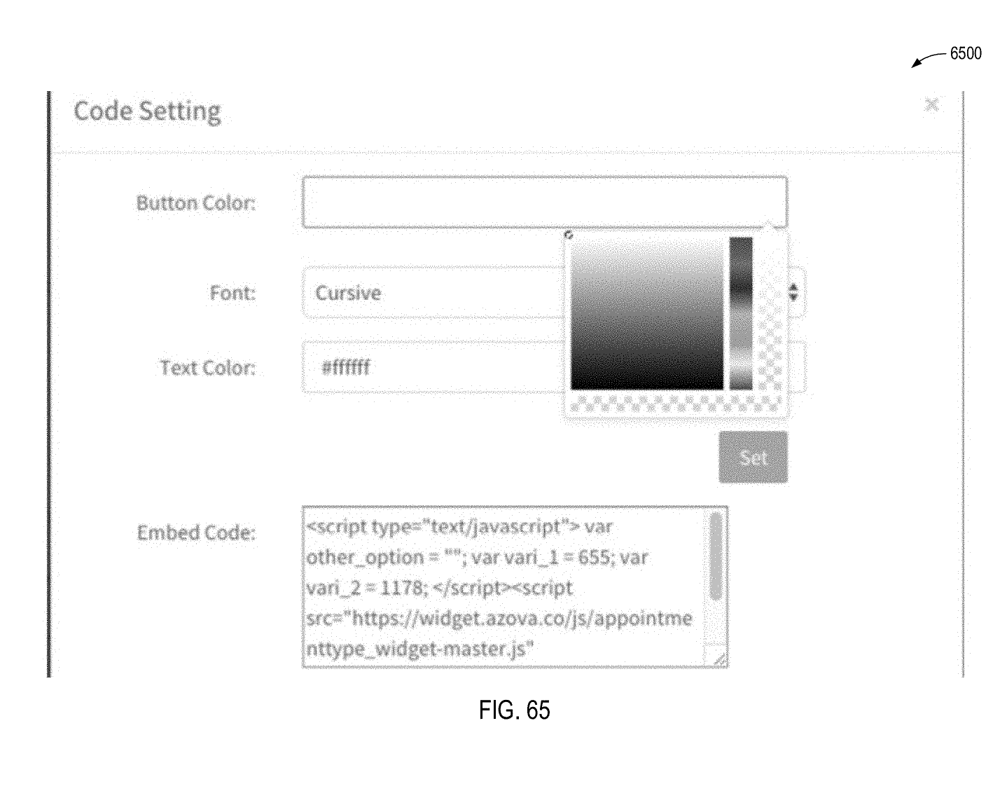

FIG. 65 illustrate another portion of an interface 6500 for an appointment-type editor, according to various embodiments. As illustrated, third party staff members, companies, managers, or the like may have very specific control of how their services are presented. In the illustrated embodiments, even details such as colors, fonts, text, and the like may be customized by a wide variety of entities.

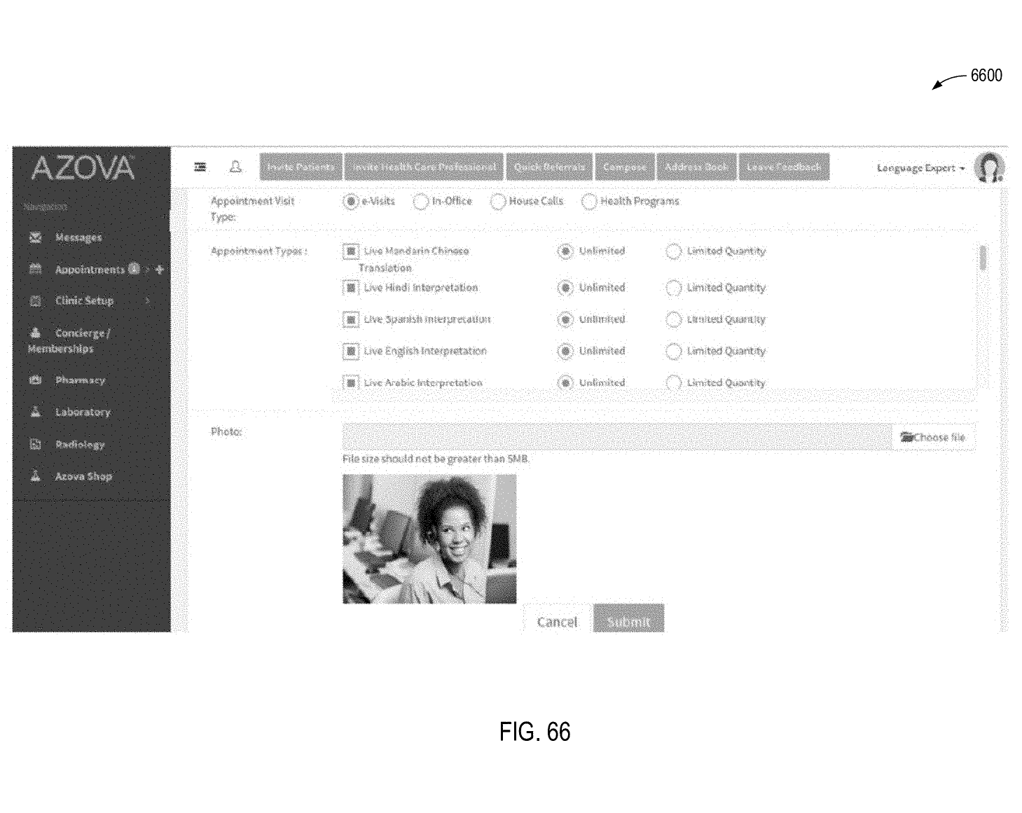

FIG. 66 illustrate another portion of an interface 6600 for an appointment-type editor and the selection of various services, according to various embodiments. For example, the “Language expert” user may provide only e-visits, or may select additional radio buttons for other appointment visit types. Similar selections for various languages may be made below that and profile pictures may also be uploaded to provide comfort and familiarity to the user/patient.

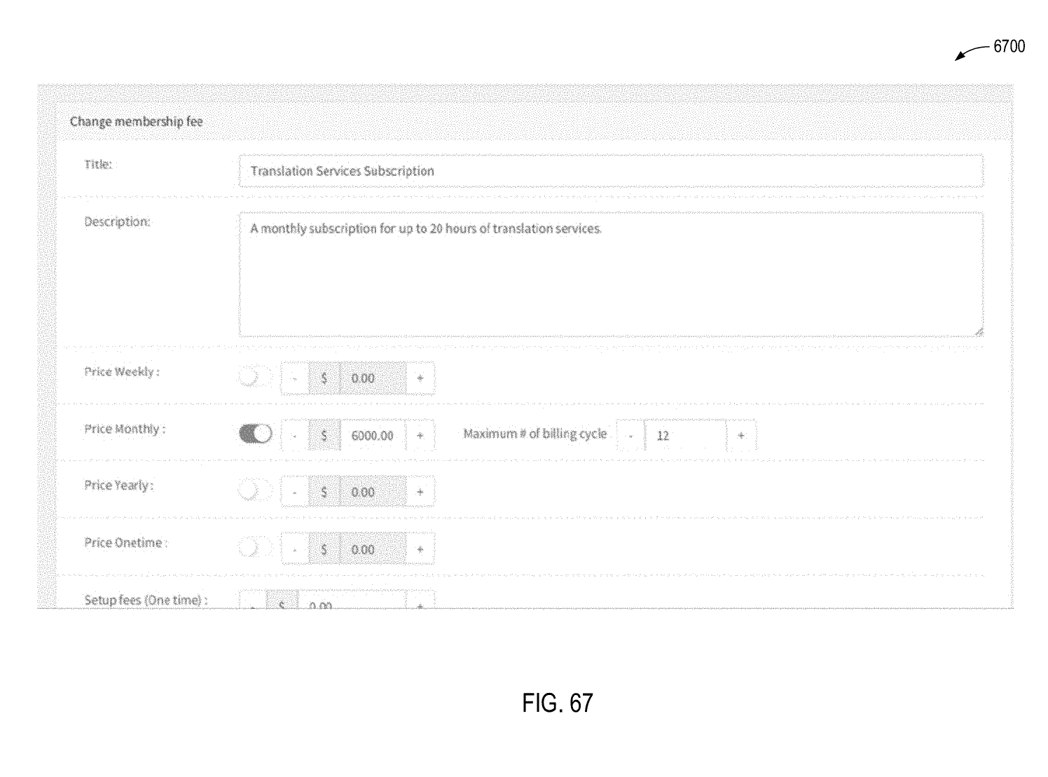

FIG. 67 illustrates a consultation sourcing system 6700 using a membership. As shown, the membership may be set to a weekly, monthly, yearly, or onetime price. In one embodiment, the customer may be charged an additional fee for certain services even with a membership.

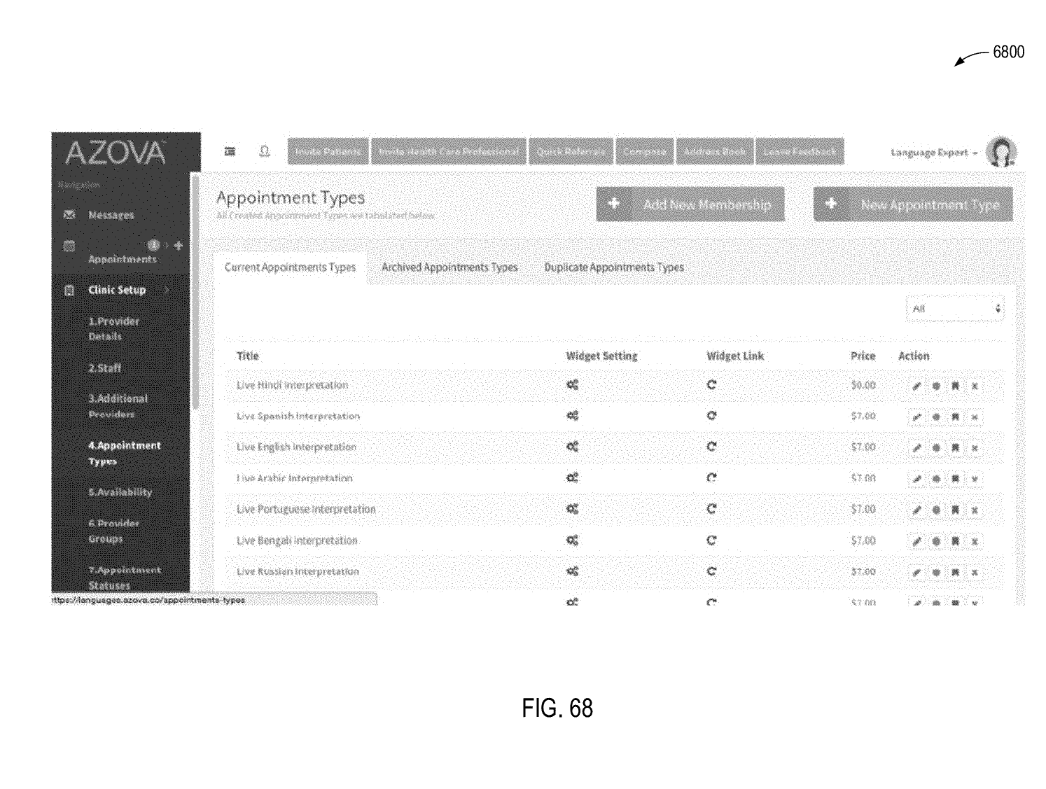

FIG. 68 illustrates menu navigation interface 6800 for a consultation sourcing system. As shown, the system may have a menu to help a person maintaining a consultation sourcing system navigate.

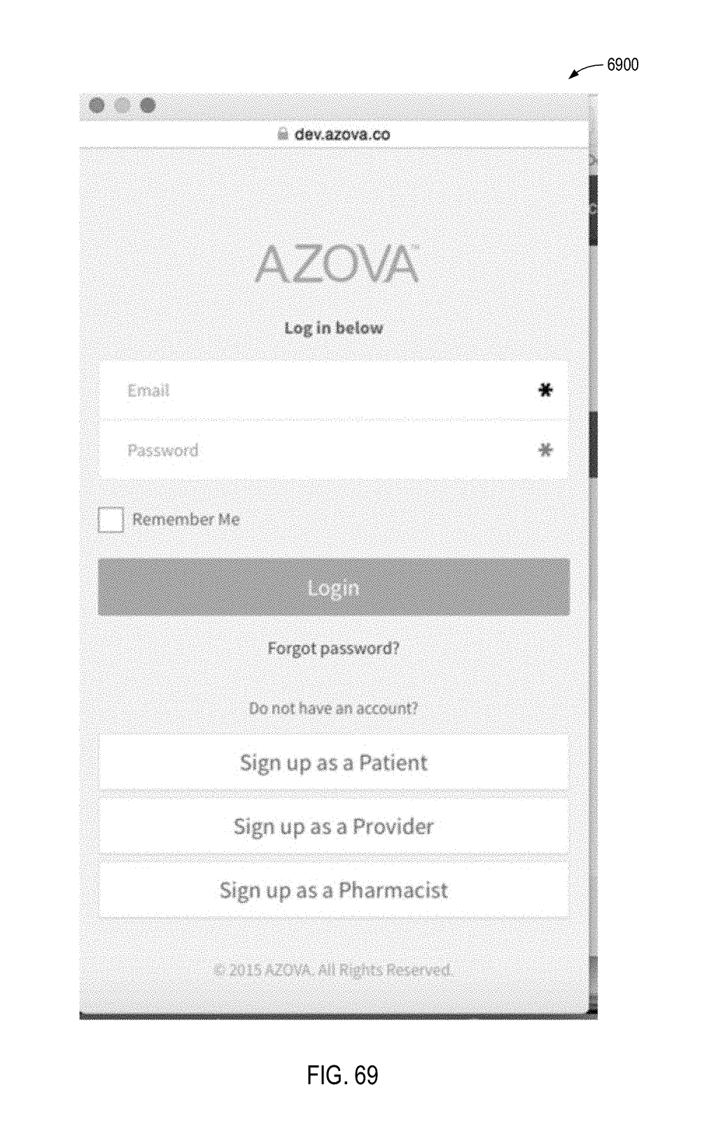

FIG. 69 illustrates a mobile login interface 6900 for a consultation sourcing system. As shown, the log in can be used by various people in different positions. For example, as shown a person may be logged in as a patient, provider, or pharmacist. Depending on how the person is logged in, different options may be presented.

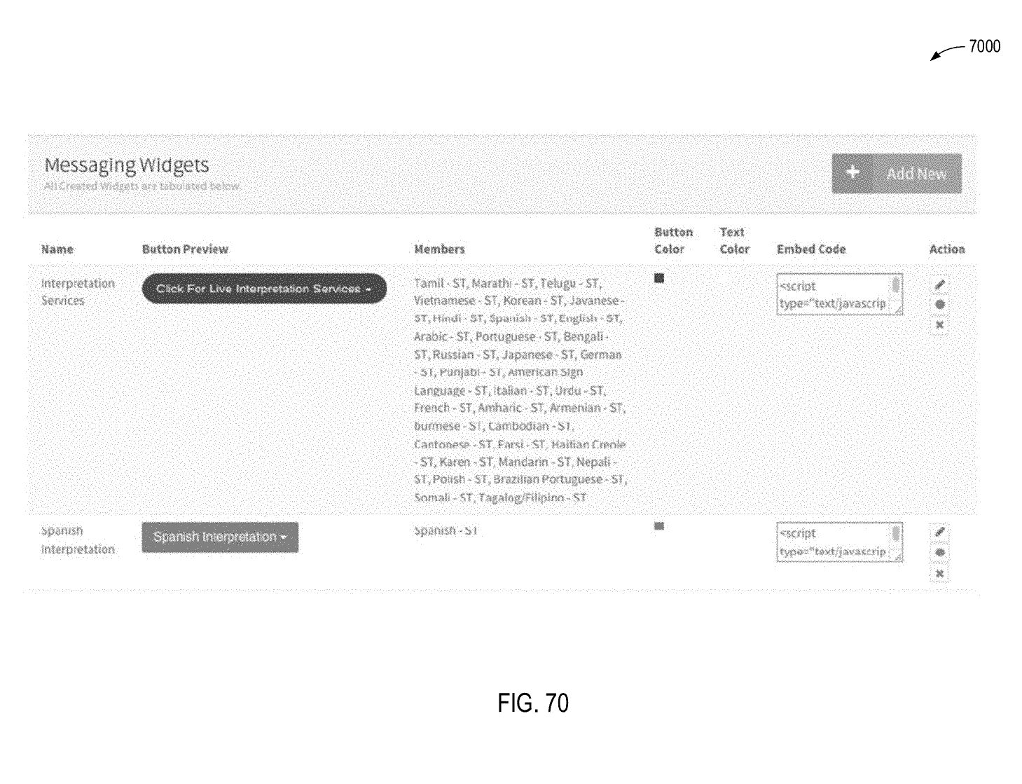

FIG. 70 illustrates a first portion of a widget creation interface 7000 for a consultation sourcing system. New widgets may be added using the “Add New” icon on the top right.

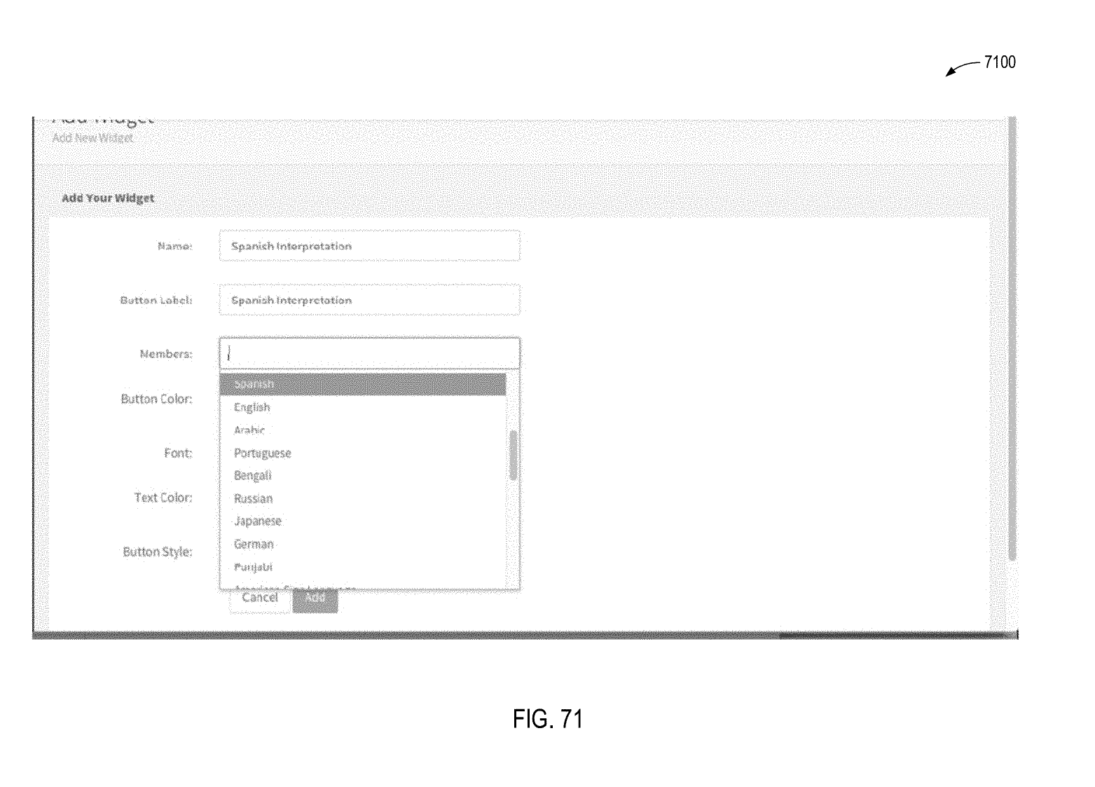

FIG. 71 illustrates a second portion of a widget creation interface 7100 for a consultation sourcing system. A widget provides a link to certain services. A widget may be incorporated into various website designs and may be edited using the widget creator.

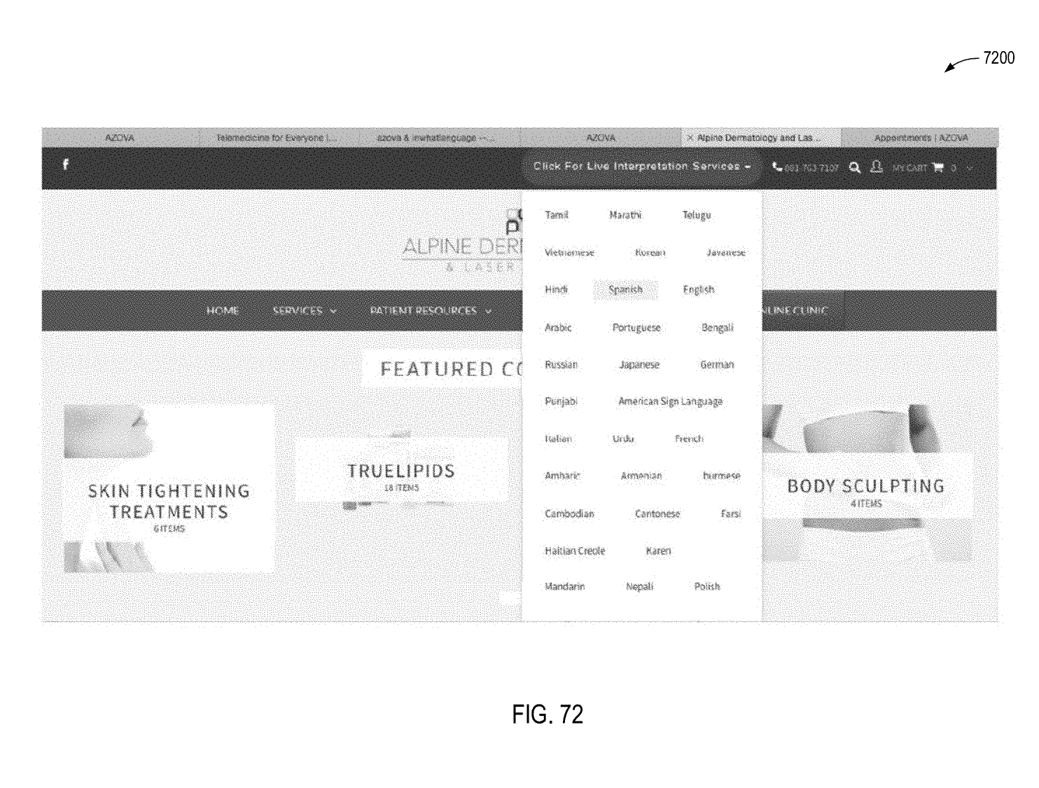

FIG. 72 illustrates a consultation sourcing widget incorporated into a website 7200. As shown, the widget may be embedded in a website overlaying the original website when selected. In another embodiment, any user interaction would send the user to another site.

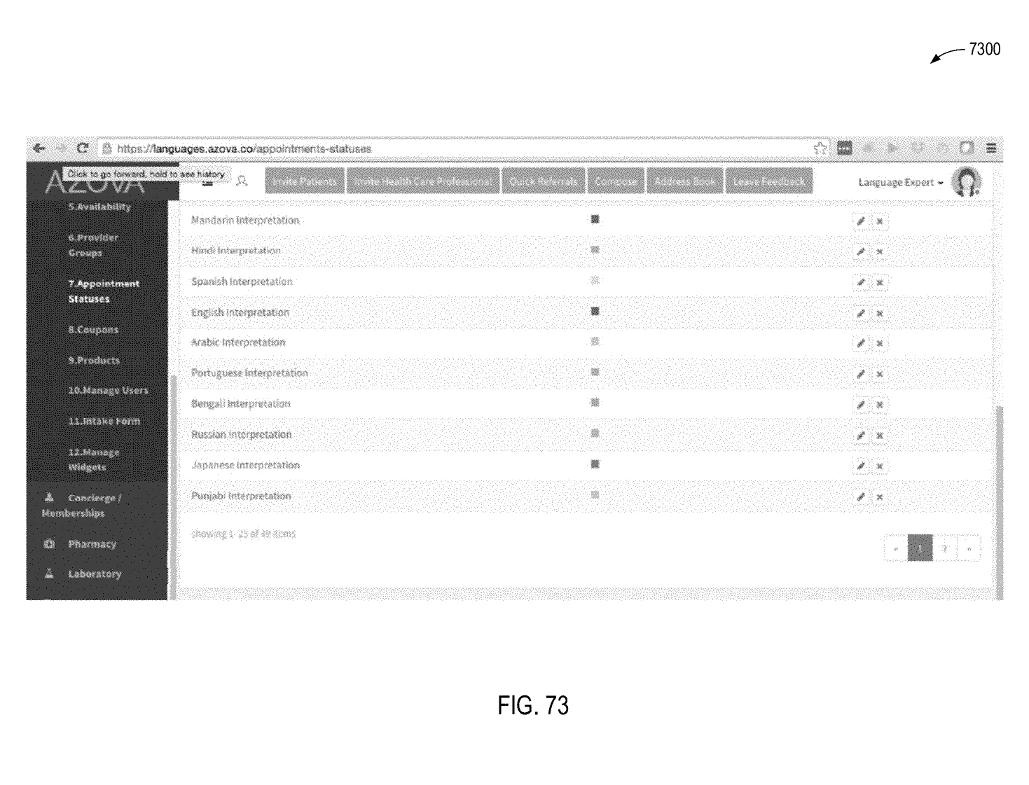

FIG. 73 illustrates an appointment status interface 7300 for a consultation sourcing system. This interface may allow a person maintaining a consultation sourcing system to see what services are offered in a widget and edit them.

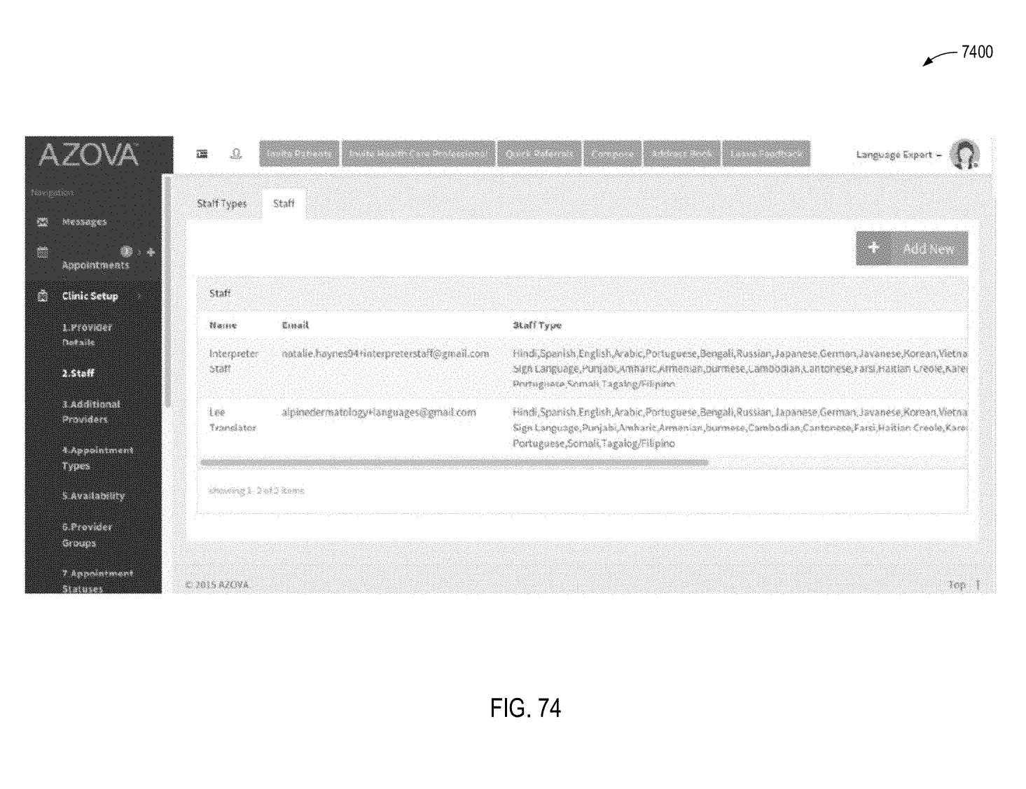

FIG. 74 illustrates a staff information interface 7400 for a consultation sourcing system. This interface may provide quick access to information about available staff members. As illustrated, a person maintaining a consultation sourcing system may navigate efficiently using the side menu.

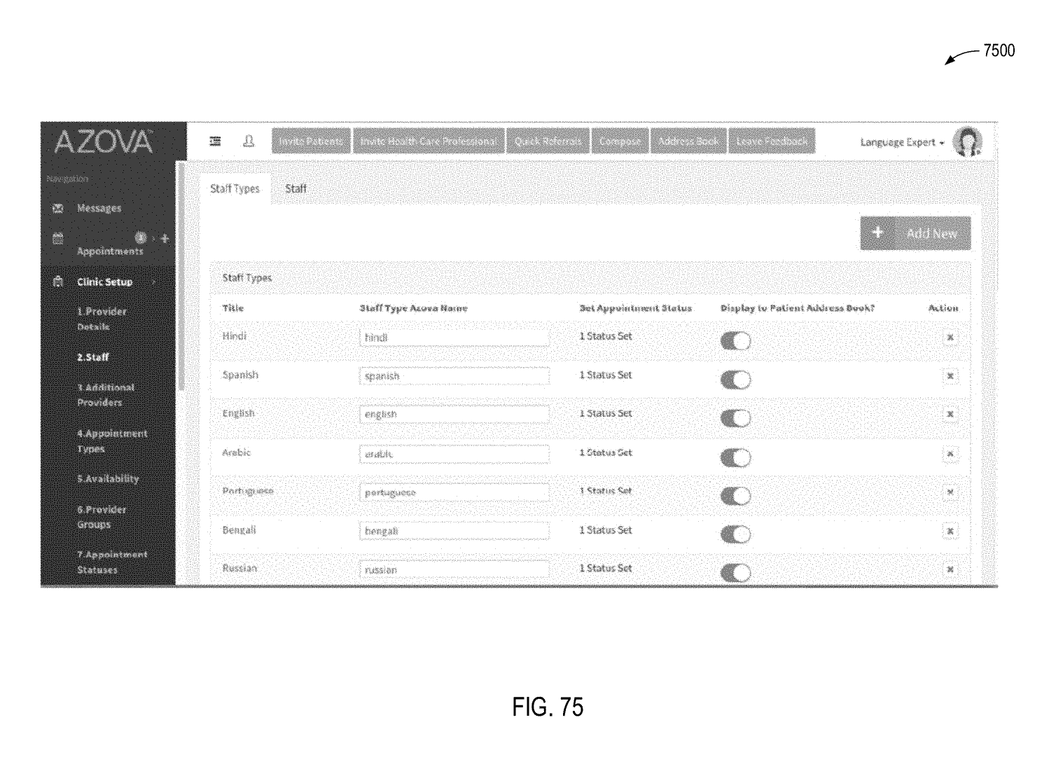

FIG. 75 illustrates a staff-type interface 7500 for a consultation sourcing system. This interface may provide quick access to information about available staff types. As illustrated, a person maintaining a consultation sourcing system may navigate efficiently using the side menu.

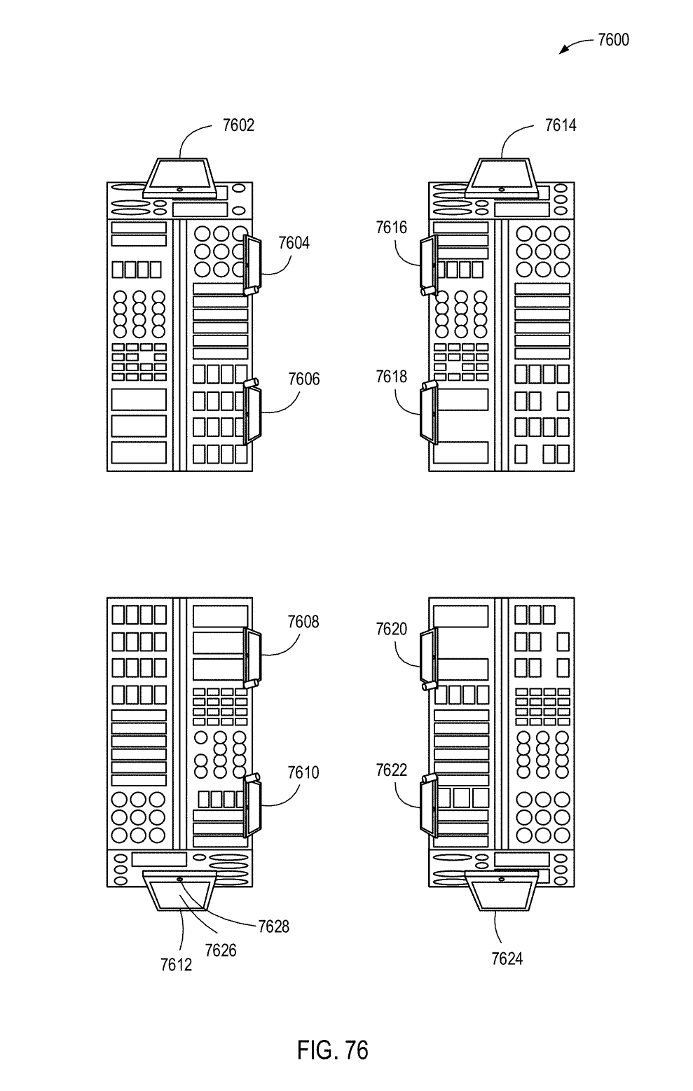

FIG. 76 illustrates a virtual sales support system 7600 installed in a store, according to various embodiments. As shown, the sales support system 7600 may include a plurality of sales support devices (e.g., 7602-7624) at a plurality of distinct physical locations.

The sales support devices may be part of one network referred to as a sales support network. Sales support devices at other stores may be included in the sales support network. A remote representative may have access to the sales support network and may be able to control the sales support devices. The remote representative may transfer from sales support device to sales support device, or the remote representative may broadcast on multiple sales support devices simultaneously.

As previously described above beginning in paragraph [00216], a remote representative may interact with a customer via the sales support devices. For example, the remote representative may answer skin care questions for a customer and direct the customer to purchase a certain product. Alternatively, the remote representative may demonstrate the use of a skin care product. The customer may hear the representative over a speaker and view the remote representative via a screen 7626 on a sales support device 7612. Similarly, the remote representative may hear and see the customer via a microphone and camera 7628 on the sales support device 7612.

The sales support devices may be manufacturer specific or multiple manufactures may use the same sales support device. In one embodiment, a store may own a sales support device and the store may configure the sales support device to interact with a plurality of manufacturers, and/or store staff. In such an embodiment, a customer may have the option to select the manufacturer or staff that he wants to interact with.

The sales support devices may be located throughout a store. For example, some sales support devices may be located on endcaps while other sales support devices may be located in an aisle. The location of the sales support device system may influence what is displayed on the sales support device. For example, a sales support device located at the end of a toy aisle may represent different manufacturers than a sales support device located on a cooking aisle.

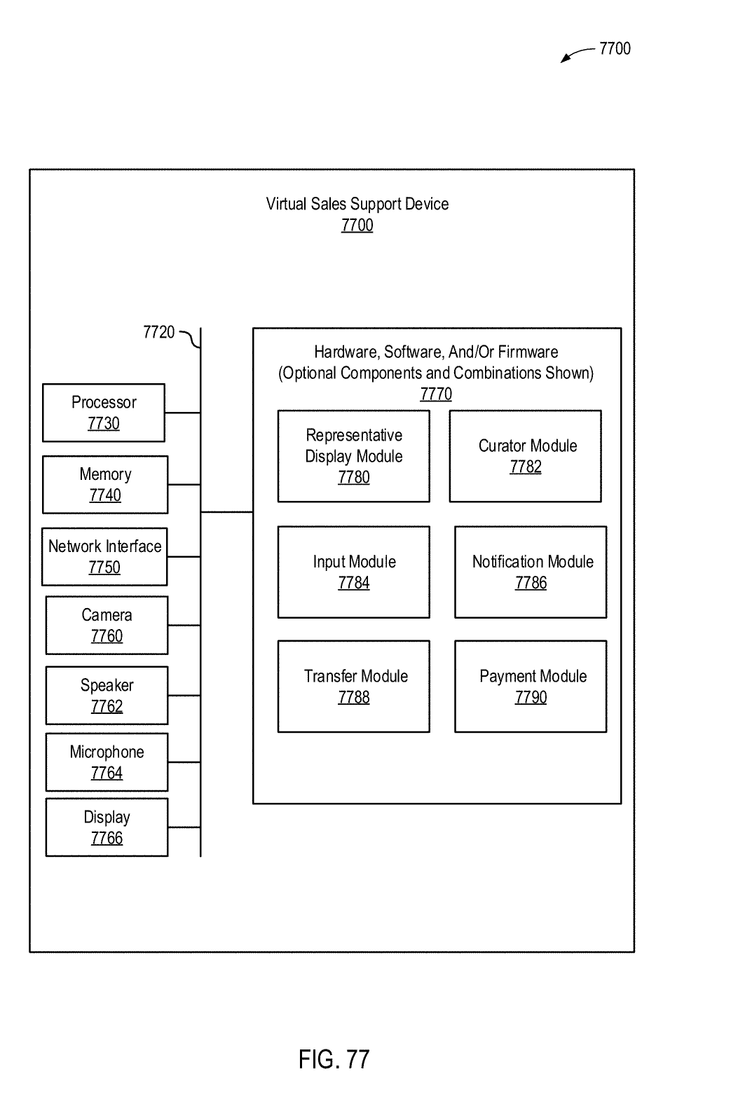

FIG. 77 illustrates a block diagram of a virtual sales support device 7700 according to various embodiments. As shown, the virtual sales support device 7700 may include a processor 7730, memory 7740, a network interface 7750, camera 7760, speaker, 7762, microphone 7764, display 7766, and other optional components 7770. A bus 7720 may interconnect various integrated and/or discrete components. Various modules (e.g., modules 7780, 7782, 7784, 7786, 7788, 7790) may be implemented in hardware, software, firmware, and/or a combination thereof.

A curator module 7782 may organize a plurality of manufacturer icons. The manufacturer icons may represent a plurality of manufacturers. The curator module 7782 may organize the manufacturer icons based on the physical surroundings of the virtual sales support device such as location, surrounding products, time, availability of products. The curator module 7782 may also base the organization on sponsored brands, and the availability of representatives for each manufacturer. A representative display module 7780 may present to a customer the organized manufacturer icons.

An input module 7784 may receive input from the customer. This input may represent the manufacturer that the customer wants to interact with, and/or a specific question. The input may be physically entered or entered via voice commands. A notification module 7786 may then send a notice to a manufacturer based on the input. The notice may indicate that a customer desires to interact with a representative, and/or a specific question. If a representative is not available when a notice is received, a video of a product may be played.

A representative may control the sales support device 7700 through the network interface. The controlling representative may interact with a customer via the camera 7760, speaker 7762, microphone 7764, and display 7766.

A transfer module 7788 may allow the controlling representative to control another sales support device. The representative may control both sales support devices at one time. Alternatively, the representative may choose to stop controlling a first sales support device and start controlling a second sales support device. In some embodiments, the transfer module may be configured to transfer the representative to a customer's personal device.

A payment module 7790 may allow a customer to pay for a product. The payment module 7790 may also present add-ons such as warranties and installation support.

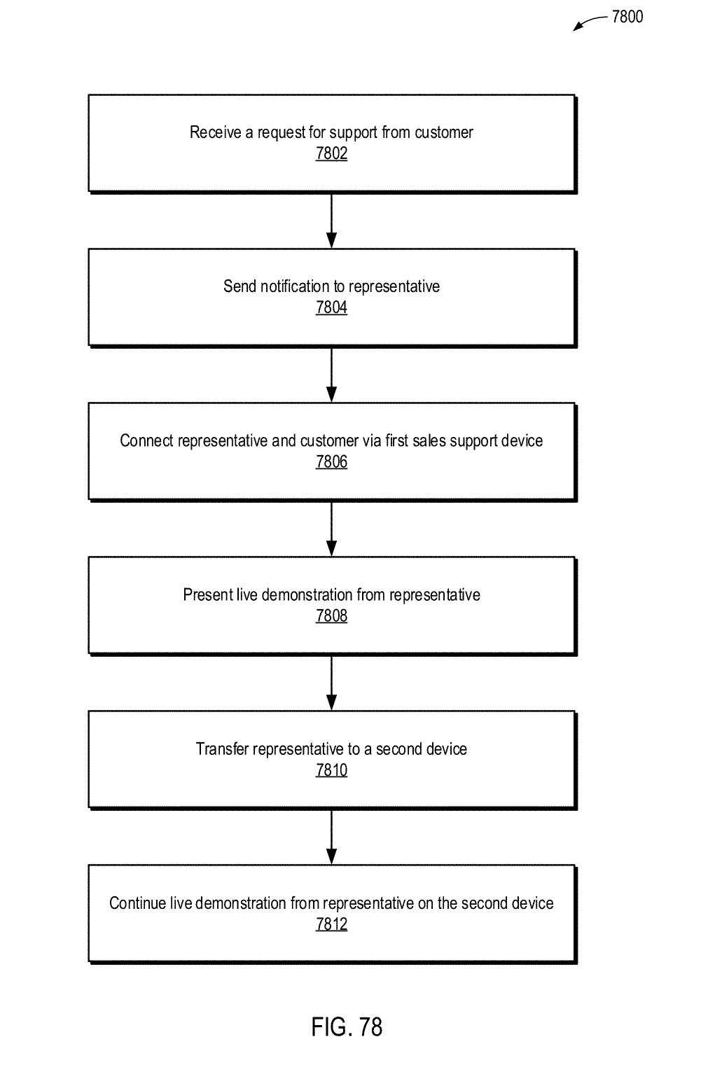

FIG. 78 illustrates a flow diagram 7800 of a method for providing virtual customer support, according to various embodiment. A sales support system may receive a request for support from a customer 7802. The sales support system may send a notification of the request for support to a representative 7804. the sales support system may connect the representative and customer via a first sales support device 7806. The first sales support device may present a live demonstration from the representative 7808. The sales support system may transfer the representative to a second device 7810. The second device may continue the live demonstration 7812.

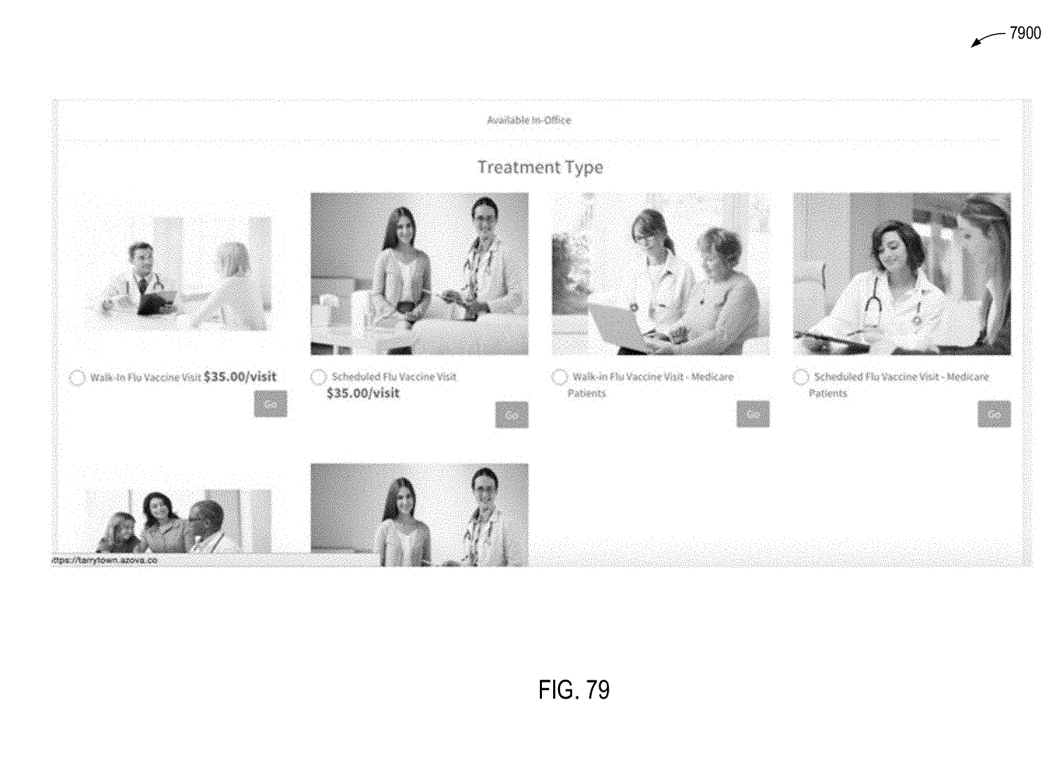

FIG. 79 illustrates a treatment type request page 7900 allowing a patient to select between various treatment types specifically relating to vaccines, according to various embodiments. A healthcare management system, such as Azova, may include an online vaccination management system (VMS) for scheduling vaccination visits, in-office/pharmacy patient registration for vaccines. The system may include inventory management to manage the stock of vaccines and reorder them as necessary.

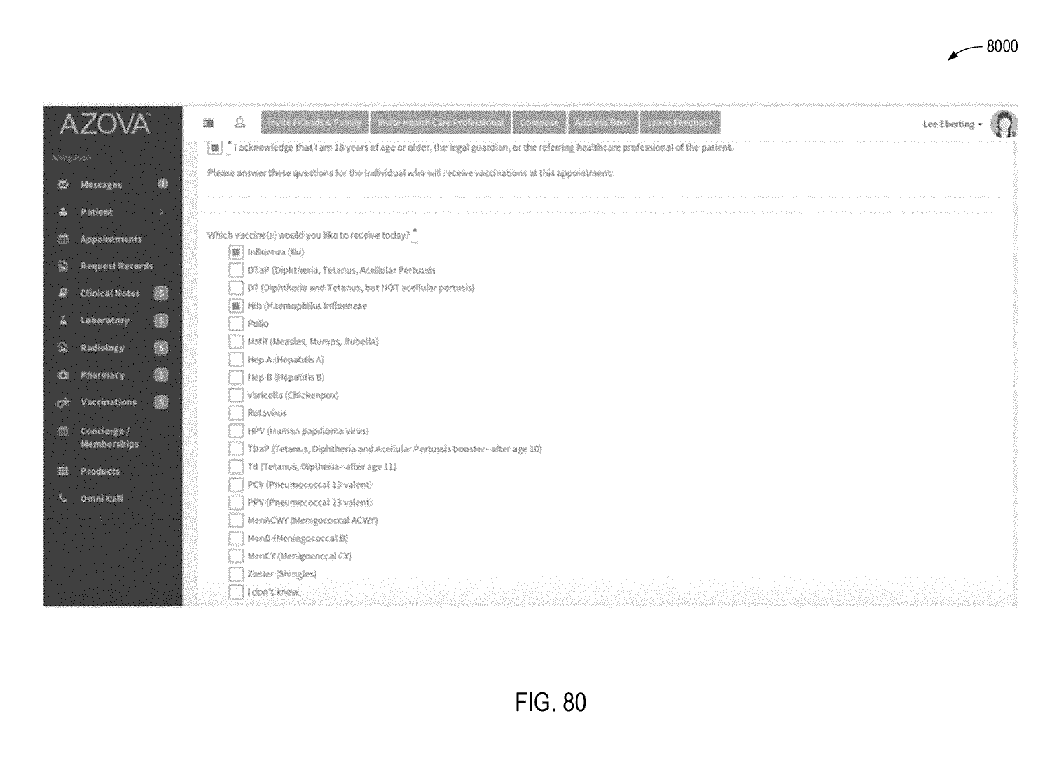

FIG. 80 illustrates a page 8000 for selecting the types of vaccines a patient would like to receive, according to various embodiments. The patient can select which vaccine(s) he/she would like to receive. The provider can track utilization on his/her analytics panel for precise inventory management decisions. Each vaccine type may be tied to its NDC (national drug code), its wholesale, retail price, and/or another price. The patient can choose which vaccines are wanted and the system can add up the cost of each vaccine and/or can run eligibility checks to determine if the patient's insurance will cover the vaccine.

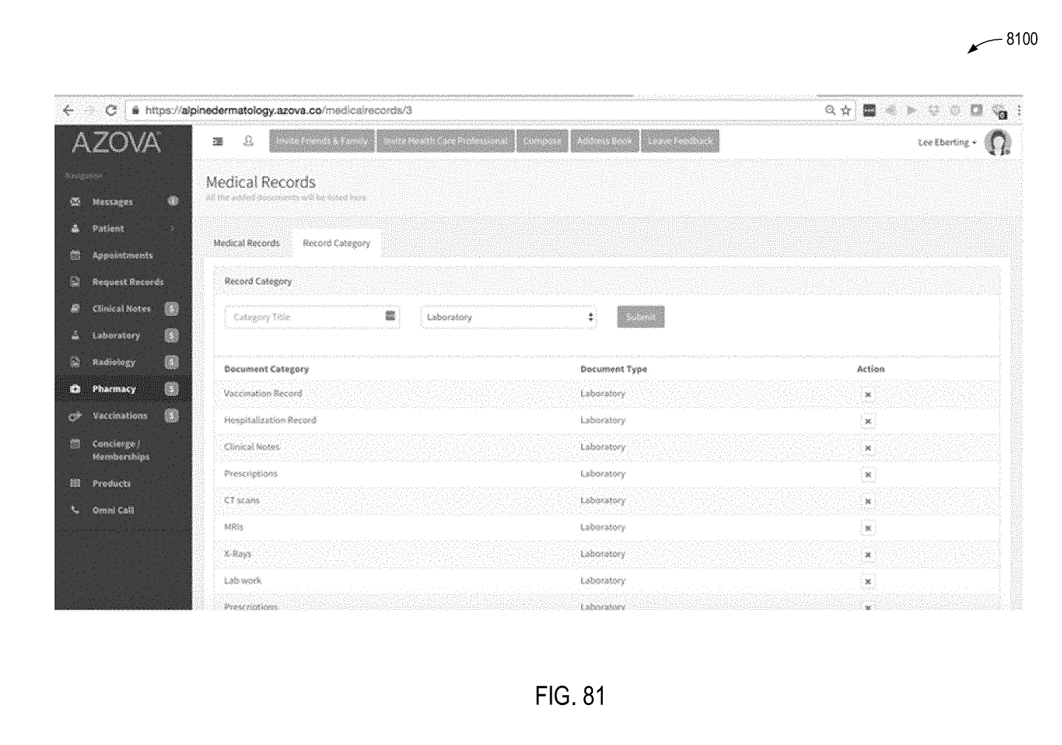

FIG. 81 illustrates a view 8100 of medical records, including vaccination records, accessible via an online healthcare portal that includes an integrated or connected vaccine management system, according to various embodiments. After purchasing/scheduling any consult or after scheduling or registering for a vaccination visit with any provider, the system may prompt the patient to select which records or pieces of their records they would like to share with their healthcare professionals for this appointment. When the patient selects “Vaccination Record”, the system may automatically prompt the patient to complete his/her online vaccination history.

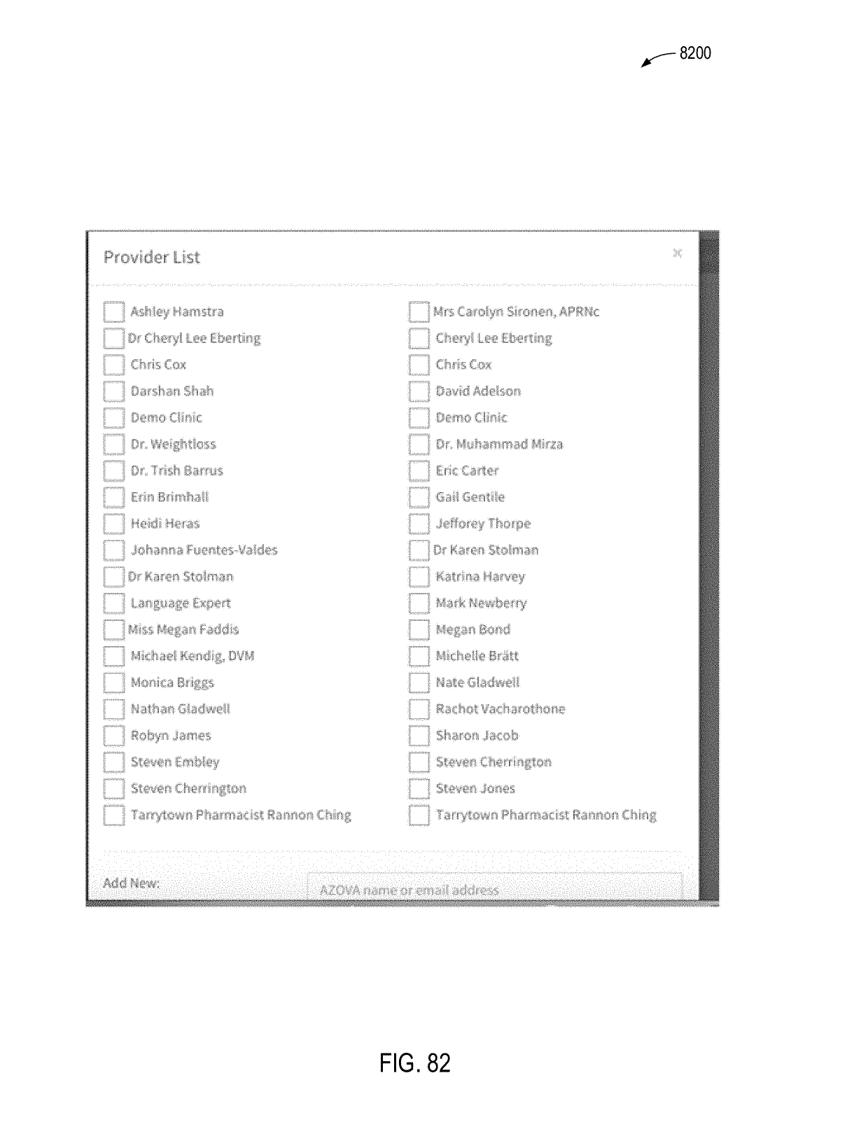

FIG. 82 illustrates a provider list 8200 that allows a patient to select a provider to administer or provide consultation with respect to vaccines, according to various embodiments. The patient determines which healthcare professional, pharmacist, school or university, laboratory, imaging center, family or friend with whom he/she would like to share his/her medical records.

According to the illustrated embodiment, when the patient selects a healthcare professional that professional has an account on AZOVA (or other healthcare management system), the record goes to that professional's vaccination tab on his/her dashboard. If that professional does not have an account on AZOVA, then he/she may be notified, as described above.

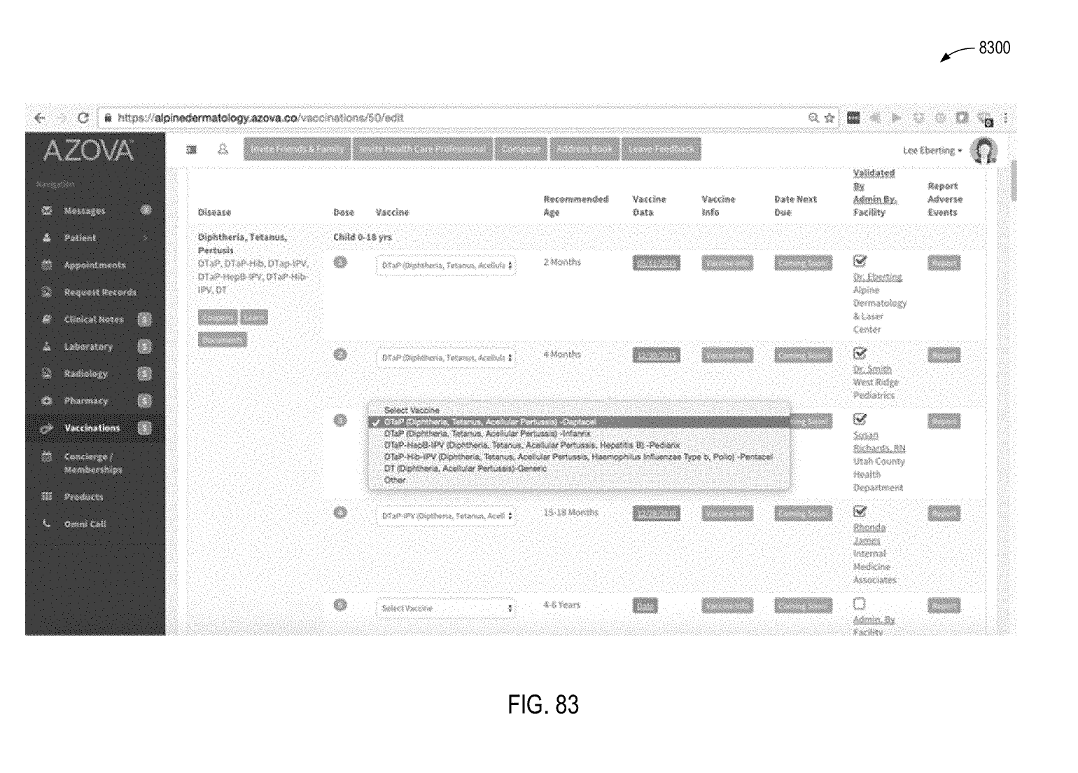

FIG. 83 illustrates a list 8300 of vaccines for a patient, dosages, recommendations, other information, and a validation status, according to various embodiments.

If the patient has opted to share vaccine information, the system may automatically provide the patient's vaccination history with healthcare providers. In some embodiments, patient can enter their own vaccine histories and share them with healthcare professionals and/or pharmacists for validation. Accordingly, in some embodiments a central registry is not needed, but may be optionally included. Blockchain techniques, approaches and technology may be utilized for verification. In such embodiments, patients can easily build and aggregate their own records and then share them with whomever needs access to it perpetually, revocably, or on demand.

In some embodiments, a professional can validate receipt of vaccines and the patient and/or professional can share the validation with schools, governments, or other entities as approved by local regulations and/or the patient. Once a vaccine is validated, a patient may be prohibited from editing it without losing the validation, but the patient may use the validated vaccine as proof of vaccine reception.

In various embodiments, a VMS system automatically presents all the vaccines that are currently FDA approved for each age. For example, certain vaccines in any one series are only approved to be used for dose four or five, but are not approved for dose 1, 2, or 3. The system may allow the patient or provider to add vaccines that are approved for each particular dose and offers a dynamic recommended age as well as recommended time between vaccinations. These recommendations may be programmed to notify the patient when they are due or overdue for a vaccination and displays to the patient, and, optionally, with one or more providers with whom the patient has opted shared information, that there are vaccines that are due or overdue and/or any vaccines that have been given in the past. This way, the VMS system can help to prevent over and under vaccination.

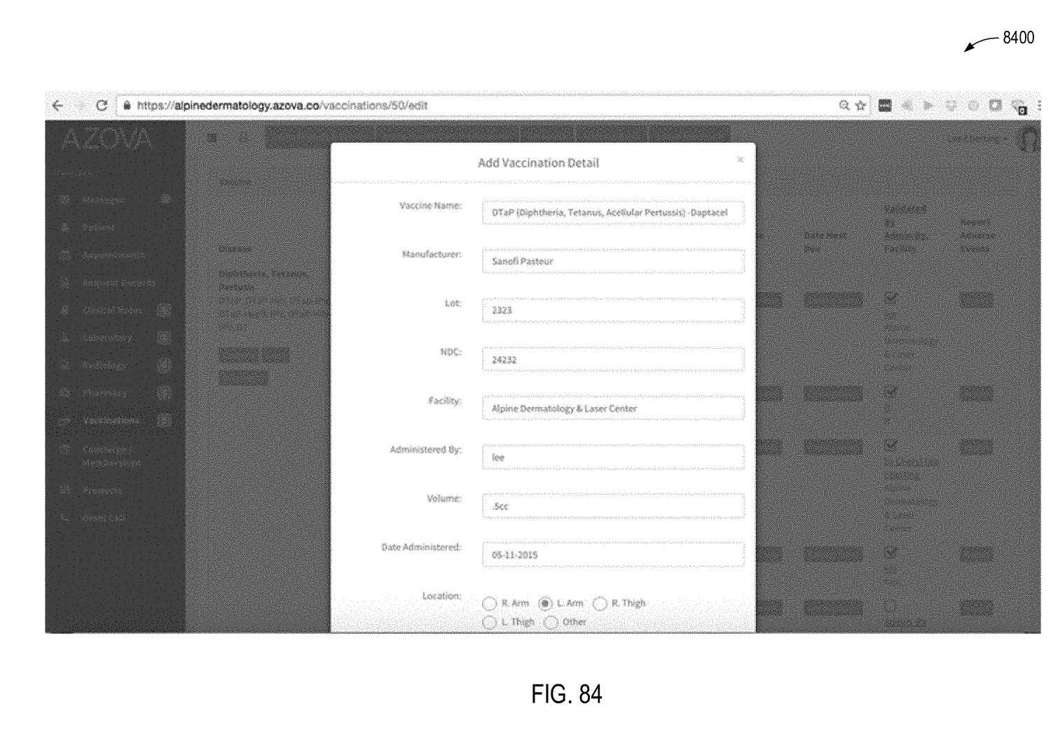

FIG. 84 illustrates a page 8400 for a healthcare profession to add vaccination detail, according to various embodiments. As previously described, the system may aggregate various vaccination information, such as manufacturer, brand name, NDC code, lot number, an identify of an indivial or facility that administered the vaccine, facility name, location of the vaccine, volume of the vaccine, location of injection and whether (or not) the vaccine was valid along with comments. As a specific embodiment, a baby may be injected with the MMR vaccine, but the nurse may not have attached the needle to the syringe tightly enough. Accordingly, the vaccine may not have been fully injected and a large portion of it may have squirted all over the child's arm or leg. This vaccine is considered an invalid vaccine and must be recorded as such and must be made up form in the future. A date may be scheduled for the makeup vaccine and the proper entities may be notified to manage payments and discounts for the mistake.

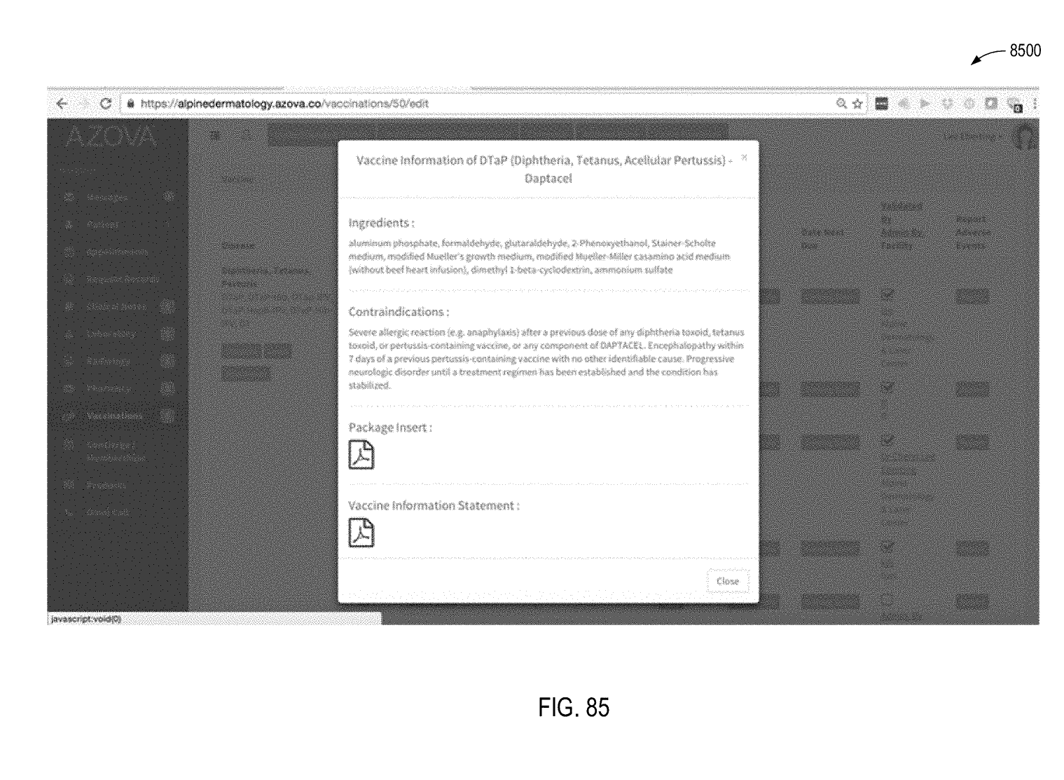

FIG. 85 illustrates a summary page 8500 of information associated with a particular vaccine, according to various embodiments. In the illustrated embodiment, at a glance, the consumer and/or the healthcare professional can access ingredients, contraindications, package inserts as well as the vaccine information sheet (VIS), potentially obviating the need to keep binders of this information and making the vaccination process much more efficient for healthcare practitioners and patients.

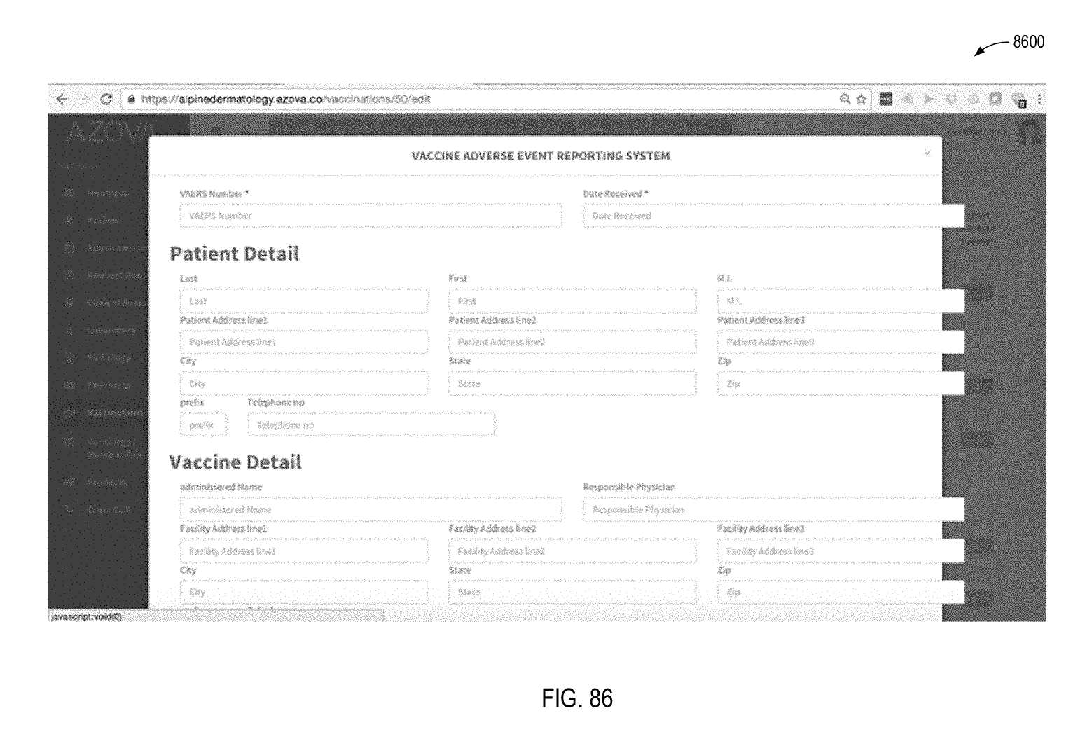

FIG. 86 illustrates a page 8600 allowing for automated or semi-automated adverse event reporting for vaccinations, according to various embodiments. The physical form that is used to mail or fax in adverse event reports to the government's VAERS system can be electronically filled out and/or transmitted using the systems and methods described herein. The current manual reporting system is very inefficient for the patient and seldom results in a record of the adverse event actually being filed. With our adverse event reporting application, the patient clicks to access the mobile responsive VAERS form, can fill it out and share with their doctor who can then add to the document and send it to VAERS and/or the patient can directly send it to VAERS through our interface.

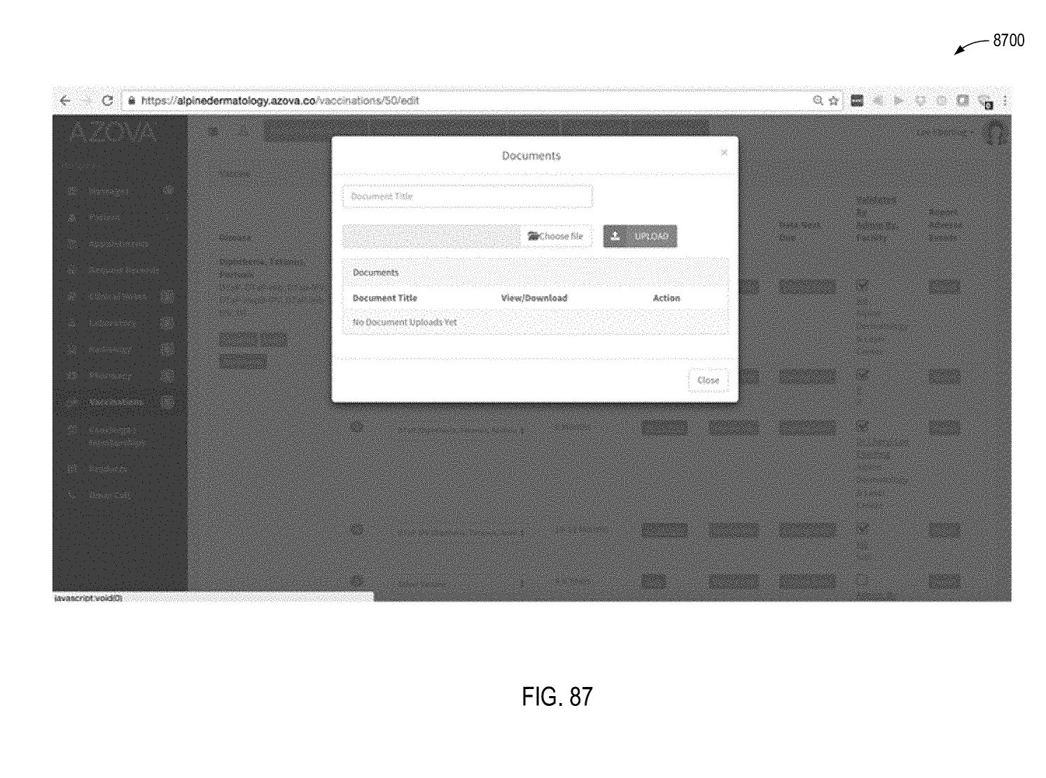

FIG. 87 illustrates a page 8700 allowing for the uploading or submission of documentation relating to vaccinations, according to various embodiments. Patients and/or healthcare professionals can attach any supporting documentation when they share their vaccine record with any school/university/health department, etc. For example, a form that must be filled out by the patient's healthcare professional could be attached along with the vaccination record itself, obviating the need to physically go to a school or other facility to prove that vaccines were received.

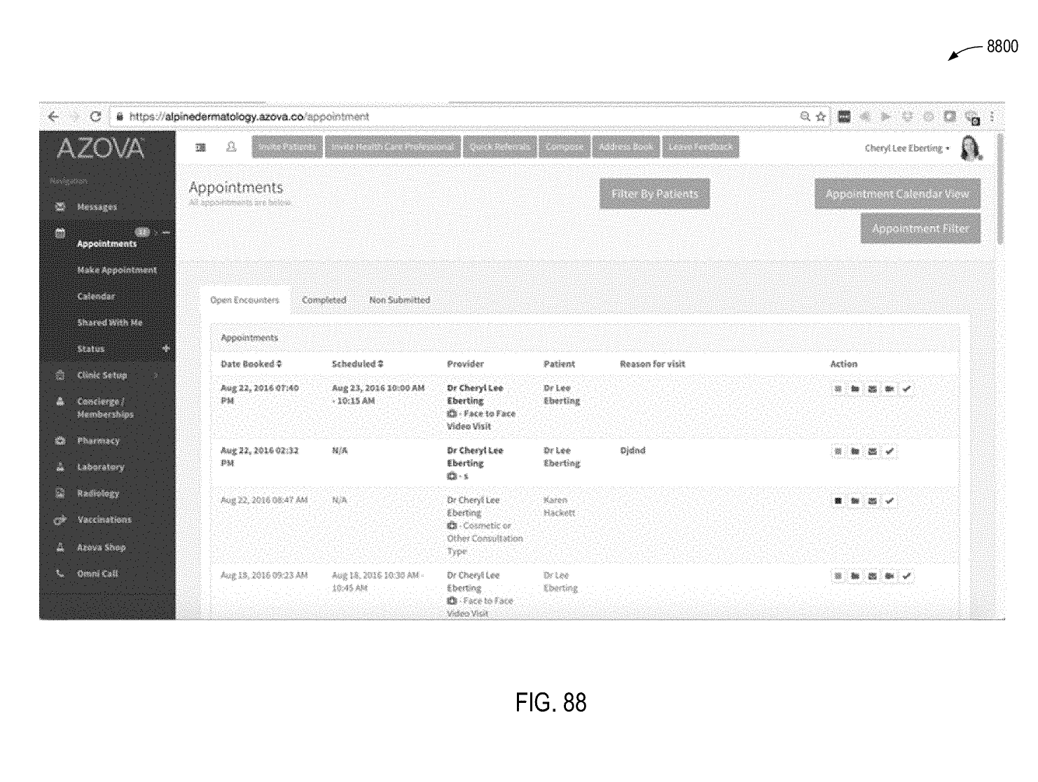

FIG. 88 illustrates an interface 8800 for an appointment scheduling tool to schedule appoints for one or both the patient and the healthcare professional, according to various embodiments.

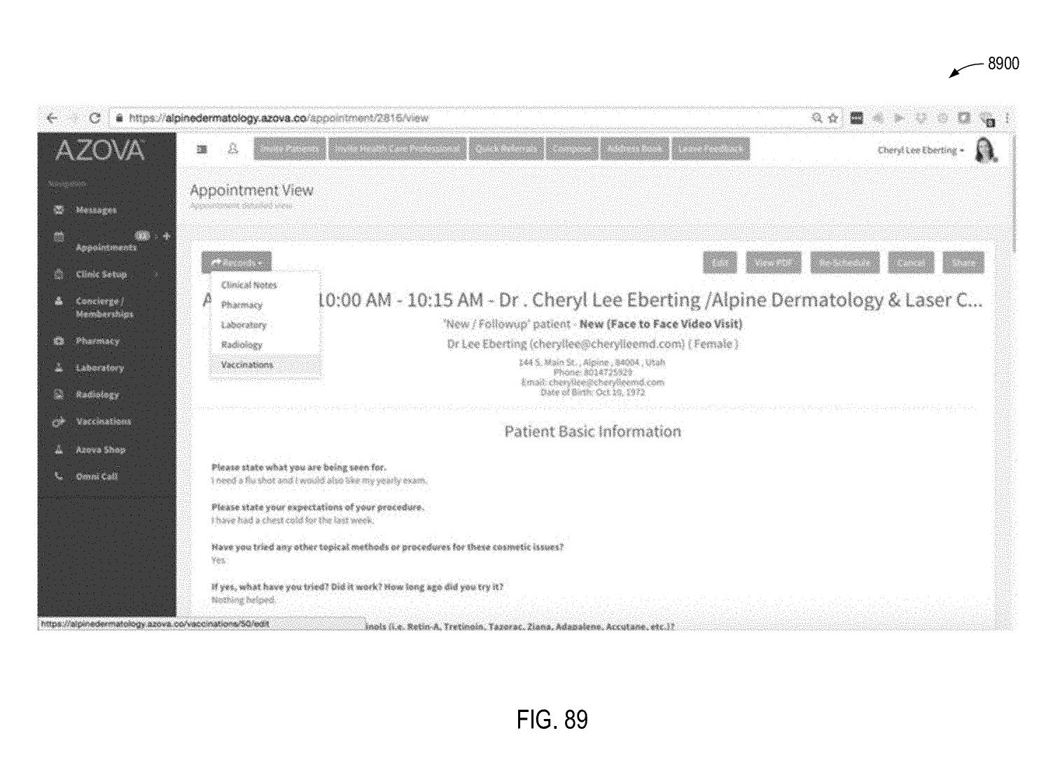

FIG. 89 illustrates an interface 8900 for an appointment chart with quick access to records that have been shared with the healthcare professional, according to various embodiments. A healthcare professional may open an appointment chart and click on any of the tabs to display the records that have been shared with the healthcare professional. By clicking on “vaccinations”, the healthcare professional may be taken directly to that patient's vaccine record.

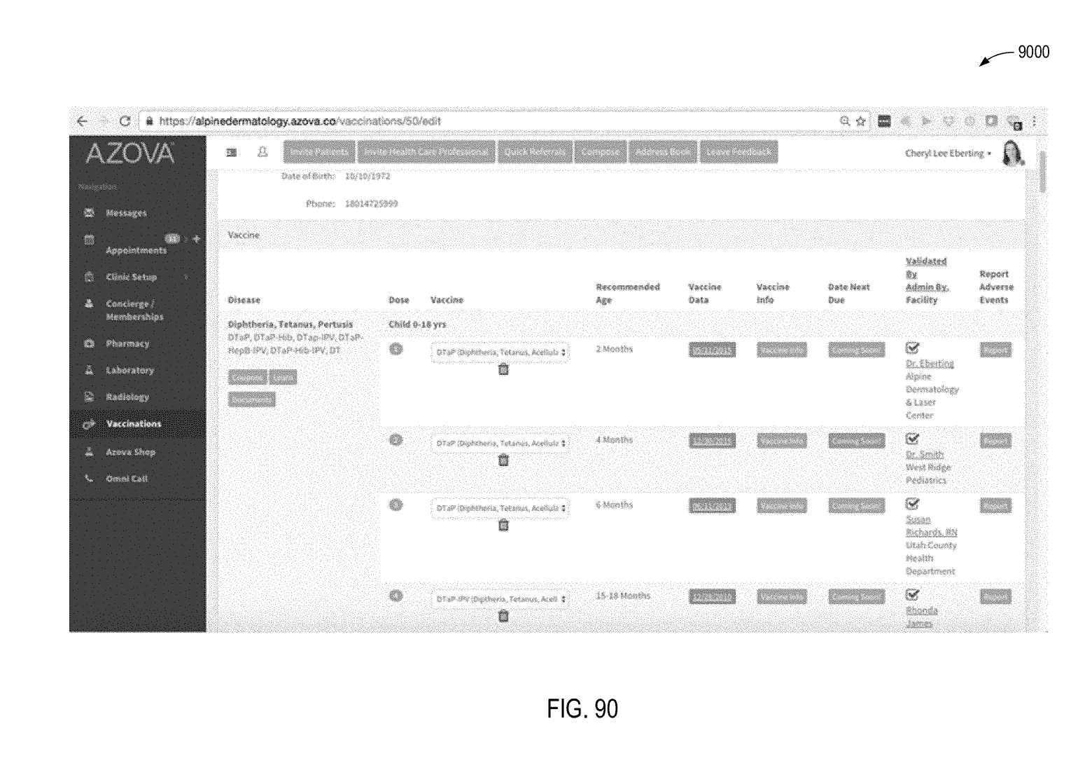

FIG. 90 illustrates a view 9000 of the patient's history as shared by the patient with the healthcare professional, according to various embodiments. The healthcare professional can access the patient's history and quickly determine which additional vaccines are needed by the patient and can document all needed information in one place. When the provider clicks to document the information, the system automatically fills the provider's name/location etc. into the form and validates the vaccine for the patient. The patient has a real-time update on his dashboard and can then share it with whomever he likes.

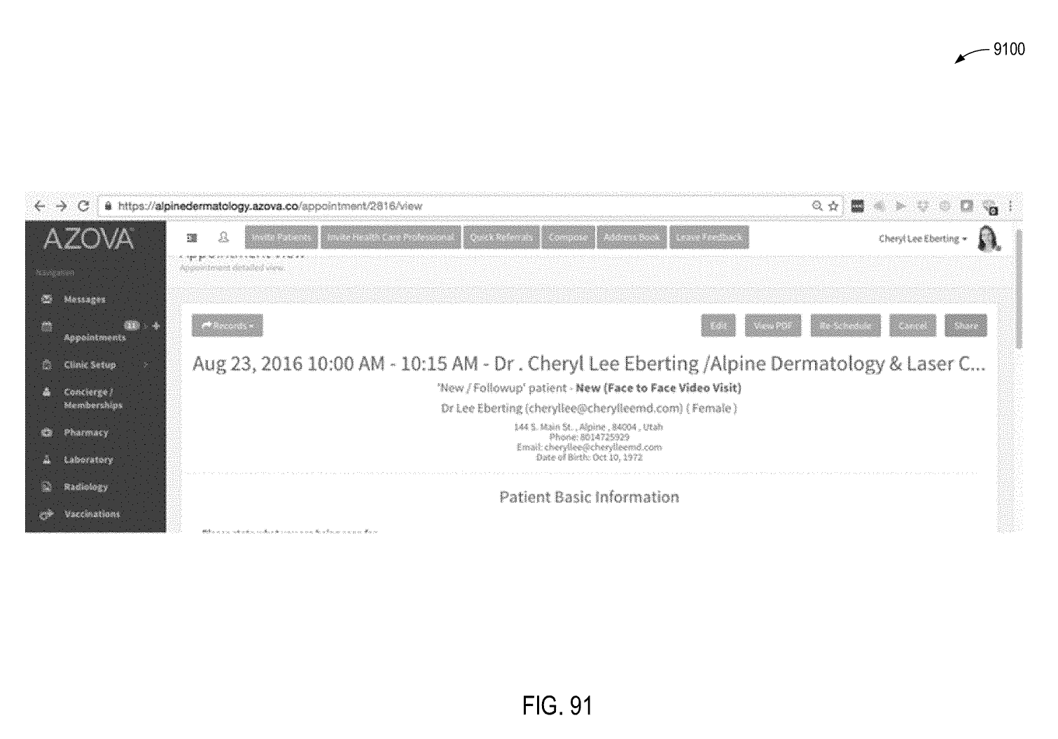

FIG. 91 illustrates an interface 9100 for a sharing module that allows the healthcare professional to share the patient's record with others within a common organization and/or with others as authorized by the patient explicitly or implicitly, according to various embodiments. For example, a healthcare professional can share the patient's record with other healthcare professionals within the same organization. The professional may also share the patient's data with someone outside of the business, as authorized by law or the patient. In some embodiments, the system requests the patient's consent prior to sending the information to third-parties.

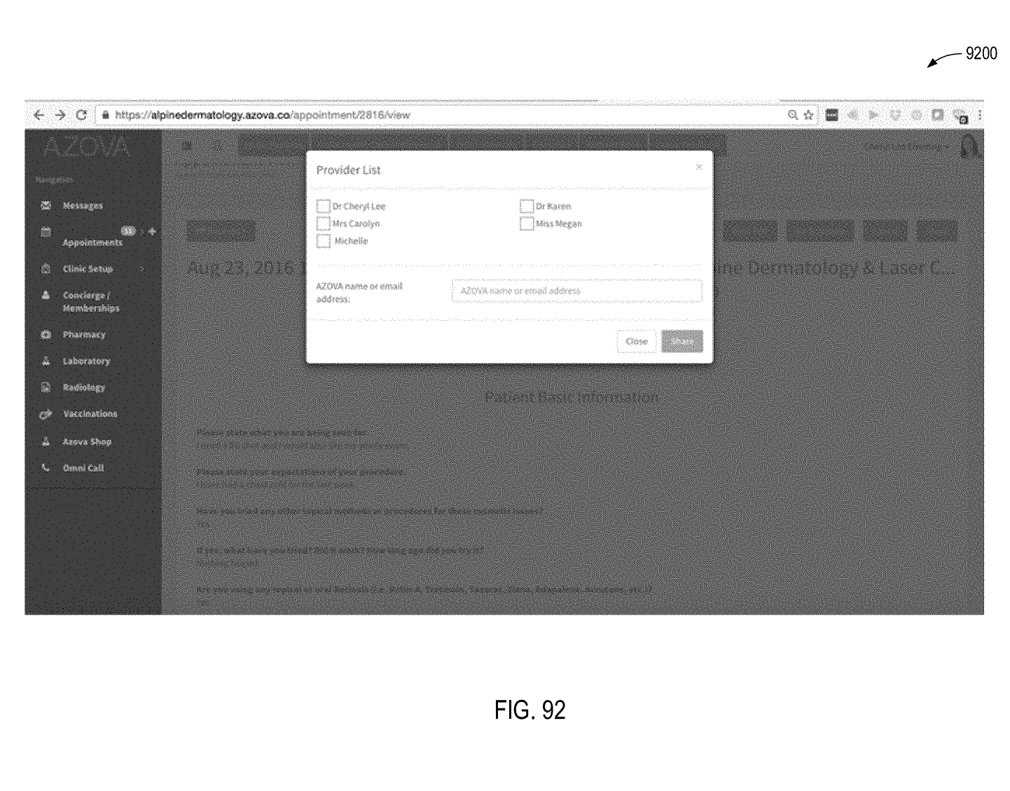

FIG. 92 illustrates a provider interface 9200 for sharing patient information within a common organization, according to various embodiments. The provider's interface for sharing a patient's chart is illustrated. Professionals from within the organization can share with each other without patient consent, in some embodiments. Patient consent may be required for all others.

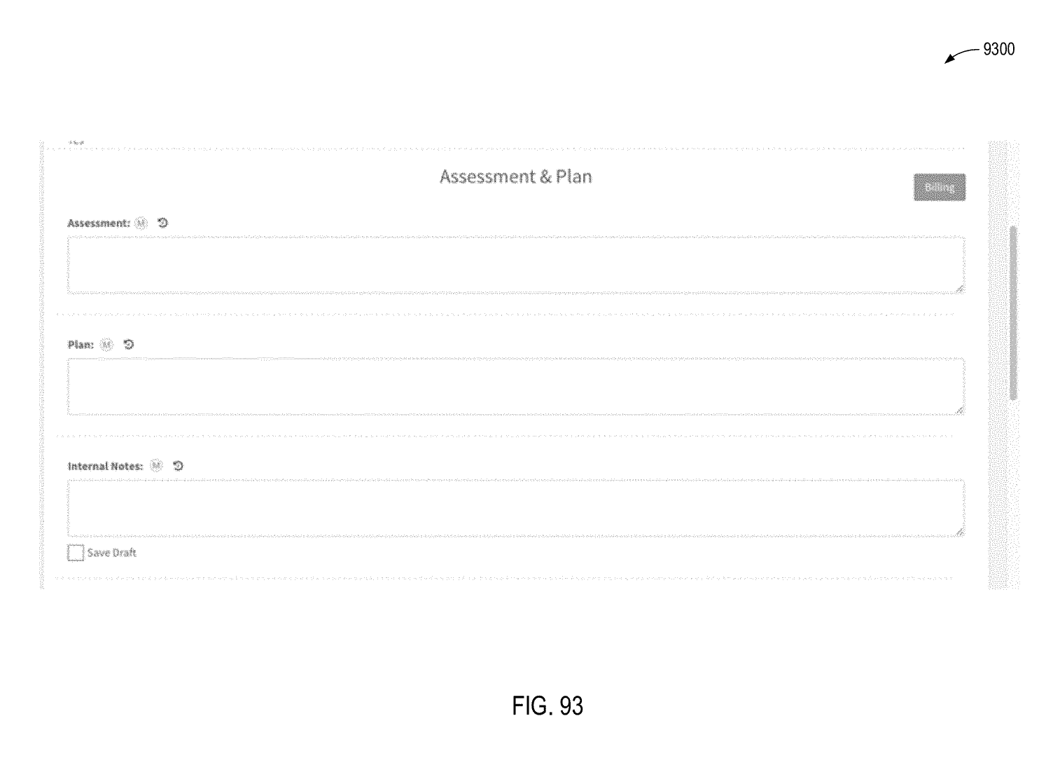

FIG. 93 illustrates an interface 9300 for an assessment and planning module to allow for vaccines to be added and removed from a plan, according to various embodiments. Providers can click on the “billing” or “billing and checkout” button to add additional vaccines and/or can remove vaccines that the patient ordered when scheduling that were not administered at the time of the visit.

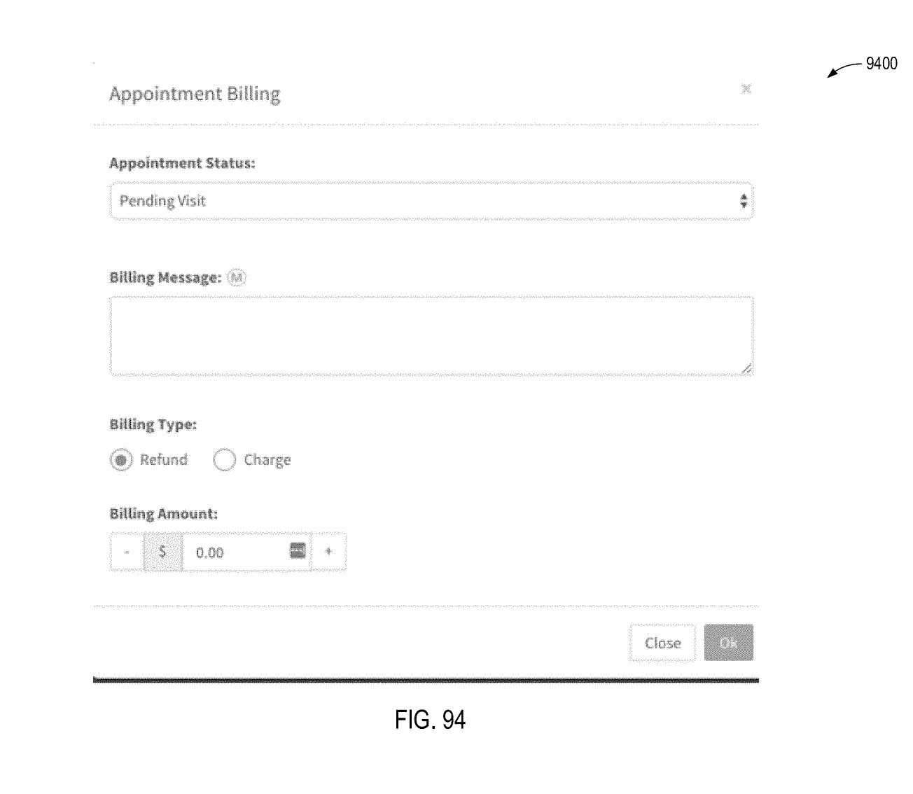

FIG. 94 illustrates an interface 9400 for products and services module that allows a patient to select products and/or services for purchase during an appointment, according to various embodiments. The illustrated interface allows for the selection of “products” that the provider is selling to the patient. The products may include vaccines, actual packaged goods, services and/or procedures. The procedures may be added to the cart just as physical products would be. Each procedure may be tied to a CPT code and pricing may be displayed on the front end at the time of scheduling the appointment.

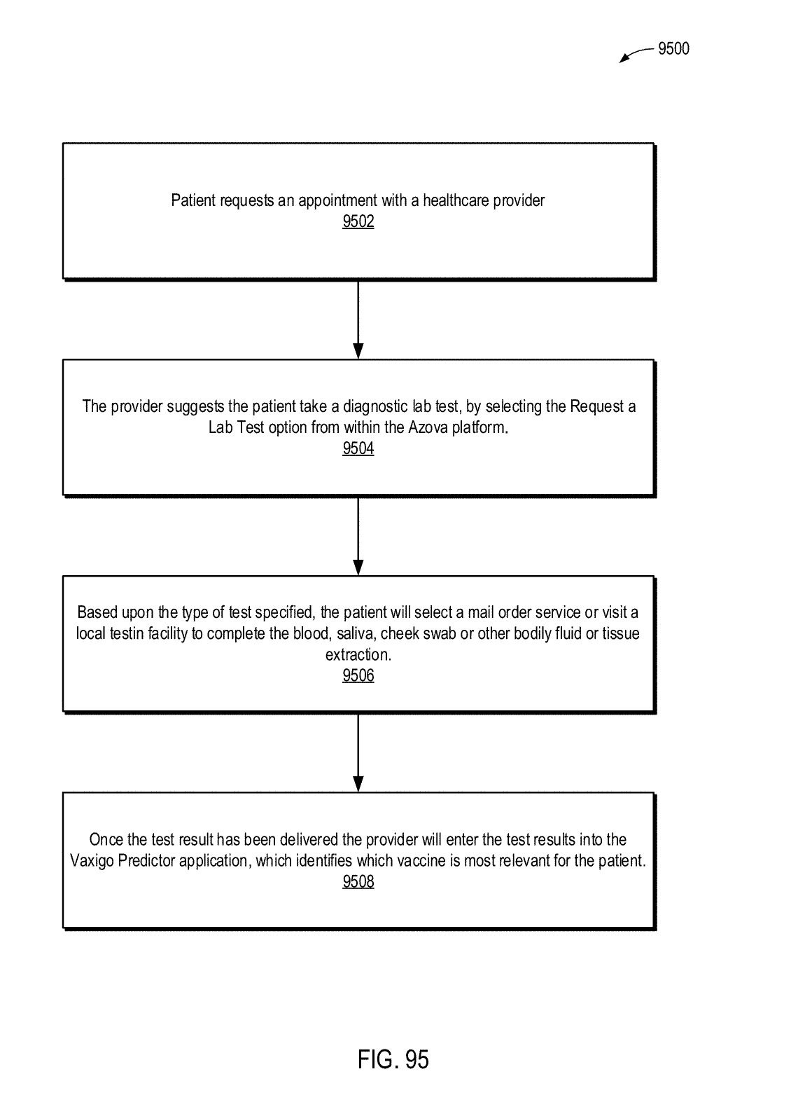

FIG. 95 illustrates a precision vaccination workflow 9500, according to various embodiments. First, a patient requests an appointment with a healthcare provider, at 9502 Second, the provider suggests the patient take a diagnostic lab test, by selecting the Request a Lab Test option from within the Azova platform, at 9504. Third, based upon the type of test specified, the patient may select a mail order service or visit a local testing facility, to complete the blood, saliva, cheek swab or other bodily fluid or tissue extraction, at 9506. Finally, once the test result has been delivered, the provider may enter the test results into the Vaxigo Predictor application, which identifies which vaccine is most relevant for the patient, at 9508.

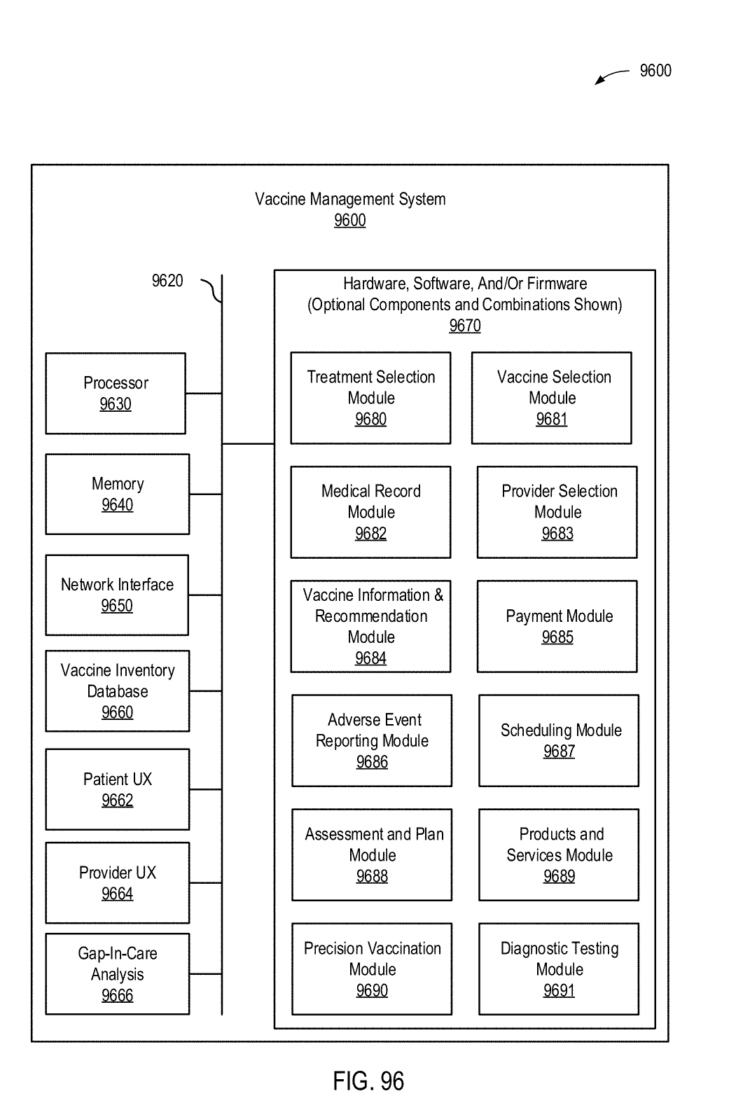

FIG. 96 illustrates a block diagram of a vaccine management system, according to various embodiments. As shown, the vaccine management system 9600 may include one or more of: a processor 9630, memory 9640, a network interface 9650, a vaccine inventory database 9660, a patient user interface 9662, a provider user interface 9664, a gap-in-care analysis subsystem or module 9666, and other optional components as hardware, firmware, and/or software 9670. A bus 9620 may interconnect various integrated and/or discrete components. Various modules (e.g., modules 9080-9091) may be implemented in hardware, software, firmware, and/or a combination thereof. The modules 9080-9091 may implement any permutation of any of the embodiments described herein. Each module may provide a technical solution to a problem originating in the computer implementation of vaccination management. The functionalities of the various modules provide significantly more functionality than the mere computerization of standard vaccination management that is performed manually (e.g., via pen and paper).

Modules 9080-9091 may include one or more of a treatment selection module 9680, a medical record module 9682, a vaccine information and recommendation module 9684, and adverse event reporting module 9686, an assessment and plan module 9688, a precision vaccination module 9690, a vaccine selection module 9681, a provider selection module 9683, a payment module 9685, a scheduling module 9687, a products and services module 9689, and/or a diagnostic testing module 9691. One or more of the above-described modules may be combined as a single module and may be configured to implement any of the systems, subsystems, and/or methods described herein.

The AZOVA™ system is an internationalized platform. Thus, the AZOVA™ platform can be used and customized for any country and/or language in the world. The platform may allow a patient to communicate/have a telemedicine consultation with any provider anywhere in the world.

Many changes may be made to the details of the above-described embodiments without departing from the underlying principles of the present disclosure. Moreover, all combinations and permutations of each of embodiments and functions described herein are contemplated and may be useful in a particular application.

1. A composite platform for integrating product sales and telemedicine consultations, comprising:
an electronic display for displaying a plurality of products available for purchase, at least some of which products require a purchase authorization from a healthcare practitioner;
an input device associated with the electronic display for selecting at least one product for purchase, including at least one product that requires a purchase authorization from the healthcare practitioner;
a consultation initiation module for automatically scheduling a consultation with the healthcare practitioner in response to the selection of the at least one product that requires the purchase authorization from the healthcare practitioner;
a consultation module for conducting remote telemedicine consultation between the healthcare practitioner and a patient;
a purchase authorization module for the healthcare practitioner to generate a purchase authorization for the at least one product selected for purchase; and
a checkout module for finalizing a purchase of the at least one product for purchase, wherein the checkout module is configured to prevent the purchase of the at least one product for purchase absent a purchase authorization.

2. The composite platform of claim 1, further comprising a consultation selection module to allow the patient to select a consultation type selected from the group of consultations consisting of: an e-visit, an in-office visit, and a house call.

3. The composite platform of any of claim 1, further comprising a practitioner selection module to allow the patient to select a healthcare practitioner from a list of available healthcare practitioners.

4. The composite platform of claim 1, further comprising a consultation offering module configured present a patient with a plurality of consultation options, each of which is associated with a price.

5. The composite platform of claim 4, wherein each of the plurality of consultation options is further associated with a product available for purchase.

6. (canceled)

7. (canceled)

8. (canceled)

9. The composite platform of claim 1, wherein the consultation comprises a face-to-face video consultation.

10. (canceled)

11. (canceled)

12. The composite platform of claim 1, wherein the consultation comprises a store and forward interaction.

13. (canceled)

14. (canceled)

15. The composite platform of claim 1, further comprising an intake module for receiving answer to intake questions from a prospective or existing patient.

16. The composite platform of claim 15, wherein the intake module comprises a model of a human body on which a patient may indicate area of focus for the consultation.

17. The composite platform of claim 1, further comprising a historical consultation module for at least one of the patient and the healthcare practitioner to view information regarding prior consultations.

18. The composite platform of claim 1, further comprising a historical consultation module for at least one of the patient and the healthcare practitioner to view information regarding prior consultations.

19. (canceled)

20. (canceled)

21. A system for initiating healthcare consultations in connection with the purchase of healthcare products, comprising:
a network communication module for connecting server devices to client devices, including remote client devices;
a server for communicating with remote client devices via the network communication module, the server including:
a user interface module for providing a patient user interface (UI) to a first client device enabling a patient using the first client device to view and selectively purchase a plurality of healthcare products,
a consultation module for initiating a healthcare consultation between the patient using the first client device and a healthcare practitioner using a second client device;
an authorization module that prevents at least some of the plurality of healthcare products from being purchased absent a prescription from a healthcare practitioner; and
a prescription generation module allowing a healthcare practitioner to generate a prescription in connection with a completed consultation via the consultation module.

22. (canceled)

23. (canceled)

24. The system of claim 21, further comprising a consultation offering module configured present a patient with a plurality of consultation options, each of which is associated with a price.

25. The system of claim 24, wherein each of the plurality of consultation options is further associated with a product available for purchase.

26. The system of claim 25, wherein each of the plurality of consultation options comprises a recurring program option with recurring consultations and recurring payments.

27. (canceled)

28. (canceled)

29. (canceled)

30. (canceled)

31. (canceled)

32. The system of claim 21, wherein the consultation comprises a store and forward interaction.

33. The system of claim 21-29, wherein the consultation comprises a sharing of a document.

34. The system of claim 21, wherein the consultation comprises a sharing of an image.

35. The system of claim 21, further comprising an intake module for receiving answer to intake questions from a prospective or existing patient.

36. The system of claim 35, wherein the intake module comprises a model of a human body on which a patient may indicate area of focus for the consultation.

37. (canceled)

38. (canceled)

39. (canceled)

40. (canceled)

41. (canceled)

42. (canceled)

43. (canceled)

44. A method for virtual customer support, comprising:
receiving a request for support from a customer at a first physical location within a store;
sending a notification to a remote representative;
connecting the representative and the customer via a first sales support device proximate the first physical location within the store;
presenting a live demonstration from the representative that includes instructions for the customer to proceed to a second physical location within the store; and
transferring the representative from the first sales support device to a second device proximate the second physical location within the store to virtually meet the customer at the second physical location.

45. (canceled)
